(19) United States
(12) Patent Application Publication
(10) Pub. No.: US 2026/0016606 A1
(43) Pub. Date: Jan. 15, 2026

(54) TRIPLE FREQUENCY SATELLITE BIAS DETERMINATION FOR A GLOBAL SATELLITE CORRECTION SIGNAL

(71) Applicant: Deere & Company, Moline, IL (US)

(72) Inventors: LIWEN DAI, Torrance, CA (US); YIQUN CHEN, Torrance, CA (US)

(21) Appl. No.: 19/257,989

(22) Filed: Jul. 2, 2025

Related U.S. Application Data
(60) Provisional application No. 63/669,035, filed on Jul. 9, 2024.

(51) Int. Cl. G01S 19/07; G01S 19/04

(52) U.S. Cl. CPC G01S 19/07; G01S 19/04

(57) ABSTRACT

The precise point positioning module or the estimator is configured to determine second wide-lane (e.g., extra-wide-lane), floating or fixed ambiguities and associated second wide-lane biases for each satellite based on the second carrier phase and third carrier phase associated with the corresponding satellite. The precise point positioning module or the estimator is configured to determine narrow-lane, floating or fixed ambiguities, a satellite slow clock solution and a time-variant narrow-lane bias for a corresponding satellite based within a narrow-lane bias/code-phase bias filter for each satellite. A correction data estimator is configured to provide a correction signal that includes the first wide-lane bias, second wide-lane (e.g., extra-wide-lane) bias, time-variant narrow lane bias, orbit correction, and clock correction for a given satellite.

### CROSS-REFERENCE TO RELATED APPLICATIONS

This application claims the benefit of U.S. Provisional Application No. 63/669,035, filed Jul. 9, 2024. The entire disclosure of the application referenced above is incorporated by reference.

### FIELD

This disclosure relates to a method for providing a global satellite correction signal with triple frequency satellite bias determination.

### BACKGROUND

In the prior art, a network of reference stations provides carrier phase measurements to a data processing hub that generates a global satellite correction signal based on the carrier phase measurements in accordance with precise point positioning (PPP) estimation: a wireless communications channel can provide the satellite correction signal to a mobile GNSS receiver to achieve dual-frequency PPP estimation. Dual-frequency PPP estimation may use carrier phase measurements of two different GNSS signals (e.g., L1 signal and L2 signal for Global Positioning System. GPS) to achieve centimeter-level position accuracy globally in real-time once phase integer ambiguity is resolved. However, for dual-frequency PPP, the convergence time to estimate carrier phase ambiguities can be about 10 minutes or longer, which makes it impracticable for some real-time applications.

Recently, a growing number of modem satellites, which support GPS/QZSS, Galileo, Beidou and GLONASS constellations, offer or make available a third carrier frequency (e.g., L3 signal for GPS). Therefore, there is a need to method for providing a global satellite correction signal with triple frequency satellite bias determination.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

In accordance with one embodiment, a method for providing a global satellite correction signal supports a third carrier frequency. A reference receiver is configured to receive a plurality of satellite signals from each satellite, the satellite signals comprising a first carrier frequency, a second carrier frequency, and third carrier frequency. A measurement module is configured to measure the carrier phase (and code phase) of the corresponding satellite signals from each satellite to estimate a first carrier phase of the respective first carrier frequency, to estimate a second carrier phase of a respective second carrier frequency, and to estimate a third carrier phase of the respective third carrier frequency. A precise point positioning module or an estimator is configured to determine first wide-lane, floating or fixed ambiguities and associated first wide-lane biases for each satellite based on the first carrier phase and second carrier phase associated with the corresponding satellite. The precise point positioning module or the estimator is configured to determine second wide-lane (e.g., extra-wide-lane), floating or fixed ambiguities and associated second wide-lane biases for each satellite based on the second carrier phase and third carrier phase associated with the corresponding satellite. The precise point positioning module or the estimator is configured to determine narrow-lane, floating or fixed ambiguities, a satellite slow clock solution and a time-variant narrow-lane bias and ambiguity-fixed-ionosphere-free (AFIF) bias for a corresponding satellite based within a narrow-lane bias/code-phase bias filter for each satellite. A correction data estimator is configured to provide a correction signal comprising the first wide-lane ambiguities, second wide-lane (e.g., extra-wide-lane) ambiguities, first wide-lane bias, second wide-lane (e.g., extra-wide-lane) bias, ambiguity-fixed-ionosphere-free (AFIF) bias, and the narrow-lane ambiguities and the time-variant narrow lane bias.

### BRIEF DESCRIPTION OF THE DRAWINGS

FIG. 1 shows illustrative example of a correction data estimator.

FIG. 2 is a flow chart of a method for providing a global satellite correction signal with triple frequency satellite bias determination.

FIG. 3 is a flow chart of a method for ambiguity resolution of integer carrier phase cycles that uses single-difference ambiguity clusters of satellite pair carrier phase measurements for one or more epochs.

FIG. 4A is an exemplary chart that illustrates the number of duplicative or cumulative sets of carrier phase measurements per epoch that are available for pairs of visible satellites from different reference receivers within a reference network.

FIG. 4B is an exemplary chart that ranks the number of duplicative or cumulative sets of carrier phase measurements per epoch that are available for pairs of visible satellites from different reference receivers within a reference network.

FIG. 5 is a flow chart of one embodiment method for providing a satellite correction signal with a precise, low-latency Global Navigation Satellite System (GNSS) satellite clock, where the correction signal comprises any of the following: an orbit correction, a clock correction, satellite EWL ambiguity, satellite WL ambiguity, satellite NL ambiguity, satellite EWL bias, satellite WL bias, and satellite NL bias.

FIG. 6 is a block diagram of the preprocessor, orbit solution and clock solution modules according to some embodiments.

FIG. 7 is a graphical representation of the time limitations associated with electronic data processing of the pre-processing module, orbit and clock module, and correction signal transmission, broadcast or delivery.

FIG. 8 is a flowchart of a process for generating navigation satellite corrections, include a correction corresponding to a satellite extra-wide-lane bias and satellite wide-lane bias for each satellite in a plurality of satellites, and for providing the generated navigation satellite corrections to navigation receivers, according to some embodiments.

FIG. 9 is a flow chart of a first illustrative embodiment of a method for providing a global satellite differential correction signal, consistent with or in conjunction with any of the block diagrams referenced in the above drawings of this disclosure.

FIG. 10 is a flow chart of a second illustrative embodiment of a method for providing a global satellite differential correction signal, consistent with or in conjunction with any of the block diagrams referenced in the above drawings of this disclosure.

Any set of two or more drawings with the same reference numbers indicates like features, processes, or elements.

### DETAILED DESCRIPTION

A satellite correction generation system receives reference receiver measurement information from a plurality of reference receivers at established locations. In accordance with the received reference receiver measurement information, and established locations of the reference receivers with triple frequency support, the system determines Extra-Wide-Lane bias (EWL), Wide-Lane (WL) bias, Narrow-Lane (NL) bias, Ambiguity-Fixed-Ionosphere-Free (AFIF) bias, orbit and clock correction for the plurality of global navigation satellite systems. The system also determines clusters of single-difference (SD) EWL floating ambiguities: each cluster comprises pairs of SD EWL floating ambiguities for respective pairs of satellites. A satellite EWL bias value for each satellite of a plurality of satellites is initially determined in accordance with fractional portions of the SD EWL floating ambiguities in the clusters, and then periodically updated by a Kalman filter.

In some embodiments, first frequency carrier phase measurements, second frequency carrier phase measurements and third frequency carrier frequency measurements are processed to form the AFIF measurements, such first portion of Equation 24. Further, the WL carrier phase and the EWL carrier phase can be used to determine the AFIF measurements, such as the second portion of Equation 24. For example, the AFIF measurements are related to (e.g., or are based on) wide-lane measurements that consider wide-lane (WL) carrier phase between the first and second carrier frequencies and extra wide lane (ELW) carrier phase between second and third carrier frequencies (e.g., which are essentially weighted or adjusted by frequency-related coefficients). For example, the ambiguity-fixed-ionosphere-free (AFIF) measurements are determined for each satellite based on: (a) a first difference of the first carrier phase measurements and the second carrier phase measurements for wide-lane (WL) measurements for a respective epoch or series of epochs; (b) a second difference of the second carrier phase measurements and third carrier phase measurements for extra-wide-lane (EWL) measurements for a respective epoch or series of epochs; (c) resolved (e.g., fixed) extra-wide lane (EWL) ambiguities and (d) resolved (e.g., fixed) wide-lane (WL) ambiguities, wherein the wide-lane ambiguities are resolved (e.g., fixed to integer values or rounded from floating values) by using both single-differencing and double-differencing of the wide-lane carrier phase measurements for the respective epoch, or series of epochs thereafter (e.g., until cycle-slip or loss of lock on the particular received carrier frequency signals), and wherein the extra-wide-lane ambiguities are resolved (e.g., fixed to integer values or rounded from floating values) by using both single-differencing and double-differencing of the extra wide-lane carrier phase measurements for the respective epoch or series of epochs thereafter (e.g., until cycle-slip or loss of lock on the particular received carrier frequency signals).

The AFIF measurements, along with both resolved EWL and resolved WL ambiguities, are processed to determine the satellite AFIF bias. A set of navigation satellite corrections, including the EWL bias, WL bias, NL bias, AFIF bias, orbit and clock correction for each satellite, are generated and transmitted to navigation receivers for use in determining locations of the navigation receivers with faster convergence and higher accuracy.

Triple frequency measurements are utilized to generate additional satellite bias signals, such as EWL bias and AFIF bias, along with precise GNSS orbit, clock correction and wide-lane (WL) bias and narrow-lane bias (NL) signals. Collectively, the correction data or correction signal comprises any of the following on a satellite-by-satellite basis: EWL bias. AFIF bias, WL bias. NL bias, precise GNSS orbit corrections and precise clock corrections Each carrier phase measurement represents a distance between the reference receiver and a corresponding satellite, which can be characterized based on an integer number (N) of wavelength cycles and a partial wavelength cycle (e.g., directly observable partial wavelength cycle), where the carrier frequency equals the speed of light (or electromagnetic propagation) divided by the wavelength. The carrier frequency can be L1, L2, L3, EWL, WL, and NL, for example. The correction signals can be used for mobile GNSS receivers to speed up precise point positioning (PPP) convergence for EWL ambiguities. WL ambiguities and NL ambiguities to be shorter than 1 minute or instantaneously.

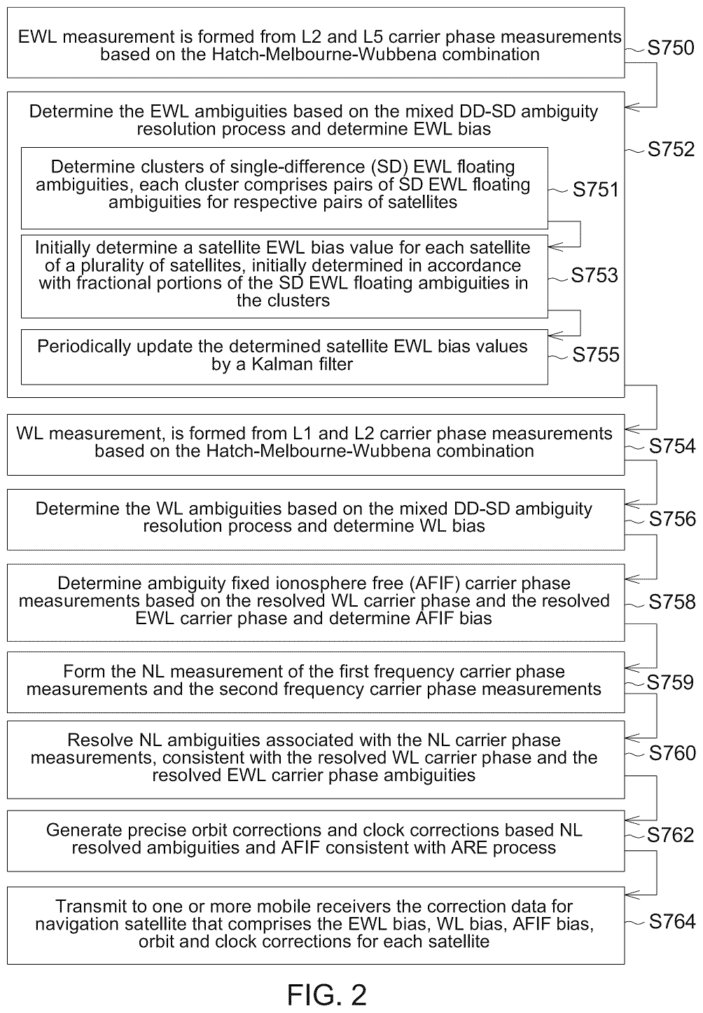

FIG. 2 is a flow chart of one embodiment of a method for determining correction data for each satellite in a GNSS constellation. The method of FIG. 2 begins in step S750.

In step S750, the electronic data processor or EWL estimator is configured to form an EWL measurement, which includes an associated ambiguity, from second frequency carrier phase measurements (e.g., L2 carrier phase measurements) and third frequency carrier phase measurements (e.g., LS carrier phase measurements) based on the Hatch-Melbourne-Wubbena combination for an epoch or measurement time interval. For example, the electronic data processor or EWL estimator is configured to form an EWL carrier phase measurement and an associated EWL ambiguity based on a difference between second frequency carrier phase measurements (e.g., L2 carrier phase measurements) and third frequency carrier phase measurements (e.g., LS carrier phase (e.g., L2-L5 carrier phase measurements) for each measurement epoch and for each satellite within reception range of the reference receiver (e.g., GNSS receiver). The EWL carrier phase measurement has a greater wavelength than the WL carrier phase measurement and the NL carrier phase measurement, where the greater wavelength facilitates search and resolution of the EWL ambiguity.

In step S752, the electronic data processor or EWL estimator is configured to determine or estimate the Extra-Wide-Lane (EWL) ambiguity of the Hatch-Melbourne-Wubbena combination (e.g., difference) of the second frequency carrier phase measurements (e.g., L2 carrier phase measurements) and the third frequency carrier phase measurements (e.g., L5 carrier phase measurements) for an epoch or series of successive epochs, which can be solved using mixed Double-difference (DD)-single difference (SD) ambiguity resolution network engine. For example, the ambiguity or ambiguities represent carrier phase wavelength cycle integer ambiguities (e.g., which non-integer portion of wavelength cycles) for the EWL measurement between a satellite and a GNSS receiver. The EWL measurement tends to improve the integer ambiguity search by making it more efficient. In one embodiment, step S752 may comprise a series of steps or sub-steps which may be applied separately or cumulatively, such as one or more of the following steps or sub-steps: S751, S753 and S755.

Under step S751, the electronic data processor or EWL estimator is configured to determine clusters of single-difference (SD) EWL floating ambiguities, where each cluster comprises pairs of SD EWL floating ambiguities for respective pairs of satellites.

Under step S753, the electronic data processor or EWL estimator is configured to initially determine a satellite EWL bias value for each satellite of a cluster or group of satellites in accordance with fractional portions of the SD EWL floating ambiguities in the clusters. Further, step S753 may use DD ambiguity resolution to reduce or eliminate non-EWL bias in the estimated EWL bias.

Under step S755, the electronic data processor or the EWL estimator periodically updates the determined satellite EWL bias by a predictive filter, such as Kalman filter.

In step S754, the electronic data processor or the WL estimator forms the WL measurement of the first frequency carrier phase measurements and second frequency carrier phase measurements frequency measurements using the Hatch-Melbourne-Wubbena combination (e.g., difference) of the first frequency carrier phase measurements (e.g., L1 carrier phase measurements) and the second frequency carrier phase measurements (e.g., L2 carrier phase measurements). For example, the electronic data processor or the WL estimator determines the WL measurement based on the difference between the first frequency carrier phase measurements (e.g., L1 carrier phase measurement) and second frequency carrier phase measurements (e.g., L2 carrier phase measurements) for each measurement epoch and for each satellite within reception range of the reference receiver (e.g., GNSS receiver).

In step S756, the electronic data processor or the WL estimator is configured to determine the WL ambiguities based on a mixed Double-difference (DD)-single difference (SD) ambiguity resolution network engine.

In step S758, once all EWL ambiguities and wide-lane (WL) ambiguities (collectively wide-lane ambiguities) are solved or resolved for each epoch and each satellite within reception range of a reference receiver (e.g., GNSS receiver), the electronic data processor is configured to determine non-ambiguous, ambiguity-fixed-ionosphere-free (AFIF) measurements based on the wide-lane (WL) carrier phase between the first and second carrier frequencies and extra wide lane (ELW) carrier phase between second and third carrier frequencies.

In step S759, the electronic data processor, measurement module, or narrow-lane (NL) estimator forms the NL measurement of the first frequency carrier phase measurements and the second frequency carrier phase measurements based on the Hatch-Melbourne-Wubbena combination (e.g., addition) of the first frequency carrier phase measurements (e.g., L1 carrier phase measurements) and the second frequency carrier phase measurements (e.g., L2 carrier phase measurements) for a respective epoch and for a respective satellite within reception range of the reference receiver (e.g., GNSS receiver). The NL estimator is configured to determine the narrow-lane (NL) ambiguities associated with the NL carrier phase measurements for each epoch and each satellite.

In step S760, the electronic data processor or the NL estimator resolves the NL ambiguities associated with the NL carrier phase measurements for one or more successive epochs, consistent with the resolved WL carrier phase ambiguities and the resolved EWL carrier phase ambiguities. For example, in step S761, the electronic data processor or the NL estimator resolves the NL ambiguities by the Least Squares Ambiguity Decorrelation Adjustment Method (LAMDA), where R2/R1 is greater than c. Otherwise, if R2/R1 is equal to or less than c, the electronic data processor or the NL estimator resolves the NL ambiguities by a partial LAMDA search.

In step S762, the data processor or correction data estimator generates precise orbit corrections and clock corrections based on NL resolved ambiguities and AFIF bias, consistent with the ARE process. Further, in the data processing center or correction data estimator, the AFIF, WL and EWL carrier phase measurements and code phase measurements are processed together with ionosphere-free combination of code phase measurements and carrier phase measurements in a network solution to generate precise orbit, clock. AFIF bras and narrow-lane bias corrections.

In step S764, the wireless communications device transmits to one or more mobile receivers (e.g., GNSS rovers) the correction data for each navigation satellite that comprises the EWL bias. WL bias, NL bias, AFIF bias, orbit and clock correction for each satellite.

Accordingly, the system and method is configured to determine improved navigation satellite correction information comprising WL, EWL, and NL carrier phase ambiguities, AFIF measurements, precise orbit, precise clock, WL bias, EWL bias, NL bias and AFIF bias, so as to enable navigation receivers to achieve much shorter convergence time using an absolute mode of navigation.

### Notation

In the explanations that follow, the following symbols and notation conventions are used.

### General Notation

$${P}_{r , {L}_{i}}^{s}$$

is code (phase) measurement from satellite s to receiver r in meter at the i-th frequency;

$${Φ}_{r , {L}_{i}}^{s}$$

is carrier phase measurement from satellite s to receiver r in cycle at the i-th frequency;

$${B}_{{L}_{i}}^{s}$$

B is code bias due to satellite hardware delay and receiver related delay B_{r,L}_{ᵢ} for the i-th frequency
b is phase bias due to satellite hardware delay

$${b}_{{L}_{i}}^{s} ,$$

receiver related delay b_{r,L}_{ᵢ} for the i-th frequency;

$${N}_{r , {L}_{i}}^{s}$$

is the float ambiguity from satellite s to receiver r in cycle at the i-th frequency;
f_{L}_{ᵢ} is the i-th GNSS carrier signal frequency
λ_{L}_{ᵢ} is the GNSS carrier signal wavelength at the i-th frequency

### Frequency Notation

Subscripts denote the applicable frequency associated with a quantity as follows:
[ ]_{L}_{₁} refers to the first carrier frequency of each GNSS system such as GPS/QZSS L₁, Galileo E₁, Beidou B_{b1c} and Glonass CDMA signal L_{10C},
[ ]_{L}_{₂} refers to the second carrier frequency of each GNSS system such as GPS/QZSS L₂, Galileo E₅, Beidou B₂ₐ and Glonass CDMA signal L_{20C},
[ ]_{L}_{₃} refers to the third carrier frequency of each GNSS system such as GPS/QZSS L₅, Galileo E₆, Beidou B₃ and Glonass CDMA signal L_{30C},
[ ]_{WL} refers to wide-lane, where wide-lane means the difference between the first carrier frequency measurement and the second carrier frequency measurement or L1-L2 for the same epoch and the same satellite,
[ ]_{NL} refers to narrow-lane, where narrow-lane means the addition of the first carrier frequency measurement to the second carrier frequency measurement for the same epoch L1+L2.
[ ]_{EWL} refers to extra-wide-lane, L2-L3.
[ ]_{AFIF} refers to ambiguity-fixed-ionosphere-free combination from L1-L2 and L2-L3 wide-lane combination.

### Receiver Notation

Subscripts that include the lower-case letter r denote quantities associated with a particular receiver (e.g., a reference receiver) as follows:
[ ]ᵣ_{₁} refers to receiver r₁,
[ ]ᵣ_{₂} refers to receiver r₂.

### Satellite Notation

Superscripts that include the upper-case letter S denote quantities associated with a particular satellite as follows:
[ ]^{S}^{₁} refers to satellite, S₁,
[ ]^{S}^{₂} refers to satellite S₂.

### Differential Notation

Δ[ ]ᵣ_{₁}ᵣ_{₂} refers to single difference between receiver r₁ and r₂,
∇[ ]^{S}^{₁}^{S}^{₂} refers to single difference between satellite S₁ and S₂,

$$∇ {Δ [ ]}_{{r}_{1} {r}_{2}}^{{S}_{1} {S}_{2}}$$

refers to double difference between receiver r₁ and r₂, and satellite S₁ and S₂.

### Ambiguity Notation

The ambiguity scalar or vector form notation follows
\hat{N} refers to the float ambiguity (e.g., sometimes called floating ambiguities),
┌\hat{N}┘ refers to the fractional part (e.g., non-integer portion) of the float ambiguity,
round (\hat{N}) refers to the round off integer part of the float ambiguity,
N refers to the fixed integer ambiguity.
   The ambiguities are often organized in a vector form. The ambiguity vector notation form is as follows:
\hat{N}_{float} refers to the float ambiguity vector \hat{N}_{float}={\hat{N}₁, . . . , \hat{N}ⱼ, . . . , \hat{N}ₙ}, where \hat{N}ⱼ is the j^{th} float ambiguity element,
N_{fixed} refers to the fixed integer ambiguity vector N_{fixed}={N₁, . . . , Nⱼ, . . . , Nₙ}, where Nⱼ is the j^{th} fixed integer ambiguity element,
N̅ᵢ refers to the i^{th} integer ambiguity candidate vector, as various ambiguity candidate vectors trials are made during the ambiguity search process,
[symbol] refers to the partial float ambiguity vector with the j^{th} ambiguity element \hat{N}ⱼ removed. For example, when the full ambiguity vector cannot be fixed, a partial fix is attempted by removing some ambiguity elements.

### GNSS Raw Measurements

The basic GNSS observables are the code and carrier phase measurements between a GNSS satellite s and a receiver r:

$${P}_{r , {L}_{1}}^{s} = {D}_{r}^{s} + {I}_{r , {L}_{1}}^{s} + {B}_{r , {L}_{1}} - {B}_{{L}_{1}}^{s} + {ε}_{{P}_{r {L}_{1}}^{s}} \qquad ( 1 )$$

$${Φ}_{r , {L}_{1}}^{s} {λ}_{{L}_{1}} = {D}_{r}^{s} + {δ}_{p w u} {λ}_{{L}_{1}} - {I}_{r , {L}_{1}}^{s} + {N}_{r , {L}_{1}}^{s} {λ}_{{L}_{1}} + {b}_{r , {L}_{1}} - {b}_{{L}_{1}}^{s} + {ε}_{{Φ}_{r , {L}_{1}}^{s}} \qquad ( 2 )$$

$${P}_{r , {L}_{2}}^{S} = {D}_{r}^{s} + \frac{{f}_{{L}_{1}}^{2}}{{f}_{{L}_{2}}^{2}} {I}_{r , {L}_{1}}^{s} + {B}_{r , {L}_{2}} - {B}_{{L}_{2}}^{s} + {ε}_{{P}_{r {L}_{2}}^{s}} \qquad ( 3 )$$

$${Φ}_{r , {L}_{2}}^{s} {λ}_{{L}_{2}} = {D}_{r}^{s} + {δ}_{p w u} {λ}_{{L}_{2}} - \frac{{f}_{{L}_{1}}^{2}}{{f}_{{L}_{2}}^{2}} {I}_{r , {L}_{1}}^{s} + {N}_{r , {L}_{2}}^{s} {λ}_{{L}_{2}} + {b}_{r , {L}_{2}} - {b}_{{L}_{2}}^{s} + {ε}_{{Φ}_{r , {L}_{2}}^{s}} \qquad ( 4 )$$

$${P}_{r , {L}_{3}}^{S} = {D}_{r}^{s} + \frac{{f}_{{L}_{1}}^{2}}{\text{?}} {I}_{r , {L}_{1}}^{S} + {B}_{r , {L}_{3}} - {B}_{{L}_{3}}^{s} + \text{?} \qquad ( 5 )$$

$${Φ}_{r , {L}_{3}}^{s} {λ}_{{L}_{3}} = {D}_{r}^{s} + {δ}_{p w u} {λ}_{{L}_{3}} - \frac{{f}_{{L}_{1}}^{2}}{{f}_{{L}_{3}}^{2}} {I}_{r , {L}_{1}}^{s} + {N}_{r , {L}_{3}}^{s} {λ}_{{L}_{3}} + {b}_{r , {L}_{3}} - {b}_{{L}_{3}}^{s} + {ε}_{{Φ}_{r , {L}_{3}}^{s}} \qquad ( 6 )$$

$$\text{?} \text{indicates text missing or illegible when filed}$$

where
I is ionospheric delay error,
ε is measurement noise including any un-modeled multipath or other unmodeled errors

$${D}_{r}^{s}$$

represents in the common term

$${D}_{r}^{s} = {ρ}_{r}^{s} + {τ}_{r} - {τ}^{s} + {T}_{r}^{s} + {δ}_{p c v / p c o} + {δ}_{t i d e s} + {δ}_{r e l} + {δ}_{s h a p i r o} \qquad ( 7 )$$

where

$${ρ}_{r}^{s}$$

is the geometric distance from the receiver r phase center to the satellite s phase center;
τᵣ is the receiver clock error;
τ^{s} is the satellite clock error;

$${T}_{r}^{s}$$

is the tropospheric effect (e.g., delay);
δ_{pcv/pco} is the antenna phase delay due to receiver phase center offset and variation, and satellite antenna phase center offset and variation;
δ_{pwu} is the phase wind up due to relative changing orientation between satellite and receiver antennas;
δ_{tides} is the tidal effect including solid earth tide, ocean tides loading, polar tide loading and related parameters;
δᵣₑₗ is relativistic effect on satellite clock; and
δₛₕₐₚᵢᵣₒ is relativistic effect on signal propagation, i.e., Shapiro delay.
   The satellite-receiver geometric distance p is obtained by solving so-called light-time equation, for example the Equation shown below. The equation contains the satellite movement effect during signal propagation and the received time offset by the receiver clock bias. The satellite position is represented in inertial coordinates (ECI) and the station position is presented, in earth-center earth-fixed (ECEF) coordinates.

$$ρ = \vert {r}^{s} ( t - {τ}_{r} - ρ / c ) + {δ}_{a p c s} - {U ( t - dt )}^{T} ( {r}_{r} + {δ}_{s d i s p} ) \vert \qquad ( 8 )$$

where
r^{s}(t) is satellite s position in ECI;
rᵣ is the reference receiver site r position in ECEF;
U(t) is an ECI to ECEF transformation matrix;
δ_{apcs} is the satellite antenna offset between phase center and mass center;
δ_{sdisp} is the site displacement, including solid earth tide, ocean loading, or the like, Coordinates can be transformed between reference frames (e.g., ECI and ECEF) using the matrix U(t), which can be expressed as follows:

$$U ( t ) = {R}_{y} ( - \underline{{x}_{p}} ) {R}_{x} ( - \underline{{y}_{p}} ) {R}_{z} ( GAST ) N ( t ) P ( t ) \qquad ( 9 )$$

$$GAST = GMST + Δψ cos ε \qquad ( 10 )$$

$$GMST = GMST ( {0}^{h} UT 1 ) + r ( {t}_{UTC} + ( UT 1 - UTC ) ) \qquad ( 11 )$$

where
R_{y}, Rₓ, R_{z} are coordinate rotation matrix around x/y/z axis
xₚ, yₚ are polar motion offsets
GAST is Greenwich Apparent Sidereal Time
GMST is Greenwich Mean Sidereal Time
N(t), P(t) are nutation and precession matrix
Δω, ε are nutation in longitude, obliquity
r is ratio of universal to sidereal time
UT1—is earth rotation angle offset

### Hatch-Melbourne-Wubbena Wide-Lane and Extra-Wide-Lane Measurement

In order for satellite corrections generation system to provide global differential corrections, ambiguities need to be resolved across the global network of reference stations. Ambiguity resolution is typically divided into multiple steps. Wide-lane and Extra-Wide-Lane ambiguities are resolved first, followed by narrow-lane ambiguity resolution.
The Hatch-Melbourne-Wubbena linear combination

$${L}_{r , WL}^{s} ,$$

a predefined linear combination of code and phase measurements of satellite navigation signals with two frequencies, can be used for wide-lane ambiguity resolution. Given the code and phase measurements from two frequencies, e.g., L1 and L2 for GPS/QZSS, G1OC/G1C and G2OC/G2C for GLONASS, E1 and E5 AltBoc for Galileo, or B1C and B2 AceBoc (B2A and B2B) for BEIDOU, the Hatch-Melbourne-Wubbena linear combination L_{WL} can be formed as below in the following equation:

$${L}_{r , WL}^{s} = ( \frac{{f}_{{L}_{1}}}{{f}_{{L}_{1}} + {f}_{{L}_{2}}} {P}_{r , {L}_{1}}^{s} + \frac{{f}_{{L}_{2}}}{{f}_{{L}_{1}} + {f}_{{L}_{2}}} {P}_{r , {L}_{2}}^{s} ) - ( \frac{{f}_{{L}_{1}}}{{f}_{{L}_{1}} - {f}_{{L}_{2}}} {Φ}_{r , {L}_{1}}^{s} {λ}_{{L}_{1}} - \frac{{f}_{{L}_{2}}}{{f}_{{L}_{1}} - {f}_{{L}_{2}}} {Φ}_{r , {L}_{2}}^{s} {λ}_{{L}_{2}} ) \qquad ( 12 )$$

By expanding the above equation,

$${Φ}_{r , {L}_{1}}^{s} , {Φ}_{r , {L}_{2}}^{s} , {P}_{r , {L}_{1}}^{s} , {P}_{r , {L}_{2}}^{s}$$

terms include the geometric range related term

$${D}_{r}^{s} ;$$

it can be show that the geometric range related term

$${D}_{r}^{s}$$

and the phase wind-up term are cancelled, as shown in Equation (13):

$${L}_{r , WL}^{s} = {N}_{r , WL}^{s} {λ}_{WL} + {b}_{r , WL} + {b}_{WL}^{s} + {ε}_{{L}_{r , WL}^{s}} \qquad ( 13 )$$

where
b_{r,WL} is receiver wide-lane bias (one per receiver and constellation for all visible satellites), which is a wide-lane combination of L1 and L2 receiver code bias and receiver carrier phase bias, as follows:

$$( 14 )$$

$${b}_{r , WL} = ( \frac{{f}_{{L}_{1}}}{{f}_{{L}_{1}} + {f}_{{L}_{2}}} {B}_{r , {L}_{1}} + \frac{{f}_{{L}_{2}}}{{f}_{{L}_{1}} + {f}_{{L}_{2}}} {B}_{r , {L}_{2}} ) - ( \frac{{f}_{{L}_{1}}}{{f}_{{L}_{1}} - {f}_{{L}_{2}}} {b}_{r , {L}_{1}} - \frac{{f}_{{L}_{2}}}{{f}_{{L}_{1}} - {f}_{{L}_{2}}} {b}_{r , {L}_{2}} ) {b}_{WL}^{s}$$

is satellite wide-lane bias (one per satellite for all receivers), which is a wide-lane combination of L1 and L2 satellite code bias and satellite phase bias.

$${b}_{WL}^{s} = - ( \frac{{f}_{{L}_{1}}}{{f}_{{L}_{1}} + {f}_{{L}_{2}}} {B}_{{L}_{1}}^{s} + \frac{{f}_{{L}_{2}}}{{f}_{{L}_{1}} + {f}_{{L}_{2}}} {B}_{{L}_{2}}^{s} ) + ( \frac{{f}_{{L}_{1}}}{{f}_{{L}_{1}} - {f}_{{L}_{2}}} {b}_{{L}_{1}}^{s} - \frac{{f}_{{L}_{2}}}{{f}_{{L}_{1}} - {f}_{{L}_{2}}} {b}_{{L}_{2}}^{s} ) \qquad ( 15 )$$

Both satellite and receiver wide-lane biases are not constant over time.
λ_{WL} is the wide-lane wavelength, about 86.4 cm for GPS, and c is the speed of light or propagation speed of the carrier signal:

$${λ}_{WL} = \frac{c}{{f}_{{L}_{1}} - {f}_{{L}_{2}}} \\ {N}_{r , WL}^{s} \qquad ( 16 )$$

is the integer wide-lane ambiguity

$${N}_{r , WL}^{s} = ( {N}_{r , {L}_{1}}^{s} - {N}_{r , {L}_{2}}^{s} ) \qquad ( 17 )$$

For simplicity, the abbreviation WL will sometimes be used herein to mean wide-lane measurements, ambiguities and the like, and the Hatch-Melbourne-W\ddot{υ}bbena linear combination will be referred to herein as simply the WL measurement.
In a similar way to the formation of WL measurements, the extra wide-lane (EWL) measurements may be formed given the code and phase measurements from two frequencies, e.g., L2 and L5 for GPS/QZSS, G2OC and G3OC for GLONASS, E₆ and E₅ (or E5B, E5A), the Alternative Binary Offset Carrier (AltBOC) for Galileo, or B3 and B2 (or B2A, B2B), the Asymmetric Constant Envelope Binary Offset Carrier (ACE-BOC) for BEIDOU, the Hatch-Melboume-W\ddot{υ}bbena extra linear combination L_{EWL} can be formed as below.

$${L}_{r , EWL}^{s} = ( \frac{{f}_{{L}_{2}}}{{f}_{{L}_{2}} + {f}_{{L}_{3}}} {P}_{r , {L}_{2}}^{s} + \frac{{f}_{{L}_{2}}}{{f}_{{L}_{2}} + {f}_{{L}_{3}}} {P}_{r , {L}_{3}}^{s} ) - ( \frac{{f}_{2}}{{f}_{{L}_{2}} - {f}_{{L}_{3}}} {Φ}_{r , {L}_{2}}^{s} {λ}_{{L}_{2}} - \frac{{f}_{{L}_{3}}}{{f}_{{L}_{2}} - {f}_{{L}_{3}}} {Φ}_{r , {L}_{3}}^{s} {λ}_{{L}_{3}} ) \qquad ( 18 )$$

By expanding the above equation it can be shown that the geometric range related term D and the phase wind-up term are cancelled, as shown in equation:

$${L}_{r , yEWL}^{s} = {N}_{r , EWL}^{s} {λ}_{EWL} + {b}_{r , EWL} + {b}_{EWL}^{s} + {ε}_{{L}_{r , EWL}^{s}} \qquad ( 19 )$$

where
b_{r,EWL} is receiver extra-wide-lane bias (one per receiver and constellation for all visible satellites), which is an extra-wide-lane combination of L2 and L3 receiver code bias and receiver carrier phase bias, as follows:

$${b}_{r , EWL} = ( \frac{{f}_{{L}_{2}}}{{f}_{{L}_{2}} + {f}_{{L}_{3}}} {B}_{r , {L}_{2}} + \frac{{f}_{{L}_{3}}}{{f}_{{L}_{2}} + {f}_{{L}_{3}}} {B}_{r , {L}_{3}} ) - ( \frac{{f}_{{L}_{2}}}{{f}_{{L}_{2}} - {f}_{{L}_{3}}} {b}_{r , {L}_{2}} - \frac{{f}_{{L}_{3}}}{{f}_{{L}_{2}} - {f}_{{L}_{3}}} {b}_{r , {L}_{3}} ) \\ {b}_{EWL}^{s} \qquad ( 20 )$$

is satellite extra-wide-lane bias (one per satellite for all receivers), which is an extra-wide-lane combination of L2 and L3 satellite code bias and satellite phase bias,

$${b}_{EWL}^{s} = - ( \frac{{f}_{{L}_{2}}}{{f}_{{L}_{2}} + {f}_{{L}_{3}}} {B}_{{L}_{2}}^{s} + \frac{{f}_{{L}_{3}}}{{f}_{{L}_{2}} + {f}_{{L}_{3}}} {B}_{{L}_{3}}^{s} ) + ( \frac{{f}_{{L}_{2}}}{{f}_{{L}_{2}} - {f}_{{L}_{3}}} {b}_{{L}_{2}}^{s} - \frac{{f}_{{L}_{3}}}{{f}_{{L}_{2}} - {f}_{{L}_{3}}} {b}_{{L}_{3}}^{s} ) \qquad ( 21 )$$

Both satellite and receiver wide-lane biases (e.g., WL biases and ELW biases) are not constant over time. λ_{EWL} is the extra-wide-lane wavelength, about 5.86 m for GPS,

$${λ}_{WL} = \frac{c}{{f}_{{L}_{2}} - {f}_{{L}_{3}}} , \qquad ( 22 )$$

where c or C is the speed of light, where f_{L2} is the second carrier frequency, and where f_{L3} is the third carrier frequency.

$${N}_{r , EWL}^{s}$$

is the integer extra-wide-lane ambiguity as follows:

$${N}_{r , EWL}^{s} = ( {N}_{r , {L}_{2}}^{s} - {N}_{r , {L}_{3}}^{s} ) \qquad ( 23 )$$

For simplicity, the abbreviation EWL will sometimes be used herein to mean extra-wide-lane measurements, ambiguities and the like, and the Hatch-Melbourne-Wubbena extra linear combination will be referred to herein as simply the EWL measurement.

### Ambiguity-Fixed-Ionosphere-Free (AFIF) Combination Measurements

Given three different frequency carrier phase measurements (e.g., L1, L2 and L3), the linear combination of the three carrier phase measurements removes the first order ionospheric refraction error, which is refraction corrected wide-lane phase measurements. The resultant refraction corrected wide-lane measurements are expressed in the following Equation 24:

$$\begin{matrix}{Φ}_{r , AFIF}^{s} = \frac{{f}_{{L}_{1}}}{{f}_{{L}_{1}} - {f}_{{L}_{3}}} ( \frac{{f}_{{L}_{1}}}{{f}_{{L}_{1}} - {f}_{{L}_{2}}} {Φ}_{r , {L}_{1}}^{s} - \frac{{f}_{{L}_{2}}}{{f}_{{L}_{1}} - {f}_{{L}_{2}}} {Φ}_{r , {L}_{2}}^{s} ) - \\ \frac{{f}_{{L}_{3}}}{{f}_{{L}_{1}} - {f}_{{L}_{3}}} ( \frac{{f}_{{L}_{2}}}{{f}_{{L}_{2}} - {f}_{{L}_{3}}} {Φ}_{r , {L}_{2}}^{s} - \frac{{f}_{{L}_{3}}}{{f}_{{L}_{2}} - {f}_{{L}_{3}}} {Φ}_{r , {L}_{3}}^{s} ) \\ = {D}_{r}^{s} + {b}_{r , AFIF} + {b}_{r , AFIF}^{s} + \frac{{f}_{{L}_{1}}}{{f}_{{L}_{1}} - {f}_{{L}_{3}}} {λ}_{WL} {N}_{WL} - \\ \frac{{f}_{{L}_{3}}}{{f}_{{L}_{1}} - {f}_{{L}_{3}}} {λ}_{EWL} {N}_{EWL} + {ε}_{{Φ}_{r , AFIF}^{s}}\end{matrix} \qquad ( 24 )$$

where
b_{r,AFIF} is receiver ambiguity-free, ionosphere-free (AFIF) bias (one per receiver and constellation for all visible satellites), which is a combination of L1, L2 and L3 receiver carrier phase bias, as follows:

$${b}_{r , AFIF} = \frac{{Cf}_{{L}_{1}}}{( {f}_{{L}_{1}} - {f}_{{L}_{2}} ) ( {f}_{{L}_{1}} - {f}_{{L}_{3}} )} {b}_{r , {L}_{1}} + \frac{{Cf}_{{L}_{2}}}{( {f}_{{L}_{2}} - {f}_{{L}_{1}} ) ( {f}_{{L}_{2}} - {f}_{{L}_{3}} )} {b}_{r , {L}_{2}} + \frac{{Cf}_{{L}_{3}}}{( {f}_{{L}_{3}} - {f}_{{L}_{1}} ) ( {f}_{{L}_{3}} - {f}_{{L}_{2}} )} {b}_{r , {L}_{3}} \\ {b}_{r , AFIF}^{s} \qquad ( 25 )$$

is satellite ambiguity-free, ionosphere-free (AFIF) bias (one per satellite for all receivers), which is a combination of L1, L2 and L3 satellite phase bias as follows, both satellite and receiver wide-lane biases are not constant over time.

$${b}_{r , AFIF}^{s} = \frac{{Cf}_{{L}_{1}}}{( {f}_{{L}_{1}} - {f}_{{L}_{2}} ) ( {f}_{{L}_{1}} - {f}_{{L}_{3}} )} {b}_{{L}_{1}}^{s} + \frac{{Cf}_{{L}_{2}}}{( {f}_{{L}_{2}} - {f}_{{L}_{1}} ) ( {f}_{{L}_{2}} - {f}_{{L}_{3}} )} {b}_{{L}_{2}}^{s} + \frac{{Cf}_{{L}_{3}}}{( {f}_{{L}_{3}} - {f}_{{L}_{1}} ) ( {f}_{{L}_{3}} - {f}_{{L}_{2}} )} {b}_{{L}_{3}}^{s} \qquad ( 26 )$$

It should be mentioned that b_{r,AFIF} in Equation 23 represents a receiver phase bias τᵣ for each receiver and each GNSS constellation, which is required to be modelled after both extra-wide-lane ambiguities and wide-lane ambiguities are resolved.

### Refraction Corrected Narrow-Lane Measurements

Refraction corrected (RC) measurements are formed to eliminate first order ionospheric effects. The RC code measurement is formed as shown below, which has meter-level accuracy but is unbiased.

$$\begin{matrix}{P}_{r , RC}^{s} = \frac{{f}_{{L}_{1}}^{2}}{{f}_{{L}_{1}}^{2} - {f}_{{L}_{2}}^{2}} {P}_{r , {L}_{1}}^{s} - \frac{{f}_{{L}_{2}}^{2}}{{f}_{{L}_{1}}^{2} - {f}_{{L}_{2}}^{2}} {P}_{r , {L}_{2}}^{S} \\ = {D}_{r}^{s} + {B}_{r , NL} - {B}_{NL}^{s} + {ε}_{{P}_{r , RC}^{s}}\end{matrix} \qquad ( 27 )$$

For each satellite, a refraction corrected (RC) carrier phase measurement,

$${Φ}_{r , RC}^{s} ,$$

is formed as shown below,

$${\hat{N}}_{r , NL}^{s} {λ}_{NL} . \\ \begin{matrix}{Φ}_{r , RC}^{s} {λ}_{NL} = \frac{{f}_{{L}_{1}}^{2}}{{f}_{{L}_{1}}^{2} - {f}_{{L}_{2}}^{2}} {Φ}_{r , {L}_{1}}^{s} {λ}_{{L}_{1}} - \frac{{f}_{{L}_{2}}^{2}}{{f}_{{L}_{1}}^{2} - {f}_{{L}_{2}}^{2}} {Φ}_{r , {L}_{2}}^{s} {λ}_{{L}_{2}} \\ = {D}_{r}^{s} + {δ}_{pwu} {λ}_{NL} + {AMB}_{r , RC}^{s} + {b}_{r , NL} - {b}_{NL}^{s} + {ε}_{{Φ}_{r , RC}^{s}}\end{matrix} \qquad ( 28 )$$

where:
B_{r,NL} is the receiver r narrow-lane code bias (one per receiver and constellation for all visible satellites), which is an RC combination of L1 receiver code bias and L2 receiver code bias. B_{r,NL} is lumped into the receiver clock (bias) and will be estimated together as receiver clock nuisance parameters. In some embodiments, for simplicity, the bias B_{r,NL} in Equation (27) can be ignored.

$${B}_{NL}^{s}$$

is satellite s narrow-lane code bias (one per satellite for all receivers), which is a RC combination of L1 satellite code bias and L2 satellite code bias.

$${B}_{N L}^{s}$$

is lumped into satellite crock and will be estimated together as satellite clock corrections. In some embodiments, for simplicity, the bias

$${B}_{N L}^{s}$$

in equation (27) can be ignored.
b_{r,NL} is the receiver r narrow-lane phase bias (one per receiver and constellation for all visible satellites), which is a RC combination of L1 receiver phase bias and L2 receiver phase bias. If B_{r,NL} is lumped into the ambiguity bias, b_{r,NL} in Equation (28) can be ignored, but as a result, individual ambiguities do not have integer values (sometimes expressed as “no longer having the integer property”). However, single differenced ambiguities between satellites keep as an integer (sometimes expressed as still having the integer property).

$${b}_{N L}^{s}$$

is the satellite s narrow-lane phase bias (one per satellite for all receivers), which is an RC combination of L1 satellite phase bias and L2 satellite phase bias. Both satellite and receiver narrow-lane biases are not constant over time. The satellite s narrow-lane bias also represents the fractional part of the difference between a code-based clock and integer phase-based clock. If the

$${B}_{N L}^{s}$$

is lumped into the satellite clock, the

$${b}_{N L}^{s}$$

is Equation (28) becomes the difference

$${b}_{N L}^{s} - {B}_{N L}^{s} . {AMB}_{r , R C}^{s}$$

is the RC carrier phase ambiguity term, as below

$$A M {B}_{r , R C}^{s} = \frac{{f}_{{L}_{1}}^{2}}{{f}_{{L}_{1}}^{2} - {f}_{{L}_{2}}^{2}} {N}_{r , {L}_{1}}^{s} {λ}_{{L}_{1}} - \frac{{f}_{{L}_{2}}^{2}}{{f}_{{L}_{1}}^{2} - {f}_{{L}_{2}}^{2}} {N}_{r , {L}_{2}}^{s} {λ}_{{L}_{2}} \qquad ( 29 )$$

λ_{NL} is narrow-lane wavelength, about 10.7 cm for GPS, which is much smaller than WL wavelength λ_{WL}

$${λ}_{N L} = \frac{c}{{f}_{{L}_{1}} + {f}_{{L}_{2}}} \qquad ( 30 )$$

The RC carrier phase ambiguity term

$$A M {B}_{r , R C}^{s}$$

can be further divided into two integer ambiguity terms.
There are three equivalent combination forms, as shown in Equation (28):
1) a combination of integer WL ambiguity

$${N}_{r , WL}^{s}$$

and integer NL ambiguity,

$${N}_{r , NL}^{s} where {N}_{r , N L}^{s} = ( {N}_{r , {L}_{1}}^{s} + {N}_{r , {L}_{2}}^{s} ) ;$$

2) a combination of integer WL ambiguity

$${N}_{r , WL}^{s}$$

and integer L1 carrier phase ambiguity

$${N}_{r , {L}_{1}}^{s} ;$$

and
3) a combination of integer WL ambiguity

$${N}_{r , WL}^{s}$$

and integer L2 carrier phase ambiguity

$$\begin{matrix}{N}_{r , {L}_{2}}^{s} : {AMB}_{r , R C}^{s} == \frac{{N}_{r , WL}^{s}}{2} {λ}_{W L} + \frac{{N}_{r , NL}^{s}}{2} {λ}_{N L} \\ = {λ}_{N L} ( {N}_{r , {L}_{1}}^{s} + \frac{{f}_{{L}_{2}}}{{f}_{{L}_{1}} - {f}_{{L}_{2}}} {N}_{r , WL}^{s} ) \\ = {λ}_{N L} ( {N}_{r , {L}_{2}}^{s} + \frac{{f}_{{L}_{1}}}{{f}_{{L}_{1}} - {f}_{{L}_{2}}} {N}_{r , WL}^{s} )\end{matrix} \qquad ( 31 )$$

In some embodiments, the third combination shown above is used. Using that form, both the WL ambiguity integer

$${N}_{r , WL}^{s}$$

and L2 carrier phase ambiguity integer

$${N}_{r , {L}_{2}}^{s}$$

need to be resolved in order to remove the bias term from the RC carrier phase measurement. As long as the bias terms are removed from the RC phase measurements, the high accuracy carrier phase measurement can be used to provide centimeter-level positioning.

The narrow-lane (NL) wavelength is much smaller than the wide-lane (WL) wavelength. In the case of GPS, the NL wavelength is about 10.7 cm, while the WL wavelength is about 86.4 cm. Therefore, in comparison with

$${N}_{r , {L}_{2}}^{s} ,$$

the GPS WL ambiguity integer

$${N}_{r , WL}^{s}$$

can be resolved easily. Moreover, in order to recover the integer property of the L1 and L2 ambiguities,

$${N}_{r , {L}_{1}}^{s} and {N}_{r , {L}_{2}}^{s}$$

(see ambiguity terms in equation 28), the WL ambiguity integer

$${N}_{r , WL}^{s}$$

is resolved first because the GNSS WL ambiguity is much easier to be resolved than the NL ambiguity.

When or after the WL ambiguity integer

$${N}_{r , WL}^{s}$$

has been resolved, using the ambiguity combination form shown in Equations (28, 31), for a refraction-corrected narrow-lane measurement can be rewritten as:

$${Φ}_{r , RC}^{s} {λ}_{NL} - \frac{{f}_{{L}_{1}}}{{f}_{{L}_{1}} - {f}_{{L}_{2}}} {N}_{r , WL}^{s} {λ}_{NL} + {D}_{r}^{s} + {δ}_{pwu} {λ}_{NL} + {N}_{r , {L}_{2}}^{S} {λ}_{NL} + {b}_{r , NL} - {b}_{NL}^{s} + {ε}_{{Φ}_{r , NL}^{s}} \qquad ( 32 )$$

For simplicity, the abbreviation NL will sometimes be used herein to mean narrow-lane measurements, ambiguities and the like. Since the RC measurements are formed to resolve NL ambiguity, the RC measurement is sometimes herein referred to as the NL measurement. Since the L2 carrier phase ambiguity

$${N}_{r , {L}_{2}}^{s}$$

cycle is measured in units of un NL wavelength, the L2 ambiguity

$${N}_{r , {L}_{2}}^{s}$$

is sometimes herein referred to as the NL ambiguity. It should be noted that the un-differenced (sometimes herein called the zero difference) ambiguity is not an integer if the receiver carrier phase bias b_{r,NL} is lumped into the ambiguity term in order to reduce the number of estimated parameters to be resolved. However, single differenced ambiguities can still be estimated as integers.

### Differential Extra-Wide-Lane, Wide-Lane and Narrow-Lane Ambiguities

Differential ambiguities are useful for determining navigation solutions because receiver bias and/or satellite bias terms are cancelled when using such differential ambiguities. There are two main forms of differential ambiguities: single difference (SD) between satellites and double difference (DD) ambiguities between satellites and receivers.

### Single Difference Extra-Wide-Lane, Wide-Lane and Narrow-Lane Ambiguities

In the case that the difference of measurements is formed between a satellite pair s₁ and s₂ from the same GNSS constellation and tracked by the same receiver r, the common part of the receiver bias is removed when forming the difference value. The single difference (SD) EWL measurement between satellites can be modelled as:

$$∇ {L}_{r , EWL}^{{s}_{1} {s}_{2}} = {L}_{r , EWL}^{{s}_{1}} - {L}_{r , EWL}^{{s}_{2}} = {N}_{r , EWL}^{{s}_{1} {s}_{2}} {λ}_{EWL} + ( {b}_{EWL}^{{s}_{1}} - {b}_{EWL}^{{s}_{2}} ) \qquad ( 33 )$$

The single difference (SD) WL measurement between satellites can be modelled as:

$$∇ {L}_{r , WL}^{{s}_{1} {s}_{2}} = {L}_{r , WL}^{{s}_{1}} - {L}_{r , WL}^{{s}_{2}} = {N}_{r , WL}^{{s}_{1} {s}_{2}} {λ}_{WL} + ( {b}_{WL}^{{s}_{1}} - {b}_{WL}^{{s}_{2}} ) \qquad ( 34 )$$

The SD NL measurement between satellites can be modelled as

$$∇ {Φ}_{r , RC}^{{s}_{1} {s}_{2}} {λ}_{NL} = {D}_{r}^{{s}_{1} {s}_{2}} + ( {N}_{r , {L}_{2}}^{{s}_{1} {s}_{2}} + \frac{{f}_{{L}_{1}}}{{f}_{{L}_{1}} - {f}_{{L}_{2}}} {N}_{r , WL}^{{s}_{1} {s}_{2}} ) {λ}_{NL} - ( {b}_{NL}^{{s}_{1}} - {b}_{NL}^{{s}_{2}} ) \qquad ( 35 )$$

Instead of Equations 33-35 where two satellites are tracked by the same receiver, if single difference SD measurements of carrier phase are formed between a receiver pair r₁ and r₂ tracking the same satellite, the common part of satellite bias bs can be removed.

### Double Difference Extra-Wide-Lane, Wide-Lane and Narrow-Lane Ambiguities

By forming Double Difference (DD) measurements between a satellite pair s₁ and s₂, and a receiver pair r₁ and r₂, the remaining terms left are the DD integer ambiguity term. The DD EWL measurement can be modeled as the following equation:

$$\begin{matrix}Δ ∇ {L}_{{r}_{1} {r}_{2} , EWL}^{{s}_{1} {s}_{2}} = ( {L}_{{r}_{1} , EWL}^{{s}_{1}} - {L}_{{r}_{1} , EWL}^{{s}_{2}} ) - ( {L}_{{r}_{2} , EWL}^{{s}_{1}} - {L}_{{r}_{2} , EWL}^{{s}_{2}} ) \\ = {N}_{{r}_{1} {r}_{2} , EWL}^{{s}_{1} {s}_{2}} {λ}_{EWL} + {ε}_{Δ ∇ {L}_{{r}_{1} {r}_{2} , EWL}^{{s}_{1} {s}_{2}}}\end{matrix} \qquad ( 36 )$$

The DD WL measurement can be modeled as the following equation:

$$Δ ∇ {L}_{{r}_{1} {r}_{2} , WL}^{{s}_{1} {s}_{2}} = ( {L}_{{r}_{1} , WL}^{{s}_{1}} - {L}_{{r}_{1} , WL}^{{s}_{2}} ) - ( {L}_{{r}_{2} , WL}^{{s}_{1}} - {L}_{{r}_{2} , WL}^{{s}_{2}} ) = {N}_{{r}_{1} {r}_{2} , WL}^{{s}_{1} {s}_{2}} {λ}_{WL} + {ε}_{Δ ∇ {L}_{{r}_{1} {r}_{2} , WL}^{{s}_{1} {s}_{2}}} \qquad ( 37 )$$

The DD NL measurement can be modeled as the following equation:

$$Δ ∇ {Φ}_{{r}_{1} {r}_{2} , NL}^{{s}_{1} {s}_{2}} = {D}_{{r}_{1} {r}_{2}}^{{s}_{1} {s}_{2}} + ( {N}_{{r}_{1} {r}_{2} , {L}_{2}}^{{s}_{1} {s}_{2}} + \frac{{f}_{{L}_{1}}}{{f}_{{L}_{1}} - {f}_{{L}_{2}}} {N}_{{r}_{1} {r}_{2} , WL}^{{s}_{1} {s}_{2}} ) {λ}_{NL} + {ε}_{Δ ∇ {Φ}_{{r}_{1} {r}_{2} , NL}^{{s}_{1} {s}_{2}}} \qquad ( 38 )$$

### Ambiguity Search

The integer ambiguity values in above Equations 36 through 38 can be resolved through various methods, such as the Least-squares AMBiguity Decorrelation Adjustment method (LAMBDA). The Least-squares AMBiguity Decorrelation Adjustment method (LAMBDA) is a common technique used to search for the carrier phase ambiguity integer values. The inputs to the LAMBDA methods are:
a set of float ambiguity estimates,

$${\hat{N}}_{float} = \{ {\hat{N}}_{{r}_{1} {r}_{2}}^{{s}_{1} {s}_{2}} \} ,$$

and
its associated variance co-variance Q_{\hat{N}}_{_{float}}.
   The ambiguity quadratic form R for the i^{th} integer ambiguity candidate set is defined as

$${R}_{i} = {( {\overline{N}}_{i} - {\hat{N}}_{float} )}^{T} {Q}_{{\hat{N}}_{float}}^{- 1} ( {\overline{N}}_{i} - {\hat{N}}_{float} ) \qquad ( 39 )$$

where
\hat{N}_{float} is the float ambiguity set which is n by 1 vector, n is the vector size of float ambiguity set; N float, each ambiguity element is a real number;
Q_{\hat{N}}_{_{float}} is the variance co-variance matrix of \hat{N}_{float}, which is n by n matrix;
N̅ᵢ is the i^{th} best integer ambiguity candidate set, which is n by 1 vector, each ambiguity element is an integer number;
Rᵢ is the ambiguity quadratic form of N̅ᵢ, which is a scalar value.
   All the integer ambiguity candidate sets N̅ᵢ are sorted in terms of Rᵢ from smallest to largest. Accordingly, N̅₁ has the smallest quadratic form R₁. As shown below by condition (40), the ratio between the smallest quadratic form R₁ and the second smallest R₂ is used as one criterion to determine whether to accept the best candidate set of ambiguity integer values as follows:

$${R}_{2} / {R}_{1} > c \qquad ( 40 )$$

where in Equation c is not the speed of light, but an empirical threshold whose value depends on the number of ambiguities and the largest acceptable failure rate, as well as other factors.
If the condition (40) is satisfied, N̅₁ is regarded as the resolved ambiguity integer set N.

### Partial LAMBDA Search

If the condition (40) is not satisfied, for example because R2 is significantly larger than would normally be expected, this indicates that one or more of the integer ambiguity candidate sets could be significantly biased from integer numbers. In some embodiments, in this case a partial fix procedure is used. One or more problematic/biased ambiguity elements are identified and removed before the partial ambiguity subset can be resolved. The resulting partial subset will have a smaller R and a larger ratio R₂/R₁. The partial search is an iterative process that is repeated until the partial ambiguity vector is resolved (e.g., by satisfying condition (40)), or the search fails for the current epoch (e.g., measurement interval for carrier phase measurements by the measurement module) and is resumed in the next epoch.
Overall iCORE Architecture

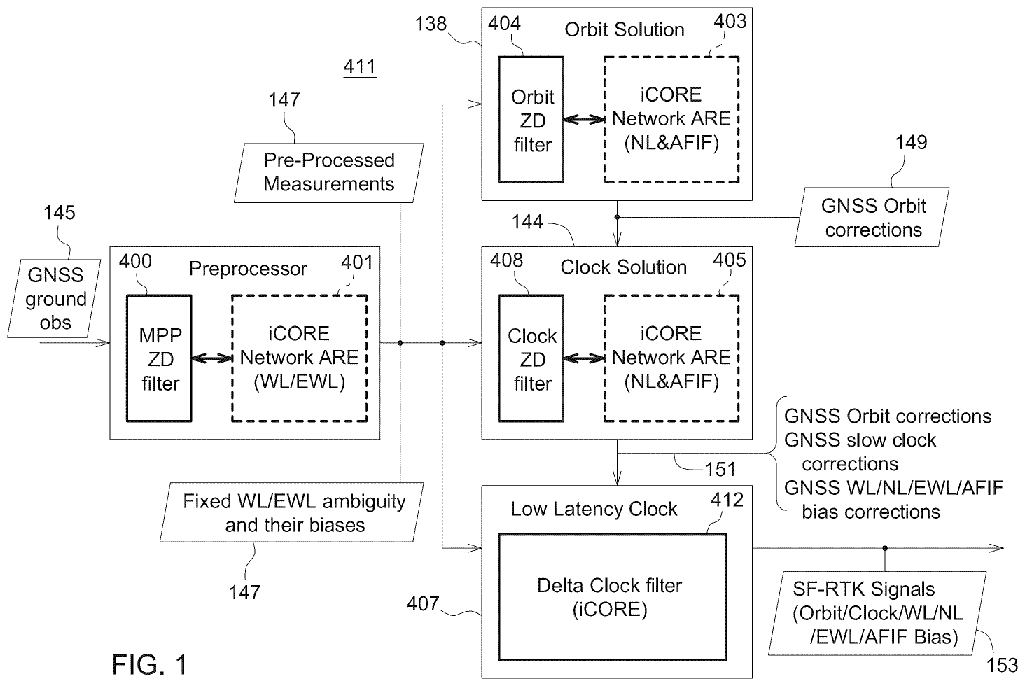

FIG. 1 presents top level architecture and data flow of the Innovative Clock Orbit Real-time Estimator (iCORE) or clock and orbit estimator system 411. There are four main modules:

A preprocessing module 136 (e.g., preprocessor) is configured to prepare pre-processed carrier phase measurements (e.g., cleaned carrier phase measurements, which may address receiver noise and multipath mitigation) and to provide Extra Wide-Lane (EWL) ambiguities and their associated corresponding EWL biases (e.g., on a satellite-by-satellite basis and per epoch or series of epochs), Wide-Lane fixed ambiguities and associated WL biases products (e.g., on a satellite-by-satellite basis and per epoch or series of epochs). The preprocessing module 136 includes a set of zero difference (ZD) filters 400 for both EWL and WL of each GNSS constellation such as GPS/QZSS. GLONASS, GALILEO, BEIDOU, and other GNSS constellations such as NAVIC, dual frequency geo-stationary SBAS systems such WAAS, EGNOS. The zero difference filters 400 and the network ARE (Ambiguity Resolution Engine) 401 are configured to communicate with each other, such that the network ARE 401 is capable of providing Extra Wide-Lane (EWL) ambiguities and their associated corresponding EWL biases (e.g., on a satellite-by-satellite basis and per epoch or series of epochs). Wide-Lane fixed ambiguities and associated WL biases products (e.g., on a satellite-by-satellite basis and per epoch or series of epochs) to the other modules of the clock and orbit system 411.

The orbit solution module 138 is configured to provide accurate satellite position and velocity estimates, which can be expressed as GNSS orbit correction to the satellite position and velocity data in the navigation data or ephemeris data transmitted by each satellite, based on the preprocessed carrier phase measurements. EWL ambiguities and their EWL biases; WL ambiguities and their WL biases from the preprocessing module 136. The orbit solution module 138 has a set of orbit zero difference filters (e.g., for each satellite that is in reception range of the GNSS constellation or GNSS constellations) and a network ARE (Ambiguity Resolution Engine) module 403 that estimates narrow lane (NL) ambiguities and AFIF. In the Ambiguity Resolution Engine (ARE) module 401, the wide-lane ambiguity is resolved first, followed by narrow-lane ambiguity resolution by the network ARE module 403, where the preprocessing module 136 or its ARE module 401 is configured to provide the resolved (or fixed) WL integer ambiguities and resolved (or fixed) EWL integer ambiguities as input to the Ambiguity Resolution Engine 403 within the orbit solution module 138.

In an alternate embodiment, in the Ambiguity Resolution Engine (ARE) 401, the wide-lane ambiguity is resolved first, followed by narrow-lane ambiguity resolution by the network ARE module 403, where the preprocessing module 136 is configured to provide floating WL integer ambiguities and floating EWL integer ambiguities as input to the Ambiguity Resolution Engine within the orbit solution module 138.

The clock solution module 144 is configured to provide satellite slow clock solution estimate. AFIF bias and narrow lane bias products based on the input of GNSS orbit corrections 149 from the orbit solution module 138 and based on the preprocessed output 147 of preprocessed carrier phase measurements. EWL ambiguities and their ELW biases; WL ambiguities and their WL biases from the preprocessing module. The clock solution module 144 has a set of clock zero difference filters 408 (e.g., one per each satellite in reception range for one or more GNSS constellations). The clock zero difference filters 408 and network ARE 405 are configured to communicate with each other such that the network ARE module 405 is capable of providing output data 151, which comprises NL ambiguities. NL bias, AFIF, and AFIF bias. The clock solution module 151 outputs one or more of the following output data 151: GNSS orbit corrections. GNSS slow clock corrections, GNSS WL bias, EWL bias, NL bias, and AFIF bias.

The low latency clock module 407 is configured to provide a (fast) satellite clock estimate (e.g., at 1 Hz sampling frequency) at a greater rate than the slow clock corrections that are outputted by the clock solution module. As illustrated, the low latency clock module 407 comprises a delta clock filter 412. Further, the low latency clock module 407 is configured to generate correction signals (e.g., SF5 StarFire signals) that feature one or more of the following correction data 153: GNSS orbit corrections, GNSS slow clock corrections, GNSS WL bias, EWL bias, NL bias, and AFIF bias.

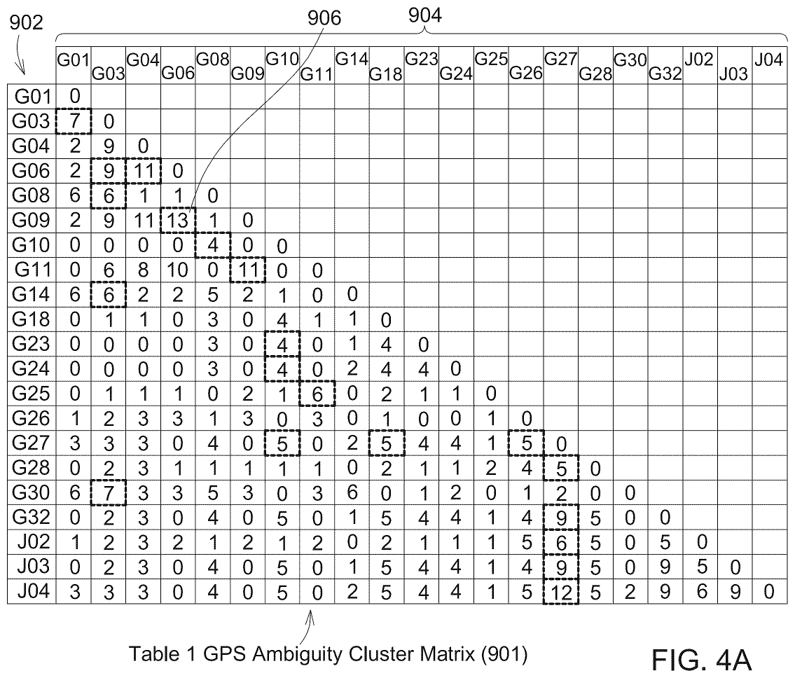

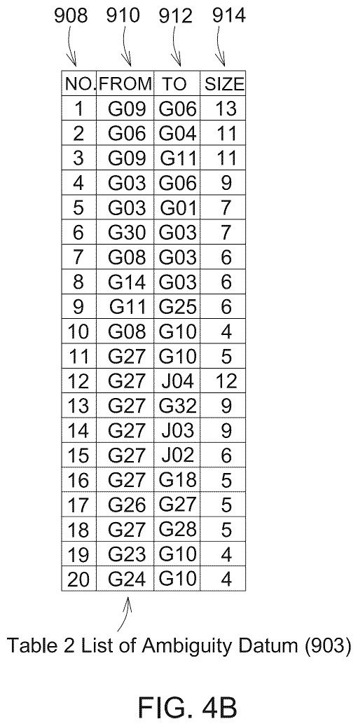

New FIG. 4C provides a flowchart of the method for determining EWL enriched correction data.

### Preprocessor ZD Kalman Filter for HMW Extra-Wide-Lane

In FIG. 1, the zero-difference (ZD) filters 400 of the preprocessing module 136 are configured to apply the Hatch-Melbourne-Wubbena extra linear combination

$${L}_{r , EWL}^{s}$$

described in above Equation (3), for each satellite as the zero-difference measurements that are filtered by a separate ZD filter 400. In one embodiment, each ZD filter 400 comprises a ZD predictive filter, such as ZD Kalman filter, for a corresponding GNSS constellation, which supports at set of satellites within (reliable) reception range (which is also referred to as “visible”) of the reference receiver. For a given satellite signal, the (reliable) reception range may be based on the sensitivity of the reference GNSS receiver, the transmission power of the transmitted satellite signal, the received signal strength at the (reference) GNSS receiver, and electromagnetic signal propagation conditions (e.g., solar activity and noise floor). For example, by design a separate ZD Kalman filter is present for each GNSS constellation, except GPS and QZSS constellations, which can be combined as one constellation. In some embodiments, for this ZD Kalman filter, the Melbourne-W\ddot{υ}bbena extra linear combination

$${L}_{r , EWL}^{s} ,$$

is modeled in accordance with the following equation:

$${L}_{r , EWL}^{s} = {N}_{r , EWL}^{s} {λ}_{EWL} + {b}_{r , EWL} + {b}_{EWL}^{s} \qquad ( 41 )$$

In some embodiments, the preprocessor ZD Kalman filter state variables are:
(a) One EWL integer ambiguity per visible satellite and site pair, N_{EWL}; (b) one receiver extra-wide-lane bias per receiver b_{r,EWL}; (c) a combination state variable where EWL integer ambiguity and EWL bias are combined as one state variable as ZD float EWL ambiguity

$${( AMB )}_{r , EWL}^{s} ;$$

and (d) a sensitivity coefficient is λ_{EWL} for the combination state variable of ZD float EWL ambiguity

$${( AMB )}_{r , EWL}^{s} ,$$

which can be expressed in the following equation:

$${( AMB )}_{r , EWL}^{s} = {N}_{r , EWL}^{s} {λ}_{EWL} + {b}_{r , EWL} \qquad ( 42 )$$

Further, the ZD Kaman filter state variable may include: (e) one satellite extra-wide-lane bias per satellite

$${b}_{EWL}^{s} ,$$

where its sensitivity coefficient is 1.

Within the preprocessing module 136 orts network ARE 401, the Extra-Wide-lane ambiguities are initially resolved by the preprocessing module 136 in double-difference (DD) and single-difference (SD) form. In these forms (e.g., or by use of the DD form), the receiver EWL bias b_{r,EWL} can be cancelled, which reduces the number of parameters to be resolved. Before an initial extra wide-lane satellite bias is estimated or SD ambiguity is fixed, the ZD float ambiguity contains both receiver and satellite extra wide-lane bias. Therefore, the combined float EWL ambiguity term

$$∇ {\hat{N}}_{r , EWL}^{{s}_{i} {s}_{j}}$$

is in essence the SD EWL ambiguity

$$∇ {N}_{r , EWL}^{{s}_{i} {s}_{j}}$$

plus satellite SD EWL bias

$$∇ {b}_{EWL}^{{s}_{i} {s}_{j}} ,$$

which is why initial bias estimation is required in order to fix SD extra wide-lane ambiguity.

$$∇ {\hat{N}}_{r , EWL}^{{s}_{i} {s}_{j}} = {\hat{N}}_{r , EWL}^{{s}_{i}} - {\hat{N}}_{r , EWL}^{{s}_{j}} = ( {N}_{r , EWL}^{{s}_{i}} {λ}_{EWL} + {b}_{r , EWL} + {b}_{EWL}^{{s}_{i}} ) - ( {N}_{r , EWL}^{{s}_{j}} {λ}_{EWL} + {b}_{r , EWL} + {b}_{EWL}^{{s}_{j}} ) = ( {N}_{r , EWL}^{{s}_{i}} - {N}_{r , EWL}^{{s}_{j}} ) {λ}_{EWL} + {b}_{EWL}^{{s}_{i}} - {b}_{EWL}^{{s}_{j}} = ∇ {N}_{r , EWL}^{{s}_{i} {s}_{j}} {λ}_{EWL} + {b}_{EWL}^{{s}_{i}} - {b}_{EWL}^{{s}_{j}} \qquad ( 43 )$$

Furthermore, the DD EWL ambiguity

$$Δ ∇ {\hat{N}}_{{r}_{m} {r}_{n} , EWL}^{{s}_{i} {s}_{j}}$$

is in essence the DD EWL ambiguity

$$∇ {N}_{{r}_{m} {r}_{n} , EWL}^{{s}_{i} {s}_{j}} \cdot Δ ∇ {\hat{N}}_{{r}_{m} {r}_{n} , EWL}^{{s}_{i} {s}_{j}} = ∇ {\hat{N}}_{{r}_{m} , EWL}^{{s}_{i} {s}_{j}} - ∇ {\hat{N}}_{{r}_{n} , EWL}^{{s}_{i} {s}_{j}} = ∇ {N}_{{r}_{m} , EWL}^{{s}_{i} {s}_{j}} {λ}_{EWL} + ∇ {b}_{EWL}^{{s}_{i} {s}_{j}} - ( ∇ {N}_{{r}_{n} , EWL}^{{s}_{i} {s}_{j}} {λ}_{EWL} + ∇ {b}_{EWL}^{{s}_{i} {s}_{j}} ) = ( ∇ {N}_{{r}_{m} , EWL}^{{s}_{i} {s}_{j}} - ∇ {N}_{{r}_{n} , EWL}^{{s}_{i} {s}_{j}} ) {λ}_{EWL} \qquad ( 44 )$$

In order to make the computation effective, the ZD Hatch-Melbourne-Wubbena EWL measurements for each reference receiver site are averaged over a suitable time interval, such as 60 seconds, with well-known additional handling when there is a cycle slip, or loss of lock of the GNSS receiver on the received carrier frequency phase for a received GNSS channel of a satellite (e.g., loss of lock for L1, L2 or L3 for any satellite). In practice, other time intervals fall within the scope of the specification and appended range, such as approximately 10 seconds to approximately 90 seconds. For each interval, averaged ZD Hatch-Melbourne-W\ddot{υ}bbena EWL measurements from global reference network are processed in the ZD Kalman filter (e.g., 400) on a site-by-site basis.

In some embodiments, the same satellite corrections processing system processes signals from the satellites of more than one GNSS constellation (e.g., from the satellites of two or more of the following GNSS constellations: GPS, GLONASS, GALILEO, BEIDOU, QZSS, NAVIC, KPS and SBAS such as WAAS), and in such embodiments the satellite corrections generation system uses a separate extra-wide-lane filter 400 for each GNSS constellation for which signals are being processed. It is noted the reference receiver bias b_{r,EWL} is not used by the navigation receivers to determine their positions. Accordingly, in order to reduce filter size and computation complexity, the reference receiver EWL bias is not explicitly estimated and instead it is combined into the ZD float ambiguity state. Given that the actual ZD float ambiguity state variable for each reference receiver is the sum of the ZD integer ambiguity and the (reference) receiver bias, the receiver bias variance covariance dynamic update is included as follows:

$${Q}_{{( AMB )}_{r , EWL}^{s}}^{n} = {Q}_{{( AMB )}_{r , EWL}^{s}}^{n - 1} + ( \begin{matrix}1 & ⋯ & 1 \\ ⋮ & ⋱ & ⋮ \\ 1 & ⋯ & 1\end{matrix} ) {q}_{{b}_{r , EWL}} \cdot Δ {t}_{n - 1 , n} \qquad ( 45 )$$

where q is the process noise, and Δt_{n-1,n} is the time interval between time tₙ₋₁ and tₙ.
The satellite EWL bias variance covariance dynamic update are as follows:

$${Q}_{{b}_{EWL}^{s}}^{n} = {Q}_{{b}_{EWL}^{s}}^{n - 1} + {q}_{{b}_{EWL}^{s}} \cdot Δ {t}_{n - 1 , n} \qquad ( 46 )$$

### Preprocessor ZD Kalman Filter for HMW Wide-Lane

The ZD filters 400 (e.g., ZD Kalman filters) of the preprocessor module 136 are configured to use or apply the Hatch-Melbourne-W\ddot{υ}bbena (HMW) linear combination

$${L}_{r , WL}^{s}$$

described above, for each satellite as the zero difference measurements that are filtered by the ZD filter 400 (e.g., ZD Kalman filter). In general, the preprocessing module 136 comprises a separate ZD filter (e.g., ZD Kalman filter) for each GNSS constellation, except the GPS and QZSS constellations. In some embodiments, for this ZD filter 400 (e.g., ZD Kalman filter), the Hatch-Melbourne-W\ddot{υ}bbena linear combination

$${L}_{r , WL}^{s} ,$$

is modeled as the following equation:

$${L}_{r , WL}^{s} = {N}_{r , WL}^{s} {λ}_{WL} + {b}_{r , WL} + {b}_{WL}^{s} \qquad ( 47 )$$

In some embodiments, the preprocessor ZD Kalman filter state variables are:
(a) One WL integer ambiguity per visible satellite and site pair, N_{WL}; (b) one receiver wide-lane bias per receiver b_{r,WL}; (c) a combination state variable where WL integer ambiguity and WL bias are combined as one state variable as ZD float WL ambiguity

$${( AMB )}_{r , WL}^{s}$$

and (d) a sensitivity coefficient is λ_{WL} for the combination state variable of ZD float WL ambiguity

$${( AMB )}_{r , WL}^{s} ,$$

which can be expressed in the following equation:

$${( AMB )}_{r , WL}^{s} = {N}_{r , WL}^{s} {λ}_{WL} + {b}_{r , WL} \qquad ( 48 )$$

Further, an additional preprocessor ZD Kalman filter state variables comprises: (d) one satellite wide-lane bias per satellite

$${b}_{WL}^{s} ,$$

where its sensitivity coefficient is 1.

In one embodiment, wide-lane ambiguities are initially resolved by the preprocessing module 136 in DD and SD form. In these forms (e.g., particularly with reference to the DD form), the receiver WL bias b_{r,WL} can be cancelled, which reduces the number of parameters to be resolved. Before an initial wide-lane satellite bias is estimated or SD ambiguity is fixed, the SD float ambiguity contains both receiver and satellite wide-lane bias. Therefore, this combined float WL ambiguity term

$$∇ {\hat{N}}_{r , WL}^{{s}_{i} {s}_{j}}$$

is in essence the SD WL ambiguity

$$∇ {N}_{r , WL}^{{s}_{i} {s}_{j}}$$

plus satellite SD WL bias

$$∇ {b}_{WL}^{{s}_{i} {s}_{j}} ,$$

which is why initial bias estimation is required in order to fix SD wide-lane ambiguity.

$$∇ {\hat{N}}_{r , WL}^{{s}_{i} {s}_{j}} = {\hat{N}}_{r , WL}^{{s}_{i}} - {\hat{N}}_{r , WL}^{{s}_{i}} = ( {N}_{r , WL}^{{s}_{i}} {λ}_{WL} + {b}_{r , WL} + {b}_{WL}^{{s}_{i}} ) - ( {N}_{r , WL}^{{s}_{j}} {λ}_{WL} + {b}_{r , WL} + {b}_{WL}^{{s}_{j}} ) = ( {N}_{r , WL}^{{s}_{i}} - {N}_{r , WL}^{{s}_{j}} ) {λ}_{WL} + {b}_{WL}^{{s}_{i}} - {b}_{WL}^{{s}_{j}} = ∇ {N}_{r , WL}^{{s}_{i} {s}_{j}} {λ}_{WL} + {b}_{WL}^{{s}_{i}} - {b}_{WL}^{{s}_{j}} \qquad ( 49 )$$

Furthermore, the DD WL ambiguity

$$Δ ∇ {\hat{N}}_{{r}_{m} {r}_{n} , WL}^{{s}_{i} {s}_{j}}$$

is in essence the DD WL ambiguity

$$\begin{matrix}∇ Δ {\hat{N}}_{{r}_{m} {r}_{n} , WL}^{{s}_{i} {s}_{j}} = ∇ {\hat{N}}_{{r}_{m} , WL}^{{s}_{i} {s}_{j}} - ∇ {\hat{N}}_{{r}_{n} , WL}^{{s}_{i} {s}_{j}} \\ = ∇ {N}_{{r}_{m} , WL}^{{s}_{i} {s}_{j}} {λ}_{WL} + ∇ {b}_{WL}^{{s}_{i} {s}_{j}} - ( ∇ {N}_{{r}_{n} , WL}^{{s}_{i} {s}_{j}} {λ}_{WL} + ∇ {b}_{WL}^{{s}_{i} {s}_{j}} ) = ( ∇ {N}_{{r}_{m} , WL}^{{s}_{i} {s}_{j}} - ∇ {N}_{{r}_{n} , WL}^{{s}_{i} {s}_{j}} ) {λ}_{WL}\end{matrix} \qquad ( 50 )$$

In order to make the computation effective, the ZD Hatch-Melbourne-W\ddot{υ}bbena measurements for each reference receiver site are averaged over an interval such as 60 seconds, with well-known additional handling when there is a cycle slip, or loss of lock of the GNSS receiver on the received carrier frequency phase for a received GNSS channel of a satellite (e.g., loss of lock for L1, L2 or L3 for any satellite). In practice, other time intervals fall within the scope of the specification and appended range, such as approximately 10 seconds to approximately 90 seconds. For each interval, averaged ZD Hatch-Melbourne-W\ddot{υ}bbena measurements from global reference network are processed in each ZD filter 400 (e.g., Kalman filter) on a site-by-site basis.

In some embodiments, the same satellite corrections data processing center or correction data estimator processes signals from the satellites of more than one GNSS constellation (e.g., from the satellites of two or more of the following GNSS constellations: GPS, GLONASS, GALILEO, BEIDOU, QZSS, NAVIC, KPS and SBAS such as WAAS), and in such embodiments the satellite correction data estimator (34, 134) uses a separate wide-lane filter for each GNSS constellation for which signals are being processed. It is noted the reference receiver WL bias b_{r,WL} is not used by the navigation receivers to determine their positions. Accordingly, in order to reduce filter size of the ZD filter 400 and computation complexity, the reference receiver WL bias is not explicitly estimated and instead it is combined into the ZD float ambiguity state. Given that the actual ZD float ambiguity state variable for each reference receiver is the sum of the ZD integer ambiguity and the receiver bias, the receiver bias variance covariance dynamic update is included as follows:

$${Q}_{{( AMB )}_{r , WL}^{s}}^{n} = {Q}_{{( AMB )}_{r , WL}^{s}}^{n - 1} + ( \begin{matrix}1 & … & 1 \\ ⋮ & ⋱ & ⋮ \\ 1 & … & 1\end{matrix} ) {q}_{{b}_{r , WL}} \cdot Δ {t}_{n - 1 , n} \qquad ( 51 )$$

where q is the process noise, and Δt_{n-1,n} is the time interval between time tₙ₋₁ and tₙ. The satellite WL bias variance covariance dynamic update are as follows:

$${Q}_{{b}_{WL}^{s}}^{n} = {Q}_{{b}_{WL}^{s}}^{n - 1} + {q}_{{b}_{WL}^{s}} \cdot Δ {t}_{n - 1 , n} \qquad ( 52 )$$

### Orbit Solution ZD Kalman Filter

The orbit solution module 138 is configured to process (pre-processed) carrier phase measurements at a fixed interval, such as once every 300 seconds. The preprocessing module 136 and orbit solution module 138 are configured to process both carrier phase measurements, which have carrier phase integer ambiguities (e.g., N_{WL}, N_{EW}L, N_{NL}), and code phase measurements, which are unambiguous. The orbit solution module 138 outputs the estimated satellite positions and satellite velocities, or equivalently, corrections to previously established (e.g., published) satellite positions and velocities, such as ephemeris data in the navigation data that is encoded one or more transmitted satellite signals that are decoded (e.g., demodulated) and provided to the clock solution module 144. The orbit solution module 138 is configured to use the AFIF phase combination measurements in Equation 24, refraction-corrected code and carrier phase measurement in Equations 27-28, above, in accordance with the following equations:

$${Φ}_{r , AFIF}^{s} = {ρ}_{r}^{s} + {\tilde{τ}}_{r} - {\tilde{τ}}^{s} + {T}_{r}^{s} + {δ}_{pcv / pco} + {δ}_{tides} + {δ}_{rel} + {b}_{r , AFIF} + {b}_{r , AFIF}^{s} + \frac{{f}_{{L}_{1}}}{{f}_{{L}_{1}} - {f}_{{L}_{3}}} {λ}_{WL} {N}_{WL} - \frac{{f}_{{L}_{3}}}{{f}_{{L}_{1}} - {f}_{{L}_{3}}} {λ}_{EWL} {N}_{EWL} \qquad ( 53 )$$

The refraction-corrected code measurement can be modelled as:

$${P}_{r , RC}^{s} = {ρ}_{r}^{s} + {\tilde{τ}}_{r} - {\tilde{τ}}^{s} + {T}_{r}^{s} + {δ}_{pcv / pco} + {δ}_{tides} + {δ}_{rel} \qquad ( 54 )$$

The refraction-corrected carrier phase measurement can be modelled as:

$${Φ}_{r , RC}^{s} {λ}_{NL} = {ρ}_{r}^{s} + {\tilde{τ}}_{r} - {\tilde{τ}}^{s} + {T}_{r}^{s} + {AMB}_{r , RC}^{s} + {b}_{r , NL} - {b}_{NL}^{s} + {δ}_{pcv / pco} + {δ}_{tides} + {δ}_{rel} + {δ}_{pwu} {λ}_{NL} \qquad ( 55 )$$

where:
ρᵣ^{s} is the satellite true range, which can be further modelled as explained below. The satellite orbit position [x^{s} y^{s} z^{s}], velocity and other parameters such as solar radiation pressure are to be estimated, the reference station coordinates are [xᵣ yᵣ zᵣ], which are pre-surveyed as known coordinates or estimated as unknown parameters.

$${ρ}_{r}^{s} = \sqrt{{( {x}^{s} - {x}_{r} )}^{2} + {( {y}^{s} - {y}_{r} )}^{2} + {( {z}^{s} - {z}_{r} )}^{2}} \qquad ( 56 )$$

\tilde{τ}ᵣ is the receiver clock and each GNSS bias terms, which is the combination of receiver clock TCXO error τᵣ, GNSS system bias B_{r,GNSS} and receiver code bias B_{r,NL}:

$${\tilde{τ}}_{r} = {τ}_{r} + {B}_{r , NL} + {B}_{r , GNSS} \qquad ( 57 )$$

The clock state for each GNSS constellation represents the receiver TXCO offset, GNSS system bias, differential code bias. The underlying relationships between these clocks will be reflected through dedicated variance-covariance propagation. This design is particularly suitable for any combination of multi-GNSS systems and multi-frequencies.

The overall clock state vector tr can represent the following physical parameters in below Equation (58):

$$T = ( \begin{matrix}{τ}_{r , GPS / QZSS} \\ {τ}_{r , GLN} \\ {τ}_{r , GAL} \\ {τ}_{r , BDS}\end{matrix} ) = ( \begin{matrix}1 & 1 & 0 & 0 & 0 \\ 1 & 0 & 1 & 0 & 0 \\ 1 & 0 & 0 & 1 & 0 \\ 1 & 0 & 0 & 0 & 1\end{matrix} ) ( \begin{matrix}{τ}_{r , TCXO} \\ {B}_{r , GPS / QZSS} \\ {B}_{r , GLN} \\ {B}_{r , GAL} \\ {B}_{r , BDS}\end{matrix} ) = HB \qquad ( 58 )$$

Where T is receiver clock state vector to be modeled including GPS/QZSS clock τ_{r,GPS/QZSS}, GLONASS clock τ_{r,GLN} GALILEO clock τ_{r,GAL} and BEIDOU clock τ_{r,BDS}. The term τ_{r,TCXO} represents the common oscillator which is same for all the clocks from the reference receiver (20). The bias B_{r,GPS/QZSS}, B_{r,GLN}, B_{r,GAL} and B_{r,BDS} indicate system bias for each GNSS constellation or GNSS system. The receiver clock bias variance covariance Q_{T}ⁿ update can be done as follows:

$${Q}_{T}^{n} = {Q}_{T}^{n - 1} + H * {Q}_{B} * {H}^{′} \cdot Δ {t}_{n - 1 , n} \qquad ( 59 )$$

$${Q}_{B} = ( \begin{matrix}{q}_{r , TCXO} & 0 & 0 & 0 & 0 \\ 0 & {q}_{r , GPS / QZSS} & 0 & 0 & 0 \\ 0 & 0 & {q}_{r , GLN} & 0 & 0 \\ 0 & 0 & 0 & {q}_{r , GAL} & 0 \\ 0 & 0 & 0 & 0 & {q}_{r , BDS}\end{matrix} ) \qquad ( 60 )$$

The abovementioned dynamic noise matrix q_{r,TCXO} could be very large such as 100 m/s. However, the dynamic noise for bias B_{r,GPS/QZSS}, B_{r,GLN}, B_{r,GAL} and B_{r,BDS} could be small such as 0.1 m/s.
b_{r,AFIF} is the AFIF receiver phase bias vector for each GNSS constellation per receiver including GPS/QZSS, GLONASS, Galileo and BEIDOU system.

$${b}_{r , AFIF}^{s}$$

is the AFIF satellite phase bias for each satellite with triple frequency signals (e.g., L1, L2, L3).

$${T}_{r}^{s}$$

is this tropospheric delay, and is divided into a dry component

$${T}_{r , dry}^{s}$$

and a wet component

$${T}_{r , wet}^{s} : {T}_{r}^{s} = {T}_{r , dry}^{s} + {T}_{r , wet}^{s} \qquad ( 61 )$$

The dry component can be accurately pre-calculated. The remaining wet component

$${T}_{r , wet}^{s} ,$$

can be further modelled as below, where M_{wet} is the wet mapping function, e is the elevation angle, and α is the azimuth, all of which can be calculated in accordance with the following equation:

$${T}_{r , wet}^{s} = {M}_{wet} \cdot {Z}_{wet} + {M}_{wet} ctg ( e ) cos ( α ) \cdot {G}_{NS} + {M}_{wet} ctg ( e ) sin ( α ) \cdot {G}_{EW} \qquad ( 62 )$$

In the above equation for the wet component,

$${T}_{r , wet}^{s} ,$$

there are three unknowns to solve: (1) the tropospheric zenith delay wet component Z_{wet}, (2) the tropospheric wet component horizontal gradient for the north-south direction G_{NS}, and (3) the tropospheric wet component horizontal gradient for the east-west direction G_{EW}.

Similar to the processing of WL measurements by the preprocessing module 136, in the orbit solution module 138, the reference receiver NL phase bias is not explicitly estimated, but instead is combined into the NL float ambiguity state. The ambiguity term and receiver narrow-lane phase bias per receiver, b_{r,NL}, are combined as one state in the RC float ambiguity term

$${( A M B )}_{r , RC}^{s}$$

as follows:

$${( A M B )}_{r , R C}^{s} = A M {B}_{r , R C}^{s} + {b}_{r , N L} \qquad ( 63 )$$

From equation (24),

$$A M {B}_{r , RC}^{s}$$

is a combination of WL and NL ambiguities,

$${\hat{N}}_{r , WL}^{s} and {\hat{N}}_{r , {L}_{2}}^{s} ,$$

as follows:

$$A M {B}_{r , RC}^{s} = {λ}_{NL} [ {\hat{N}}_{r , {L}_{2}}^{s} + \frac{{f}_{1}}{{f}_{1} - {f}_{2}} {\hat{N}}_{r , WL}^{s} ] .$$

In the case that the WL ambiguity has been resolved, for example by the preprocessing module 136, as would typically be the case for signal processing by the orbit solution module 138, the combined RC float ambiguity term

$${( A M B )}_{r , RC}^{s}$$

can be rewritten as

$${( A M B )}_{r , RC}^{s} = {λ}_{N L} [ {\hat{N}}_{r , {L}_{2}}^{s} + \frac{{f}_{1}}{{f}_{1} - {f}_{2}} {\hat{N}}_{r , WL}^{s} ] + {b}_{r , NL} = [ {\hat{N}}_{r , {L}_{2}}^{s} {λ}_{NL} + {b}_{r , NL} ] + \frac{{f}_{1}}{{f}_{1} - {f}_{2}} {\hat{N}}_{r , WL}^{s} {λ}_{NL} \qquad ( 64 )$$

In the case that the SD WL ambiguity has already been resolved, as would typically be the case for signal processing by the orbit solution module 138, only the quantity

$$[ {\hat{N}}_{r , {L}_{2}}^{s} {λ}_{NL} + {b}_{r , NL} ]$$

needs to be solved for.
This quantity is defined as the modified RC float ambiguity term:

$${( A M B )}_{r , RC}^{s *} = {\hat{N}}_{r , {L}_{2}}^{s} {λ}_{NL} + {b}_{r , NL} \qquad ( 65 )$$

The RC float ambiguity is resolved in DD and SD form by the narrow-lane DD and SD module of the orbit solution module 138, or equivalently the DD ambiguity resolution engine and SD ambiguity resolution engine (collectively network ARE 403) of the orbit solution module 138, where the receiver NL bias b_{r,NL} can be cancelled. Before the initial satellite narrow-lane bias is estimated, the RC float ambiguity contains both receiver and satellite narrow-lane bias. It is for this reason that initial NL bias estimation is required in order to fix SD narrow-lane ambiguity. Therefore, the SD modified RC float ambiguity term

$$∇ {( A M B )}_{r , RC}^{{s}_{i} {s}_{j} *}$$

is in essence the SD NL ambiguity

$$∇ {N}_{r , {L}_{2}}^{{s}_{i} {s}_{j}} ,$$

plus satellite NL bias

$$∇ {b}_{NL}^{{s}_{i} {s}_{j}} ,$$

as shown here:

$$∇ {( A M B )}_{r , RC}^{{s}_{i} {s}_{j} *} = {( A M B )}_{r , RC}^{{s}_{i} *} - {( A M B )}_{r , RC}^{{s}_{j} *} = [ {N}_{r , {L}_{2}}^{{s}_{i}} {λ}_{NL} + {b}_{r , NL} + {b}_{NL}^{{s}_{i}} ] - [ {N}_{r , {L}_{2}}^{{s}_{j}} {λ}_{NL} + {b}_{r , NL} + {b}_{NL}^{{s}_{j}} ] = [ {N}_{r , {L}_{2}}^{{s}_{i}} - {N}_{r , {L}_{2}}^{{s}_{j}} ] {λ}_{NL} + {b}_{NL}^{{s}_{i}} - {b}_{NL}^{{s}_{j}} = ∇ {N}_{r , {L}_{2}}^{{s}_{i} {s}_{j}} {λ}_{NL} + ∇ {b}_{NL}^{{s}_{i} {s}_{j}} \qquad ( 66 )$$

Similarly, the DD modified RC float ambiguity term is in essence the DD NL ambiguity,

$$Δ ∇ {N}_{{r}_{m} {r}_{n} , {L}_{2}}^{{s}_{i} {s}_{j}} {λ}_{NL} ,$$

as shown here:

$$Δ ∇ {( AMB )}_{{r}_{m} {r}_{n} , RC}^{{s}_{i} {s}_{j} *} = ∇ {( AMB )}_{{r}_{m} , RC}^{{s}_{i} {s}_{j} *} - ∇ {( AMB )}_{{r}_{n} , RC}^{{s}_{i} {s}_{j} *} = ∇ {N}_{{r}_{m} , {L}_{2}}^{{s}_{i} {s}_{j}} {λ}_{NL} + ∇ {b}_{NL}^{{s}_{i} {s}_{j}} - ∇ {N}_{{r}_{n} , {L}_{2}}^{{s}_{i} {s}_{j}} {λ}_{NL} - ∇ {b}_{NL}^{{s}_{i} {s}_{j}} = Δ ∇ {N}_{{r}_{m} {r}_{n} , {L}_{2}}^{{s}_{i} {s}_{j}} {λ}_{NL} \qquad ( 67 )$$

It is noted that all the & offset items (see, for example, Equations 4 and 5, above) included in the AFIF, the code phase measurements, and carrier phase measurements, such as δ_{pcv/pco},δ_{pwu}, δ_{tides}, δᵣₑₗ, can be pre-calculated.

Consistent with the orbit solution module 138, the orbit solution equation for the AFIF measurements with the resolved N_{WL} and N_{EWL} ambiguities, can be implemented by the orbit ZD filter 404 (e.g., ZD Kalman filter), can be written in accordance with the following equations:

$${Φ}_{r , AFIF}^{s} - ( {δ}_{pcv / pco} + {δ}_{tides} + {δ}_{rel} ) - {T}_{r , dry}^{s} - \frac{{f}_{{L}_{1}}}{{f}_{{L}_{1}} - {f}_{{L}_{3}}} {λ}_{WL} {N}_{WL} + \frac{{f}_{{L}_{3}}}{{f}_{{L}_{1}} - {f}_{{L}_{3}}} {λ}_{EWL} {N}_{EWL} = {ρ}_{r}^{s} + {\tilde{τ}}_{r , GNSS} - {\tilde{τ}}^{s} + {T}_{r}^{s} + {b}_{r , AFIF} - {b}_{r , AFIF}^{s} = \sqrt{{( {x}^{s} - {x}_{r} )}^{2} + {( {y}^{s} - {y}_{r} )}^{2} + {( {z}^{s} - {z}_{r} )}^{2}} + {\tilde{τ}}_{r , GNSS} - {\tilde{τ}}^{s} + {b}_{r , AFIF} - {b}_{r , AFIF}^{s} + {M}_{wet} \cdot {Z}_{wet} + {M}_{wet} ctg ( e ) cos ( α ) \cdot {G}_{N S} + {M}_{wet} ctg ( e ) sin ( α ) \cdot {G}_{EW} \qquad ( 68 )$$

The orbit solution equation for code measurements, implemented by the orbit ZD filter 404 (e.g., orbit ZD Kalman filter), can be written as the following:

$${P}_{r , RC}^{s} - ( {δ}_{pcv / pco} + {δ}_{tides} + {δ}_{rel} ) - {T}_{r , dry}^{s} = {ρ}_{r}^{s} + {\tilde{τ}}_{r , GNSS} - {\tilde{τ}}^{s} + {T}_{r}^{s} = \sqrt{{( {x}^{s} - {x}_{r} )}^{2} + {( {y}^{s} - {y}_{r} )}^{2} + {( {z}^{s} - {z}_{r} )}^{2}} + {\tilde{τ}}_{r , GNSS} - {\tilde{τ}}^{S} + {M}_{wet} \cdot {Z}_{wet} + {M}_{wet} ctg ( e ) cos ( α ) \cdot {G}_{NS} + {M}_{wet} ctg ( e ) sin ( α ) \cdot {G}_{EW} \qquad ( 69 )$$

and the orbit solution equation for carrier phase measurements, implemented by the orbit ZD Kalman filter can be written in accordance with the following:

$${Φ}_{r , RC}^{s} {λ}_{NL} - ( {δ}_{pcv / pco} + {δ}_{tides} + {δ}_{rel} + {δ}_{pwu} {λ}_{NL} ) = {ρ}_{r}^{s} + {\tilde{τ}}_{r , GNSS} - {\tilde{τ}}^{s} + {T}_{r}^{s} + {AMB}_{r , RC}^{s} + {b}_{r , NL} - {b}_{NL}^{s} = \sqrt{{( {x}^{s} - {x}_{r} )}^{2} + {( {y}^{s} - {y}_{r} )}^{2} + {( {z}^{s} - {z}_{r} )}^{2}} + {\tilde{τ}}_{r , GNSS} - {\tilde{τ}}^{S} + {M}_{wet} \cdot {Z}_{wet} + {M}_{wet} ctg ( e ) cos ( α ) \cdot {G}_{NS} + {M}_{wet} ctg ( e ) sin ( α ) \cdot {G}_{EW} + {( AMB )}_{r , RC}^{s} - {b}_{NL}^{s} \qquad ( 70 )$$

In the case that the WL ambiguity has been resolved, for example by the preprocessing module 136, as would typically be the case for signal processing by the orbit solution module 138, according to equation (55) the carrier phase measurement can be modelled as the following:

$${Φ}_{r , RC}^{s} {λ}_{NL} - ( {δ}_{pcv / pco} + {δ}_{tides} + {δ}_{rel} + {δ}_{pwu} {λ}_{NL} ) - \frac{{f}_{1}}{{f}_{1} - {f}_{2}} {N}_{r , WL}^{s} {λ}_{NL} = \sqrt{{( {x}^{s} - {x}_{r} )}^{2} + {( {y}^{s} - {y}_{r} )}^{2} + {( {z}^{s} - {z}_{r} )}^{2}} + {\tilde{τ}}_{r , GNSS} - {\tilde{τ}}^{s} + {M}_{wet} \cdot {Z}_{wet} + {M}_{wet} ctg ( e ) cos ( α ) \cdot {G}_{NS} + {M}_{wet} ctg ( e ) sin ( α ) \cdot {G}_{EW} + {( AMB )}_{r , RC}^{s *} - {b}_{NL}^{s} \qquad ( 71 )$$

The state variables in the orbit solution filter 403 (e.g., ZD Kalman filter) variables are as follows:
(a) Satellite orbit position [x^{s} y^{s} z^{s}], for which the sensitivity coefficients are:

$$[ \begin{matrix}\frac{{x}^{s} - {x}_{r}}{{ρ}_{r}^{s}} & \frac{{y}^{s} - {y}_{r}}{{ρ}_{r}^{s}} & \frac{{z}^{s} - {z}_{r}}{{ρ}_{r}^{s}}\end{matrix} ] \qquad ( 72 )$$

(b) The Empirical CODE Orbit Model (ECOM2) is widely used as the empirical model to take care of the solar radiation pressure;
(c) Satellite clock \tilde{τ}^{s}, for which the sensitivity coefficient is −1;
(d) Receiver clock and bias term \tilde{τ}ᵣ, for which the sensitivity coefficient is 1;
(e) Receiver AFIF bias term for each GNSS system b_{r,AFIF}, for which the sensitivity coefficient is 1;
(f) Satellite AFIF bias term

$${b}_{r , AFIF}^{s} ,$$

which the sensitivity coetticient is −1;
(g) Troposphericzenith delay wet component Z_{wet}, for which the sensitivity coefficient is the tropospheric delay mapping function for the wet component M_{wet};
(h) Tropospheric horizontal gradients for the north-south direction, for which the sensitivity coefficient is:

$${M}_{wet} ctg ( e ) cos ( α ) \qquad ( 73 )$$

(i) Tropospheric horizontal gradients for the east-west direction, for which the sensitivity coefficient is:

$${M}_{wet} ctg ( e ) sin ( α ) \qquad ( 74 )$$

(k) RC float ambiguity term

$${( AMB )}_{r , RC}^{s} , or {( AMB )}_{r , RC}^{s *}$$

for the case in which the WL ambiguity has already been resolved, for which the sensitivity coefficient is λ_{NL}; and
(l) Satellite NL bias

$${b}_{NL}^{s} ,$$

tor which the sensitivity coefficient is −1.

In some embodiments, All GNSS system signals are integrated in one filter (e.g., orbit ZD filter 404), in which case the float ambiguity variance covariance matrix update, for a common receiver phase bias error, is as follows:

$${Q}_{{\hat{N}}_{NL}}^{n} = {Q}_{{\hat{N}}_{NL}}^{n - 1} + ( \begin{matrix}1 & ⋯ & 1 \\ ⋮ & ⋱ & ⋮ \\ 1 & ⋯ & 1\end{matrix} ) {q}_{{b}_{r , NL}} \cdot Δ {t}_{n - 1 , n} \qquad ( 75 )$$

The satellite NL bias variance is also updated as following:

$${Q}_{{b}_{NL}^{s}}^{n} = {Q}_{{b}_{NL}^{s}}^{n - 1} + {q}_{{b}_{NL}^{s}} \cdot Δ {t}_{n - 1 , n} \qquad ( 76 )$$

### Clock Solution ZD Kalman Filter

The clock solution module 144 comprises a ZD filter 408 (e.g., ZD Kalman filter) that is configured to use the same measurements as the orbit ZD filter 404 (e.g., ZD Kalman filter), and the same update equations, except as follows:

In the clock solution module 144, the clock solution ZD filter 408 (e.g., clock solution ZD Kalman filter) runs at a different update rate (e.g., an update rate of once per 30 seconds or once per 60 seconds) than the orbit solution ZD Kalman filter, because clock corrections vary more quickly than orbit corrections. The clock update rate of the clock solution module 144 is configured to exceed the orbit update rate of the orbit solution module 138.

In the clock solution ZD filter 408 (e.g., ZD Kalman filter), all the state variables remain the same as in the orbit ZD filter 408 (e.g., ZD Kalman filter), as described above, except satellite orbit related states, which are not estimated but instead use the orbit estimation results from the orbit solution module 138. In the clock solution ZD filter 404 (e.g., ZD Kalman filter) the following equations apply to WL and EWL carrier phase measurements:

$${Φ}_{r , AFIF}^{s} - ( {δ}_{pcv / pco} + {δ}_{tides} + {δ}_{rel} ) - {T}_{r , dry}^{s} - {ρ}_{r}^{s} - \frac{{f}_{{L}_{1}}}{{f}_{{L}_{1}} - {f}_{{L}_{3}}} {λ}_{WL} {N}_{WL} + \frac{{f}_{{L}_{3}}}{{f}_{{L}_{1}} - {f}_{{L}_{3}}} {λ}_{EWL} {N}_{EWL} = {\tilde{τ}}_{r , GNSS} - {\tilde{τ}}^{s} + {b}_{r , AFIF} - {b}_{r , AFIF}^{s} + {M}_{wet} \cdot {Z}_{wet} + {M}_{wet} ctg ( e ) cos ( α ) \cdot {G}_{NS} + {M}_{wet} ctg ( e ) sin ( α ) \cdot {G}_{EW} \qquad ( 77 )$$

Similarly, the code phase measurement is modelled as:

$${P}_{r , RC}^{s} - ( {δ}_{pcv / pco} + {δ}_{tides} + {δ}_{rel} ) - {T}_{r , dry}^{s} - {ρ}_{r}^{s} = {\tilde{τ}}_{r , GNSS} - {\tilde{τ}}^{s} + {M}_{wet} \cdot {Z}_{wet} + {M}_{wet} ctg ( e ) cos ( α ) \cdot {G}_{NS} + {M}_{wet} ctg ( e ) sin ( α ) \cdot {G}_{EW} \qquad ( 78 )$$

Further, the NL carrier phase measurement are modelled as:

$${Φ}_{r , RC}^{s} {λ}_{NL} - ( {δ}_{pcv / pco} + {δ}_{tides} + {δ}_{rel} + {δ}_{pwu} {λ}_{NL} ) - {ρ}_{r}^{s} = {\tilde{τ}}_{r , GNSS} - {\tilde{τ}}^{s} + {M}_{wet} \cdot {Z}_{wet} + {M}_{wet} ctg ( e ) cos ( α ) \cdot {G}_{NS} + {M}_{wet} ctg ( e ) sin ( α ) \cdot {G}_{EW} + {( AMB )}_{r , RC}^{s} - {b}_{NL}^{s} \qquad ( 79 )$$

In some embodiments, the clock solution module 144 outputs the complete set of global difference corrections, including satellite orbit corrections, satellite clock corrections, satellite EWL biases, WL biases, satellite NL biases, and quality information. These corrections and estimated tropospheric parameters are sent to the low latency clock solution module. Note that the biases discussed herein are satellite EWL, WL and NL biases, and not receiver biases, unless receiver biases are being specifically discussed, because receiver biases of the reference receivers 20 are not used by the navigation receivers to determine their positions, and thus are not resolved by the satellite corrections estimator (34, 134).

### Satellite Bias and SD Ambiguity Determination

Once the DD ambiguities have been fixed in EWL and WL modules of the preprocessing module 136, orbit solution module 138, or clock solution module 144, the next task is to separately solve for both satellite biases (AFIF, WL and NL) and SD ambiguities (EWL, WL and NL). However, for any individual reference receiver, solving for both satellite biases and SD ambiguities is a “rank deficiency” problem, as there are an insufficient number of independent equations to solve for both. In order to remove the rank deficiency, the satellite biases are resolved using a networked solution, as described herein, and as part of that process, a “SD ambiguity datum” is determined. The SD ambiguity datum, and its use in resolving the satellite biases, are described below.

Once the DD ambiguities for most or all of the satellites are fixed, some of the corresponding SD ambiguities need to be fixed into integer values, or initial integer values, to resolve the rank deficiency. These initially fixed SD ambiguity values are defined as the SD ambiguity datum set ∇N_{datum}, which is shown here in equation form:

$$∇ {N}_{datum} = \{ ∇ {N}_{{r}_{1} , fixed}^{{s}_{1} {s}_{2}} , ∇ {N}_{{r}_{2} , fixed}^{{s}_{2} {s}_{3}} , … , ∇ {N}_{{r}_{m} , fixed}^{{s}_{N - 1} {s}_{N}} \} \qquad ( 80 )$$

in which the floating ambiguity SD pairs

$$∇ {\hat{N}}_{{r}_{1}}^{{s}_{1} {s}_{2}} , ∇ {\hat{N}}_{{r}_{2}}^{{s}_{2} {s}_{3}} , … , ∇ {\hat{N}}_{{r}_{m}}^{{s}_{N - 1} {s}_{N}}$$

are initially fixed to their round-off integer numbers or at other arbitrarily determined values (e.g., round up or round down values):

$$∇ {N}_{{r}_{1} , fixed}^{{s}_{1} {s}_{2}} = round ( ∇ {\hat{N}}_{{r}_{1}}^{{s}_{1} {s}_{2}} ) \qquad ( 81 )$$

$$∇ {N}_{{r}_{2} , fixed}^{{s}_{2} {s}_{3}} = round ( ∇ {\hat{N}}_{{r}_{2}}^{{s}_{2} {s}_{3}} )$$

$$⋯$$

$$∇ {N}_{{r}_{m} , fixed}^{{s}_{N - 1} {s}_{N}} = round ( ∇ {\hat{N}}_{{r}_{m}}^{{s}_{N - 1} {s}_{N}} )$$

where

$$round ( ∇ {\hat{N}}_{r}^{{s}_{i} {s}_{j}} )$$

is the round-oft integer value of

$$∇ {\hat{N}}_{r}^{{s}_{i} {s}_{j}} , and ∇ {N}_{r , fixed}^{{s}_{1} {s}_{2}}$$

is the fixed ambiguity value for the float SD ambiguity

$$∇ {\hat{N}}_{r}^{{s}_{1} {s}_{2}} .$$

The SD ambiguity datum is therefore the initial integer fix for the SD ambiguities, and subsequently determined fixes are based on the SD ambiguity datum.

It is noted that the preprocessing module 136 is configured to estimate or form an SD ambiguity datum for WL and EWL ambiguities, while orbit solution module 138 and clock solution module 144 are configured to estimate, individually and collectively, an SD ambiguity datum for NL ambiguities. Thus, the following explanations concerning the SD ambiguity datum, ambiguity clusters, and satellite bias value determination, are applicable to both EWL, WL measurement processing by preprocessing module 136, and NL measurement processing by orbit solution module 138 and clock solution module 144.

### Ambiguity Clusters

For any given fixed DD ambiguity

$$∇ Δ {N}_{{r}_{m} {r}_{n}}^{{S}_{i} {S}_{j}} ,$$

two float SD ambiguities can be formed as follows:

$$∇ {\hat{N}}_{{r}_{m}}^{{S}_{i} {S}_{j}} = {\hat{N}}_{{r}_{m}}^{{S}_{i}} - {\hat{N}}_{{r}_{m}}^{{S}_{j}} \qquad ( 82 )$$

$$∇ {\hat{N}}_{{r}_{n}}^{{S}_{i} {S}_{j}} = {\hat{N}}_{{r}_{n}}^{{S}_{i}} - {\hat{N}}_{{r}_{n}}^{{S}_{j}} \qquad ( 83 )$$

where

$${\hat{N}}_{{r}_{m}}^{{S}_{i}} , {\hat{N}}_{{r}_{m}}^{{S}_{j}} , {\hat{N}}_{{r}_{n}}^{{S}_{i}} , {\hat{N}}_{{r}_{n}}^{{S}_{j}}$$

are the ZD Kalman filter float ambiguity state variable estimates, and the ZD Kalman filter is the preprocessing ZD filter 400 of preprocessing module 136 for EWL and WL ambiguity resolution or EWL and WL floating ambiguities, orbit ZD filter 408 of the orbit solution module 138 for NL ambiguity resolution or the clock ZD filter 408 of the clock solution module 144 for NL ambiguity resolution or NL floating ambiguities, whose carrier phase measurement modeling equation is equations (41 and 47), (68 and 70), or (77 and 79) respectively.
These two float SD ambiguities

$$∇ {\hat{N}}_{{r}_{m}}^{{S}_{i} {S}_{j}} and ∇ {\hat{N}}_{{r}_{n}}^{{S}_{i} {S}_{j}}$$

have the same ambiguity fractional parts and variances, as indicated in equation (84), below, because their associated DD ambiguity is

$$∇ Δ {N}_{{r}_{m} {r}_{n}}^{{S}_{i} {S}_{j}}$$

has already been fixed into an integer value:

$$⌊ ∇ {\hat{N}}_{{r}_{m}}^{{S}_{i} {S}_{j}} ⌋ = ⌊ ∇ {\hat{N}}_{{r}_{n}}^{{S}_{i} {S}_{j}} ⌋ \qquad ( 84 )$$

$${Q}_{{r}_{m} , {r}_{m}}^{{S}_{i} {S}_{j}} = {Q}_{{r}_{n} , {r}_{n}}^{{S}_{i} {S}_{j}} = {Q}_{{r}_{m} , {r}_{n}}^{{S}_{i} {S}_{j}} or - {Q}_{{r}_{m} , {r}_{n}}^{{S}_{i} {S}_{j}} ,$$

where the term

$$⌊ ∇ {\hat{N}}_{{r}_{m}}^{{S}_{i} {S}_{j}} ⌋$$

means the fractional part of the float ambiguity

$$∇ {\hat{N}}_{{r}_{m}}^{{S}_{i} {S}_{j}} .$$

Based on the fixed DD ambiguities between satellite pair sᵢ and sⱼ among all site pairs, the SD ambiguity set

$$\{ ∇ {\hat{N}}_{{r}_{m}}^{{s}_{i} {s}_{j}} , ∇ {\hat{N}}_{{r}_{n}}^{{s}_{i} {s}_{j}} , … \}$$

can be formed for all reference stations that have both satellites sᵢ and sⱼ in view of their GNSS antennae and which satisfy equation (84). This SD ambiguity set is defined as the SD ambiguity cluster

$$∇ {\hat{N}}_{cluster}^{{s}_{i} {s}_{j}}$$

$$∇ {\hat{N}}_{cluster}^{{s}_{i} {s}_{j}} = \{ ∇ {\hat{N}}_{{r}_{m}}^{{s}_{i} {s}_{j}} , ∇ {\hat{N}}_{{r}_{n}}^{{s}_{i} {s}_{j}} , … \} \qquad ( 85 )$$

The number of SD ambiguity pairs in the cluster is defined as the cluster size. It should be noted that there could be several clusters for a given satellite pair sᵢ and sⱼ. The ambiguity cluster with the maximum cluster size is selected as

$$∇ {\hat{N}}_{cluster}^{{s}_{i} {s}_{j}} .$$

### SD Ambiguity Datum Determination

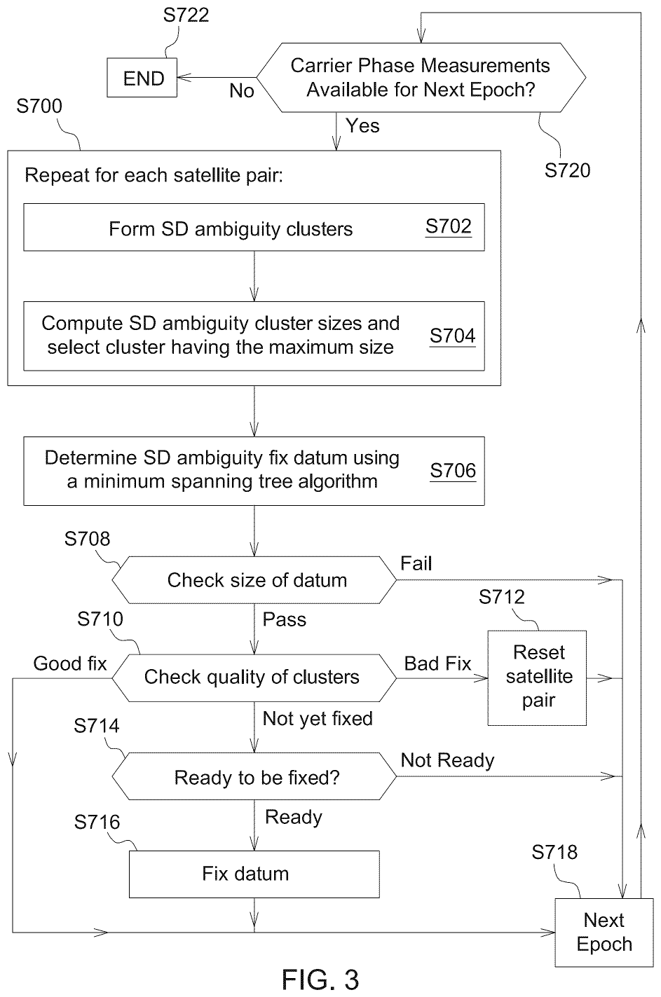

FIG. 3 is a flowchart of a method for determining the SD ambiguity datum in a respective module. The method of FIG. 3 begins in step S700, which comprises steps S702 and S704 that are repeated for each visible satellite pair of a GNSS constellation, where a visible satellite pair of GNSS constellation transmits a set of satellite carrier signals (e.g., L1, L2 and L3) that are within (reliable) reception range of the reference receiver 20.

In step S702, for all possible satellite pairs (e.g., for satellites s; and sⱼ) that are candidates for having a cluster to be included in the datum, an SD ambiguity set

$${\hat{N}}_{cluster}^{{s}_{i} {s}_{j}}$$

is formed using SD ambiguities for all reference stations in view of both satellites. For example, each reference receiver 130 within the reference data network (32, 132) is configured to provide carrier phase measurements and code phase measurements, for pairs of satellites within reception range of each reference receiver, to the data processing center 118, correction data estimator or an Ambiguity Resolution Engine (ARE) module. In turn, the data processing center 118, correction data estimator 34, or an Ambiguity Resolution Engine (ARE) module is configured to determine an SD ambiguity set

$${\hat{N}}_{cluster}^{{s}_{i} {s}_{j}}$$

using SD ambiguities/

In step S704, the data processing center 118, the correction data estimator 34, or ARE module of system 411 is configured to determine respective sizes of the corresponding ambiguity clusters, where the cluster having the maximum size is selected. Alternatively, if an ambiguity cluster

$${\hat{N}}_{cluster}^{{s}_{i} {s}_{j}}$$

is or was already fixed (e.g., during a prior epoch), that ambiguity cluster is selected as the first cluster in the datum.

In the example of FIG. 3 and FIG. 4A, the sizes of the ambiguity clusters between all the EWL satellite pairs including both GPS and QZSS are determined. The Table of FIG. 4A illustrates a GPS/QZSS ambiguity cluster matrix.

In step S706, the data processing center 118, the correction data estimator 34, or ARE module of system 411 is configured to add additional clusters to the datum using a minimum spanning tree algorithm, to form the SD EWL ambiguity datum, ∇N_{datum}, after which in later steps S708 and S710 the datum is tested or evaluated in size and quality to determine if it is ready to be fixed in step S714 for use in determining satellite EWL bias values.

In step S708, the data processing center 118, the correction data estimator 34, or ARE module of system 411 checks the size of the datum. If the size of the data is greater than or equal to a threshold size, then the datum size is acceptable or designated as a “pass” and the method continues with step S710. However, if the data size is less than a threshold size then the datum size is unacceptable or designated as a “fail.” then the method continues with step S718, where the SD ambiguity clusters are formed, evaluated and fixed for the next epoch by returning to step S700.

In step S710, the data processing center 118, the correction data estimator 34 or ARE module of system 411 checks the quality of the clusters or datum. For example, the data processing center 118, the correction data estimator 34 or ARE module of system 411 determines that the quality of the clusters or data are adequate if the fractional part of the floating ambiguities for each pair of satellites in the datum or cluster has a variance that is below a threshold variance (e.g., where threshold variance is measured with respect to the mean of the fraction part of ambiguities of the pairs of satellites within the datum or cluster). If the quality of the clusters or datum exceeds a threshold quality, then the cluster or datum is eligible for fixing, and method continues with step S714. However, if the quality of the clusters or datum is less than or equal to the threshold quality, then the cluster or datum is ineligible for fixing and the method continues with step S712.

In step S712, if the quality of the datum for the respective satellite pair is deficient, the data processing center 118, the correction data estimator 34, or ARE module of system 411 resets (e.g., deletes) one or more satellite pairs within the datum and continues to step S718, where the SD ambiguity clusters are formed, evaluated and fixed for the next epoch by returning to step S700. The quality of the datum of the satellite pair can be deficient as explained later in this document, where the deficiency may depend upon the size of the datum for a respective satellite pair, the number of satellites or carrier phase measurements observed by the reference receivers of the GNSS constellation during the epoch. If the datum or cluster is deleted for a satellite pair within the datum, the datum or cluster from the current epoch will not be available as the starting point for the next epoch: the next epoch can start from a clean starting point in block S700 after block S718.

In step S714, the data processing center 118, the correction data estimator 34 or the ARE module of system 411 determines whether the datum or cluster is ready to be fixed for a current epoch. If the datum of or cluster is ready to be fixed for the current epoch, the method continues with step S716, in which the datum or cluster is fixed. However, if the datum or cluster is not ready to be fixed for the current epoch, the method continues with step S718, where the SD ambiguity clusters are formed, evaluated and fixed for the next epoch by returning to step S700.

In some embodiments, in step S706 the minimum spanning tree algorithm for adding clusters to the datum is as follows: First, start with the largest ambiguity cluster

$$∇ {\hat{N}}_{cluster}^{{s}_{1} {s}_{2}}$$

for example satellite pair G06 (e.g., PRN06) and G09 (e.g., PRN09) in FIG. 4A of GPS/QZSS EWL Ambiguity Cluster Matrix, which has a cluster size of 13 in cell 906, or more generally the cluster selected to be the first cluster in the list of EWL ambiguity datum, an example of which is shown as FIG. 4A. Each satellite within the pair may be identified by its respective pseudo-random noise (PRN) code assignment that is assigned (e.g., by the government) and transmitted on the course-acquisition (C/A) GPS signal, where the PRN code can be associated with a Gold code of a known length, among other things. For EWL ambiguities or WL ambiguities, it is known that all the SD ambiguities in this cluster

$$∇ {\hat{N}}_{cluster}^{{s}_{1} {s}_{2}}$$

have (or should nave) the same fractional part and variance, as indicated by equation (84); hence, it is equivalent to select any one ambiguity within the cluster for inclusion in the datum. Therefore we can select any one of the SD EWL ambiguities

$$∇ {\hat{N}}_{r}^{{s}_{1} {s}_{2}}$$

in this cluster, and fix it into an integer

$$∇ {N}_{r , fixed}^{{s}_{1} {s}_{2}}$$

as the initial element of the datum, where r can be any reference receiver within the first cluster:

$$∇ {N}_{datum} = \{ ∇ {N}_{r , fixed}^{{s}_{1} {s}_{2}} \} \qquad ( 86 )$$

To cover all pairs of satellites in view within the GNSS constellation during a respective epoch, the datum or matrix is expanded one additional ambiguity cluster at a time, using the next largest cluster,

$$∇ {\hat{N}}_{cluster}^{{s}_{2} {s}_{3}} ,$$

but with the constraint that satellite s₂ is already in the SD EWL ambiguity datum ∇N_{datum} and s₃ is not yet in the SD ambiguity datum VN datum. For example, in FIG. 4A, the second largest cluster is for satellite pair G06 (e.g., PRN06) and G04 (e.g., PRN04), which has a cluster size of 11. After the inclusion a second cluster,

$$∇ {\hat{N}}_{cluster}^{{s}_{2} {s}_{3}} ,$$

in the SD EWL ambiguity datum, the expanded datum is represented as:

$$∇ {N}_{datum} = \{ ∇ {N}_{r , fixed}^{{s}_{1} {s}_{2}} , ∇ {N}_{r , fixed}^{{s}_{2} {s}_{3}} \} \qquad ( 87 )$$

The expansion of the datum is repeated until there are no further satellite pairs that can be included in the datum. For example, in FIG. 4B, there are a total of 20 SD EWL ambiguity datum from 21 satellites. Given a GNSS constellation of n satellites, a fully determined SD ambiguity datum has n−1 clusters:

$$∇ {N}_{datum} = \{ ∇ {N}_{r , fixed}^{{s}_{1} {s}_{2}} , ∇ {N}_{r , fixed}^{{s}_{2} {s}_{3}} , … , ∇ {N}_{r , fixed}^{{s}_{n - 1} {s}_{n}} \} \qquad ( 88 )$$

In step S708, the data processing center 118, correction data estimator 34 or ARE module is configured to determine an observed size of the datum and check or compare the observed size of the datum to the target size of the datum with knowledge of the total number of properly functional satellites within the GNSS constellation, n or any lesser target size of the datum because of practical constraints, such as maintenance, repair, replacement, unavailability or nonfunctional satellites.

In particular, in step S708 if the SD ambiguity datum is not fully determined, where the number of SD ambiguity clusters in the datum is less than the appropriate target size (e.g., less than n−1 target size for a GNSS constellation of fully functioning satellites) the process of generating the datum resumes during the next epoch (e.g., in accordance with S718, which returns to step S700 after incrementing an epoch counter), and succeeding epochs as needed, until the number of SD ambiguity clusters in the datum is equal to the target size (e.g., n−1, where n is the total number of properly functional satellites with the constellation or within reception range of a suitable set of the reference receivers within the correction network). For example, if partial SD ambiguity datum is determined where the datum is less than the target size (e.g., (e.g., n−1, where n is the total number of properly functional satellites with the constellation or within reception range of a suitable set of the reference receivers within the correction network) for a prior epoch, that partial SD ambiguity datum can be used as the starting point for the SD ambiguity datum for the next epoch.

Initially, in the executing of step S708, if number of qualified SD ambiguity clusters accounts more than half number of satellites (e.g., n) in the GNSS constellation (or for each constellation, and if satellite correction information is being determined for more than one GNSS constellation), this is an indicator that the data processing center 118, the correction data estimator 34, or ARE module of system 411 is ready for determining the quality of the SD ambiguity clusters within the datum or matrix for the respective GNSS constellation. Otherwise, formation of the SD ambiguity datum resumes during the next epoch, starting at step S700 via step S718. For any satellite not included (or deleted from) in the list of ambiguity datum for a GNSS constellation, the SD ambiguity EWL. WL or NL constraints are not applied in the ZD filter.

In step S710, after the ambiguity datum for most satellites in the same constellation is determined, the data processing center 118, the data correction estimator 34 of the ARE module of system 411 is configured to determine, check or evaluate the quality of the SD ambiguity clusters for a particular satellite pair in the datum for each epoch. In some embodiments, if the quantity of the SD ambiguities corresponding to an SD ambiguity cluster for the satellite pair in the datum fails to meet predefined criteria for example, because the quantity of satellite measurements (e.g., L1. L2 and L3 carrier phase signals) for a respective satellite pair is less than two (e.g., less than two reference receivers within reception range of the satellite pair for an epoch), the SD ambiguity cluster for the satellite pair is reset (e.g., removed from the datum) in step S712, and the process of forming the SD ambiguity datum resumes during the next epoch.

In step S714, if the quality of ambiguity datum is validated and ready to be fixed), in step S716 each SD ambiguity pair

$$∇ {N}_{r , fixed}^{{s}_{n - 1} {s}_{n}}$$

in the list of datum is fixed as an integer SD EWL ambiguity, or SD WL ambiguity, or both in the preprocessing module 136 or SD NL ambiguity in orbit solution module 138 or clock solution module 144. In some embodiments, the ambiguity datum includes a list of SD ambiguity pairs, where each pair contains two satellites. All the satellites included in the list of the ambiguity datum will be marked as SD fix ready set. The SD EWL, WL or NL ambiguity constraints for these satellites marked as SD fix ready set can be applied in the preprocessing module 136, orbit solution module 138 and clock solution module 144 to improve further filter state estimation including satellite AFIF/WL/NL biases, orbit and clock corrections, and the like. If these satellites are not a list of the ambiguity datum or are removed (e.g., deleted) from the datum, their SD EWL, WL or NL ambiguities should not be fixed. It should be noted that DD or SD NL ambiguity constraints can be only applied for a particular pair of satellites after the corresponding SD WL ambiguity is fixed, which generally means both the SD EWL and SD WL are fixed.

### Apply Ambiguity Fix Constraint

Within system 411, for all the fixed ambiguities or partial fixed ambiguities in the fixed set N_{fixed}, ambiguity constraints are sequentially updated for one or more ZD Kalman filters (400, 404, 408). For DD ambiguities, according to equations (27) and (48),

$$\begin{matrix}Δ ∇ {\hat{N}}_{{r}_{m} {r}_{n} , fixed}^{{s}_{i} {s}_{j}} = ( {\hat{N}}_{{r}_{m}}^{{s}_{i}} - {\hat{N}}_{{r}_{m}}^{{s}_{j}} ) - ( {\hat{N}}_{{r}_{n}}^{{s}_{i}} - {\hat{N}}_{{r}_{n}}^{{s}_{j}} ) \\ {σ}_{Δ ∇ {\hat{N}}_{{r}_{m} {r}_{n} , fixed}^{{s}_{i} {s}_{j}}}^{2} = 0\end{matrix} \qquad ( 89 )$$

where

$$Δ ∇ {N}_{{r}_{m} {r}_{n} , fixed}^{{s}_{i} {s}_{j}}$$

is used as a virtual measurement;

$${σ}_{Δ ∇ {\hat{N}}_{{r}_{m} {r}_{n} , fixed}^{{s}_{i} {s}_{j}}}^{2}$$

is the measurement variance, which is set to zero since the DD ambiguity has been fixed into an integer; and \hat{N} is the ambiguity state variable in the ZD filter (400, 408, 412), which can be a float WL ambiguity or float NL ambiguity.
For SD EWL, SD WL or SD NL ambiguities between satellites when their ambiguity datum are fixed, the constraint applied is:

$$\begin{matrix}∇ {\hat{N}}_{{r}_{m} , fixed}^{{s}_{i} {s}_{j}} = {\hat{N}}_{{r}_{m}}^{{s}_{i}} - {\hat{N}}_{{r}_{m}}^{{s}_{j}} \\ {σ}_{∇ {\hat{N}}_{{r}_{m} , fixed}^{{s}_{i} {s}_{j}}}^{2} = 0\end{matrix} \qquad ( 90 )$$

where

$$∇ {N}_{{r}_{m} , fixed}^{{s}_{i} {s}_{j}}$$

is the SD fixed ambiguity value (i.e., integer value) determined by the LAMBDA search process, which is used as a virtual measurement; and

$${σ}_{∇ {\hat{N}}_{{r}_{m} , fixed}^{{s}_{i} {s}_{j}}}^{2}$$

is the measurement variance, which is set to zero since the SD ambiguity has been fixed into an integer.
Once the ambiguity fix constraint is applied, the variance of that fixed ambiguity becomes zero. Therefore, all the fixed ambiguity information is preserved in the variance-covariance matrix, and no additional bookkeeping logic is required when processing the ambiguities sets in the next epoch.

In FIG. 4A, the vertical axis 902 has a list of satellite identifiers (e.g., S₁) and the horizontal axis has a list of corresponding satellite identifiers (e.g., S₂) for a table of the GPS ambiguity cluster matrix 901. Each cell 906 provides a size of the datum or cluster, where the size indicates how many duplicate pairs of the same two satellites have available similar carrier phase measurements from different reference receivers 130 (at different known stationary locations or coordinates) within the reference network (32, 132) for the current epoch that are within view or reception range of the different reference receivers. For each pair of the carrier phase measurements for the same two satellites (e.g., where each pair of Sᵢ and Sⱼ satellite carrier phase measurements can be measured from a different reference receiver 130 at different stationary locations), the data processing center 118, or data correction estimator 34 or ARE module of system 411 is configured to determine floating ambiguities with an integer component or rounded integer representative of the integer ambiguity and a fractional component. Further, the fractional component of the floating ambiguity may have a variance that is representative of quality of the integer ambiguity for the particular reference receiver. In one example, the datum or cluster size equals the total number of reference receivers that can carrier phase measurements for any respective pair of satellites: the data processing center 118, or data correction estimator 34 or ARE module of system 411 is configured to determine any of the following: (a) EWL carrier phase measurements and respective EWL ambiguities. (b) WL carrier phase measurements and respective WL ambiguities, and (c) NL carrier phase measurements and respective NL ambiguities.

Meanwhile. FIG. 4B is a table 903 of ambiguity datums or clusters with ranks 908 that are ranked in order of size 914 of number of duplicate pairs of the same two satellites (S₁, S₂) with available carrier phase measurements within the reference network for the current epoch that are within view or reception range of the difference reference receivers. The satellites identifiers (910, 912) are designated in the table 903.

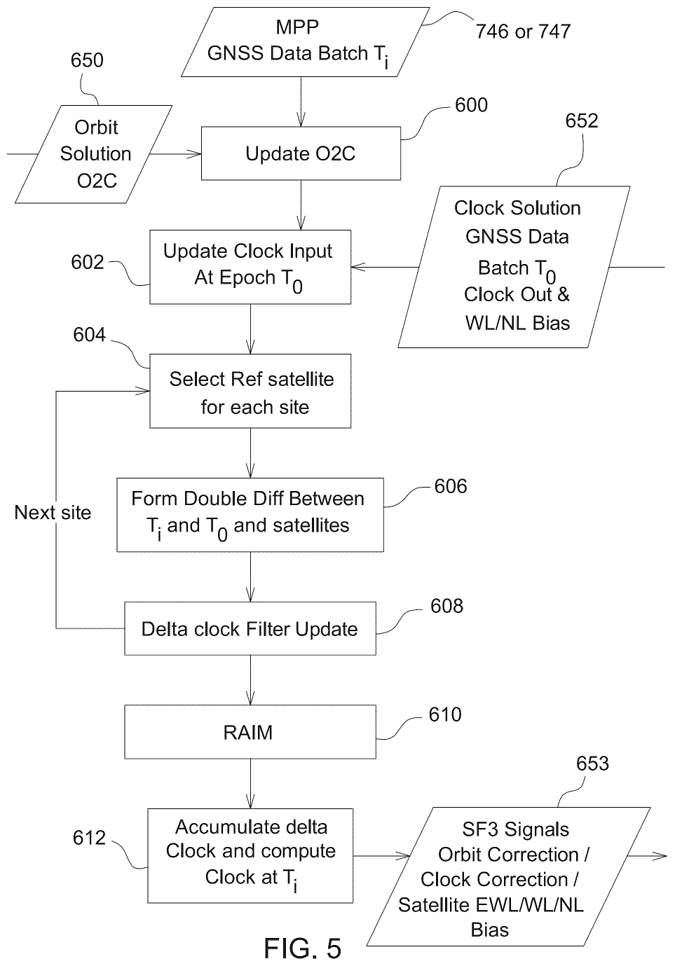

FIG. 5 is of one embodiment of a method for providing a satellite correction signal with a precise, low-latency Global Navigation Satellite System (GNSS) satellite clock. The method of FIG. 5 begins in block 600.

In block 600, the data processor 120, correction data estimator 34 or the orbit solution module 38 determines the predicted orbital data for a respective measurement time (e.g., epoch Ti), or an update to the predicted orbital data, based upon reference network data 746 (e.g., batch data or raw measurement data (746, 747) for time or epoch Ti) received from one or more reference receivers 130 and previous predicted orbital data (e.g., for time T)) from the orbit solution module 38 or stored in a data storage device 124 (e.g., register, electronic memory, or non-volatile random access memory). Measurement time or epoch (e.g., Ti) can be a next epoch after a previous epoch or first epoch (e.g., T0). Further, the orbit solution module 38 can provide the predicted orbital data (e.g., predicted orbital data for measurement time or epoch Ti) or the update to the predicted orbital data, based on wide-lane ambiguities and corresponding wide-lane ambiguity bias data, where the wide-lane ambiguities and corresponding wide-lane ambiguity bias data are provided by the measurement pre-processing module 36.

In one example of carrying out block 600, the correction data estimator 34 or the orbit solution module 38 estimates the predicted orbital data (e.g., O2C data) over a few minutes at an orbit update rate, such as once every 300 seconds, from the time that orbit solution are fixed in low latency clock module 42. For example, the correction data estimator 34 or the orbit solution module 38 is configured to estimate or update the orbit solution data based on the orbit solution data 650 (e.g., previous or stored orbit solution data for epoch T0 or the last epoch) and the measurement pre-processing (MPP) GNSS data batch 648 for epoch Ti (e.g., next epoch after epoch T0 or the last epoch).

In block 602, the data processor 120, correction data estimator 34 or clock solution module (44, 144) determines the clock input data, or an update of clock input at measurement time or epoch T0 based on the predicted orbital data (e.g., at measurement time or epoch Ti or epoch T0) and based upon any of the following: (a) clock solution GNSS data (e.g., slow clock solution data). (b) wide-lane bias data. (c) extra-wide-lane bias data, and (d) narrow-lane bias data (e.g., batch data for epoch T0), and/or (e) network data 746 (e.g., batch data or raw measurement data 747 for time or epoch T0) received from one or more reference receivers 130. As used herein, measurement time or epoch Ti follows measurement time or epoch T0.

For example, in block 602, the data processor 120, correction data estimator 34 or clock solution module (44, 144) determines the clock input data, or an update of the clock input that is updated at slow clock rate or at a slow clock interval based on a clock solution GNSS data 652 consistent with batch T0 or epoch T0, clock bias and EWL bias. WL bias, and NL bias. Accordingly, a transition from measurement time T0 to measurement time Ti does not necessarily trigger an update of the clock input data, unless Ti is coincident with the next update interval of the slow clock process. For example, the pre-processed measurements from measurement pre-processing module (36, 136) are batched and sent to low latency clock module 42 for block 604 after a few seconds waiting window (e.g., first update interval), such as 1-2 seconds. Meanwhile, the pre-processed measurements are sent to orbit/clock solutions module (38, 138) after longer period or window (e.g., a second update interval), such as 6-15 seconds.

After block 602, the method continues in block 604. In block 604, the data processor 120, correction data estimator 34, or low-latency module selects a reference satellite for each site of the reference network, or a pair of reference satellites for each reference receiver 130 of the reference network. For example, in one embodiment the correction data estimator 34 or the low-latency clock module (407) selects the highest elevation satellite without cycle slips as a reference satellite for each reference site. Any difference in elevation between the reference receiver 130 and the mobile receiver 20 should be taken into account for tropospheric bias compensation. The tropospheric biases are corrected using a prior model and residual troposphere bias estimation from slow clock solution.

In block 606, the data processor 120, correction data estimator 34, or the low-latency module 407 determines a double difference between the carrier phase measurements or narrow-lane carrier phase measurements at measurement times or epochs Ti and TO and the pair of satellites. For example, the double difference is determined for carrier phase measurements at each reference receiver 130 at measurement times or epochs Ti and TO and the pair of satellites. The double difference (DD) narrow-lane ambiguities are resolved to determine precise refraction-corrected carrier phase measurements for which certain biases are canceled out. For example, in double differencing techniques, one or more of the following biases can cancel out: receiver code phase bias (e.g., receiver code phase bias and satellite code phase bias), carrier phase bias (e.g., receiver phase bias and satellite phase bias) and clock bias (e.g., receiver clock bias and satellite clock bias), that are common between satellites and receivers and can be cancelled out by the double differencing operation between satellites and receivers. Some ionospheric propagation delay bias cancels out in the double-difference equations. The remaining atmospheric errors including ionospheric and tropospheric delay can be ignored after the double differencing for double differencing between the same reference receiver 130 at different times. However, an ionosphere error between different reference receivers 130 separated by long base-lines could be estimated and used by the correction data estimator 34.

In one embodiment, the low latency clock module (42, 407) reduces the correction latency to improve clock accuracy with absolute clocks from slow clock solution. In order to improve computation efficiency, the double differencing measurements between time and satellites are used so that some unnecessary states such as ambiguity and receiver clocks are removed. The low-latency module 407 or the delta clock filter 412 only estimates changes in states for satellite clock for processing efficiency and enhanced rapid availability/reduced latency of the correction data 108 for the mobile receivers 20.

In one example, the clock solution module 44 determines predicted orbital data, satellite bias data and satellite bias quality data (e.g., variance-co-variance data) based on the resolved double-differenced refraction corrected, narrow-lane ambiguities.

In block 608, the data processor 120, correction data estimator 34 or low latency clock module (42, 407) receives the predicted orbital data, satellite bias data and satellite bias quality data (e.g., variance-co-variance data) based on the resolved double-differenced refraction corrected, narrow-lane ambiguities and provides a delta clock filter 412 update. Prior to the next update of the clock solution module 44 at the slow update rate in block 602, the low latency clock module (42, 407) only estimates delta satellite clocks so that the computation can be updated at a low-latency rate that is greater than the orbit update rate of the orbit solution module 38 and the slow update rate of the clock solution module 44.

In one example of the method of FIG. 5, the method continues with block 604 after each iteration of blocks 604, 606 and 608 for each site or reference receiver 130, until all the calculations of blocks 604, 606 and 608 have been made for all sites or reference receivers 130 in the reference data network 32. Further, each iteration of blocks 604, 606 and 608 is consistent with providing low-latency correction data 108 at a low-latency intervals or a low-latency data rate.

In block 610, the data processor 120, the correction manager 740 or the low-latency clock applies a RAIM (receiver autonomous integrity monitoring) algorithm to the delta clock filter 412. The RAIM algorithm comprises software that uses an over-determined solution or redundant calculations to check the consistency of satellite measurements, such as carrier phase measurements and code phase measurements of one or more satellites for each reference receiver 130 in the network. The RAIM algorithm requires at least five satellites in reception range to detect a material carrier phase error measurement or material error in the clock correction for any satellite in the constellation. The correction manager 740 or data processor 120 may delete, suspend or flag (as suspect or unreliable) low-latency clock correction data 108 for one or more satellites that that is determined to be erroneous or unreliable such that the mobile receiver 20 or rover may ignore or provide less weight to low-latency clock correction data 108 that has been flagged as suspect or unreliable.

In one example of executing block 610, the received satellite signals, low latency clock module (42, 407) or the delta clock filter 412 uses the a priori satellite clock rates from broadcast ephemeris to estimate delta satellite clocks as an error checking mechanism, such as supporting the RAIM algorithm. Within the low latency clock module (42, 407), an additional predictive filter (e.g., Kalman filter or least squares estimator) can be used to estimate delta clock for the RAIM algorithm. Further, the estimated delta satellite clocks derived from the broadcast ephemeris can be compared to the estimated delta satellite clods associated with the predictive filter or lease squares estimator. The number of estimated state variables or unknowns is equal to the number of active satellites. The RAIM algorithm is used to ensure to detect and remove any measurement with cycle slips.

In block 612, the data processor 120, correction data estimator 34, or low latency clock module (42, 407) accumulates delta clock data and computes the clock data that corresponds to measurement time or epoch Ti for incorporation into the correction data (108, 653) or low-latency correction data. For example, the low-latency correction data 108 incorporates precise orbital correction data 650, precise low-latency clock data, precise low-latency clock quality data, and wide-lane satellite bias data and narrow-lane satellite bias data on a satellite-by-satellite basis that can be applied to the particular satellites in view of or within reliable reception range of the mobile receiver 20. In one configuration, the correction data 108 can be globally valid in the GNSS system for each corresponding measurement time or epoch and for each satellite to which it pertains.

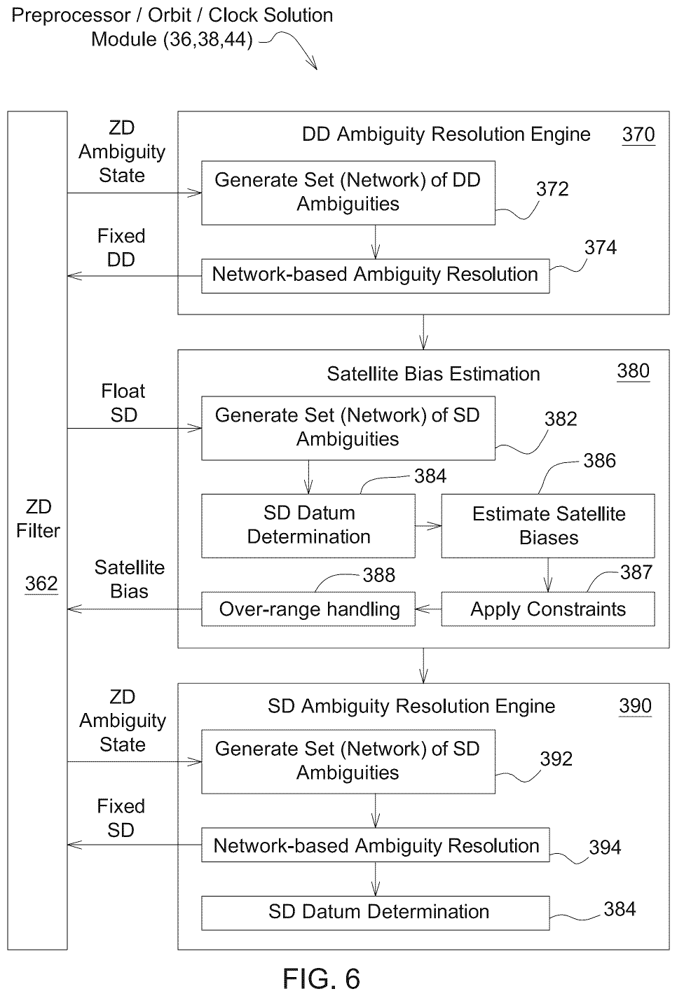

FIG. 6 is a block diagram of the measurement preprocessing module 36, orbit solution module 38 and clock solution module 44 shown in FIG. 4A, according to some embodiments. Each of these modules (e.g., 36, 38, 44) include a zero difference filter 362, such as a zero difference Kalman filter, that generates and updates a zero difference ambiguity state and other state variables (described in more detail herein), a double-difference ambiguity resolution engine (“ARE”) 370, a satellite bias estimation module 380, and a single-difference ambiguity resolution engine (“ARE”) 390. It is noted that in measurement preprocessing module 36, the ambiguities being resolved and the satellite bias values being determined are extra-wide-lane ambiguities, wide-lane ambiguities and satellite bias values (e.g., EWL bias and WL bias), while in the orbit solution module 38 and clock solution module 44, the ambiguities being resolved and the satellite bias values being determined are narrow-lane ambiguities and satellite bias values.

The double-difference ambiguity resolution engine 370 determines a set of double-difference ambiguities based on ambiguity state variable estimates received from the zero difference filter 362, determines which of the double-difference ambiguities are ready for resolution in accordance with predefined criteria, and performs a network-based ambiguity resolution process 374, which determines double-difference fixed ambiguity values. For example, the double-difference ambiguity engine 370 comprises a generator 372 of DD ambiguities that generates or determines a set of double-difference ambiguities (e.g., ambiguity candidates with an applicable search space) based on ambiguity state variable estimates received from the zero difference filter 362.

It is noted that since the satellites are in motion, flight, or in orbit, the distance between each reference receiver (station) and the corresponding satellites in view (of such reference receiver) is constantly changing over time. As a result, the ambiguity state output by the ZD filter 362 is being updated each measurement epoch (e.g., once per second), and the double-difference fixed ambiguity values are also being updated each epoch. Thus the double-difference fixed ambiguity values, each based on a combination of four float ambiguities, are “fixed” in that they have integer values, or an integer property, but the four float ambiguities are not constant due to slowly changing receiver phase bias, and instead are updated at the update rate or epoch rate of the module 36, 38 or 44. As explained in more detail below, the various module each have their own update rate (e.g., relative to the epoch of the carrier phase measurements).

Similarly, the single-difference fixed ambiguity values generated by the single-difference ambiguity resolution engine 390 are updated each epoch. Furthermore, as the sets of satellites in view of the various reference stations change, due to movement of the satellites along their respective orbits, in some embodiments the SD datum, discussed below, is updated, and as needed, new satellite bias estimates are generated and provided to the ZD filter 362. Thus, in one embodiment, the computation processes performed by each of the modules are dynamic processes, with the ZD Kalman filter states generated by the ZD filter 362 of each module (e.g., measurement preprocessing module 36, orbit solution module 38, clock solution module 44) being updated once per epoch, and the external “filters” or “engines” (370, 380 and 390) also producing updated solutions to support the operation of the ZD filter 362.

The satellite bias estimation module 380 is invoked, to determine initial satellite bias values, once a sufficient quantity (e.g., at least half) of the double-difference ambiguities have been resolved (i.e., fixed DD ambiguities have been determined). Using a process described in more detail below, the fixed DD ambiguities, alone or together with SD float ambiguities, are used to estimate (i.e., determine) an initial satellite bias value for each satellite. Once the initial satellite bias value for each satellite has been estimated, the satellite bias values can be separated from the float DD ambiguities, which facilitates resolution of the double-difference ambiguities in subsequence computations (both by the satellite corrections generation system (e.g., 11 or 111 or 211), and by navigation receivers (e.g., rovers 20).

Furthermore, once the initial satellite bias values have been determined by satellite bias estimation module 380, the initial satellite bias values are updated by the ZD filter 362 at a predefined rate, for example once per epoch or once per P epochs, where P is an integer greater than one, depending on the implementation. The satellite bias estimation module 380 may comprise a generation process (382) for a set of SD ambiguities (e.g., candidate ambiguities), a SD datum determination process 384 and an estimation process 386 for satellite biases based on the input of float SD ambiguities from the ZD filter 362, where the estimated satellite biases are applied to the constrain process 387.

If SD fix of ambiguities is ready for a given satellite. SD ambiguity constraints in SD ambiguity resolution engine 390 are applied to improve satellite bias values and other state estimation in the ZD filter 362 for that satellite. In some embodiments, satellite extra-wide lane bias, or satellite wide-lane bias, or both values are updated at a rate of once per minute (i.e., at the update rate of the measurement preprocessing module 36), and satellite narrow-lane bias values are updated at a rate of once per 30 seconds (i.e., at the update rate of the clock solution module 44), but other update rates may be used in other embodiments. Satellite bias estimate module 380 is discussed in further detail below.

In some embodiments, single-difference ambiguity resolution engine 390 is invoked after the satellite bias estimation module 380 has generated a set of initial satellite bias values that satisfy predefined constraints (387) and which have been adjusted by over-range handling (388), as needed, to maintain the satellite bias values within a predefined range of values. For example, the satellite WL bias dynamic noise in the ZD filter (362, 400, 501), which is available from the WL filters in the preprocessing module, may comprise a predefined constraint 387 for satellite WL bias estimation: the satellite EWL bias dynamic noise in the ZD filter (362, 400, 501), which is available from the EWL filters, may comprise a predefined constraint 387 for satellite WL bias estimation. Similarly, the satellite NL bias dynamic noise, which is available from the satellite code bias filters (e.g., code-phase bias filters), may comprise a predefined constraint 387 for satellite NL bias estimation. In FIG. 6, satellite bias output from the satellite bias estimation module 380 refers to satellite WL bias estimates, satellite EWL bias estimates, or satellite NL bias estimates (e.g., for the corresponding module or modules (26, 38, 44).

The single-difference ambiguity resolution engine 390 determines a set of single-difference ambiguities (e.g., float single-difference ambiguities) based on ambiguity state variable estimates received from the zero difference filter 362, which, in turn, have been adjusted based on the fixed double-difference ambiguities determined by the double-difference ambiguity resolution engine 370. Using the determined set of single-difference ambiguities, the single-difference ambiguity resolution engine 390 determines which of the single-difference ambiguities are ready for resolution in accordance with predefined criteria, and performs a network-based ambiguity resolution process 394, which determines single-difference fixed ambiguity values. It is noted that once an initial set of single-difference fixed ambiguity values have been determined and provided to ZD filter 362, single-difference ambiguity resolution engine 390 updates the set of single-difference fixed ambiguity values in accordance with changes in the zero-difference ambiguity state, as received from the ZD filter 362. For example, the single-difference ambiguity engine 390 comprises a generator 392 of SD ambiguities that generates or determines a set of single-difference ambiguities (e.g., ambiguity candidates with an applicable search space) based on ambiguity state variable estimates received from the zero difference filter 362.

### Notation

In the explanations that following the following symbols and notation conventions are used:
P is code measurement from satellite to receiver in meter:
Φ is phase measurement from satellite to receiver in cycle;
B is code bias due to satellite hardware delay and receiver related delay
b is phase bias due to satellite hardware delay, receiver related delay and un-modeled satellite phase wind-up errors
b_{IFB} is the linear Inter-Frequency code bias, which is only applicable to frequency division multiple access (FDMA) signal, e.g., GLONASS
N is the integer ambiguity
f is the GNSS carrier signal frequency
λ is the GNSS carrier signal wavelength

### Frequency Notation

Subscripts denote the applicable frequency associated with a quantity as follows:
[ ]_{L1} refers to L1 frequency,
[ ]_{L}_{₂} refers to L2 frequency,
[ ]_{WL} refers to wide-lane, L1−L2,
[ ]_{NL} refers to narrow-lane, L1+L2.

### Receiver Notation

Subscripts that include the lower case letter r denote quantities associated with a particular receiver (e.g., a reference receiver) as follows:
[ ]ᵣ_{₁} refers to receiver r₁,
[ ]ᵣ_{₂} refers to receiver r₂.

### Satellite Notation

Superscripts that include the lower case letter s denote quantities associated with a particular satellite as follows:
[ ]^{S}^{₁} refers to satellite, S₁,
[ ]^{S}^{₂} refers to satellite S₂.

### Differential Notation

Δ[ ]ᵣ_{₁}ᵣ_{₂} refers to single difference between receiver r₁ and r₂,
Δ[ ]^{S}^{₁}^{S}^{₂} refers to single difference between satellite S₁ and S₂,

$$∇ {Δ [ ]}_{{r}_{1} {r}_{2}}^{{S}_{1} {S}_{2}}$$

refers to double difference between receiver r₁ and r₂, and satellite S₁ and S₂

### Ambiguity Notation

The ambiguity scalar or vector form notation follows
\hat{N} refers to the float ambiguity (sometimes called floating ambiguities),
┌\hat{N}′ refers to the fractional part of the float ambiguity,
round(\hat{N}) refers to the round off integer part of the float ambiguity,
N refers to the fixed integer ambiguity.

The ambiguities are often organized in a vector form. The ambiguity vector notation form is as follows:
\hat{N}_{float} refers to the float ambiguity vector \hat{N}_{float}={\hat{N}₁, . . . , \hat{N}ⱼ, . . . , \hat{N}ₙ},where \hat{N}ⱼ is the j^{th} float ambiguity element,
N_{fixed} refers to the fixed integer ambiguity vector N_{fixed}={N₁, . . . , Nⱼ, . . . , Nₙ}, where Nⱼ is the j^{th} fixed integer ambiguity element,
N̅ᵢ refers to the i^{th} integer ambiguity candidate vector, as various ambiguity candidate vectors trials are made during the ambiguity search process,
\hat{N}^{j} refers to the partial float ambiguity vector with the j^{th} ambiguity element or more \hat{N}ⱼ removed. For example, when the full ambiguity vector cannot be fixed, a partial fix is attempted by removing some ambiguity elements.

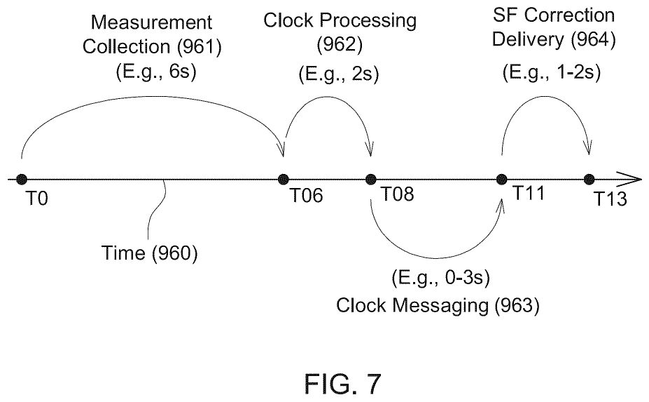

FIG. 7 is a diagram that illustrates that the final latency of the correction signals is a cumulative composition of three basic sources: (1) measurement collection duration 961 (e.g., about 6 seconds) which is commensurate with the time for the network data (e.g., raw carrier phase measurements and code phase measurements of L1, L2 and L3 satellite signals) from reference receivers 130 to arrive at the data processing center 118 or correction data center 34 (e.g., network processing server); (2) clock/orbit processing duration 962 (e.g., 2 seconds), alone, or together with clock messaging time 963, which is collectively commensurate the network processing time; and (3) correction delivery duration 964, which is the time for the correction wireless transmission time to deliver to correction data from the data processing center 118 or correction data center 34 to a mobile GNSS receiver or rover 20 via a satellite channel or a wireless data channel (e.g., cellular or wireless communications network.

### Initial Satellite Wide-Lane Bias Determination

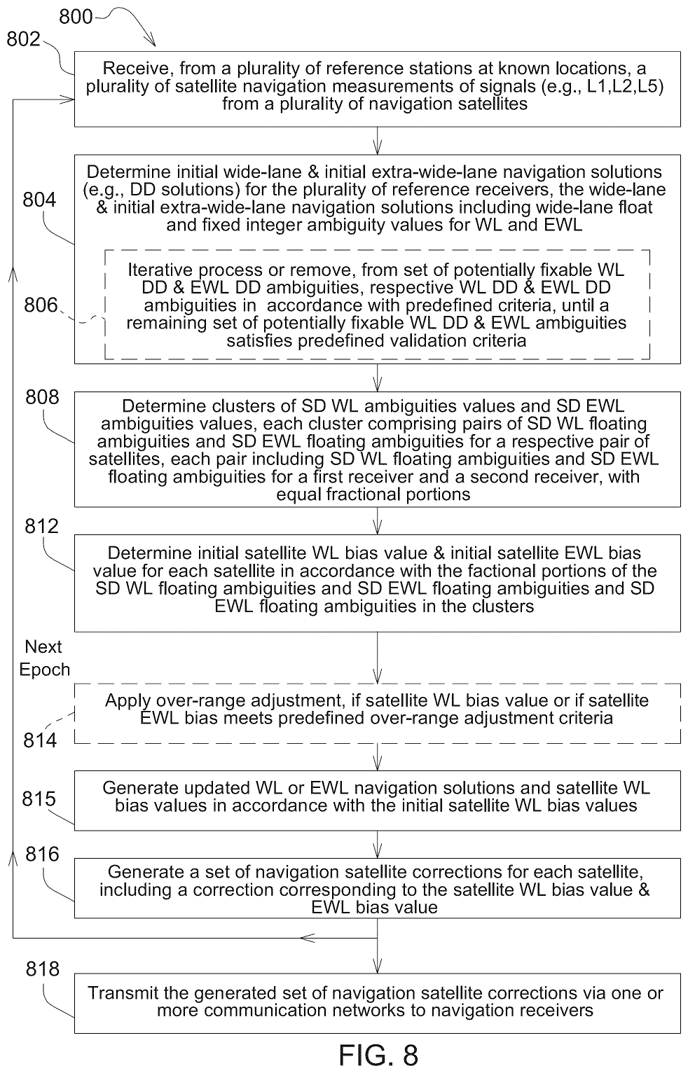

FIG. 8 is a flowchart of a process 800 (also herein called method 800) for determining satellite extra-wide-lane (EWL) and wide-lane (WL) biases for a plurality of satellites, comprising n satellites, to facilitate navigation by navigation receivers that receive satellite navigation signals from various subsets of the plurality of satellites. FIG. 8 is a flowchart of a process 800 for resolving extra-wide-lane double-difference ambiguities, extra-wide-lane single difference ambiguities, wide-lane double-difference ambiguities and single-difference wide-lane ambiguities (e.g., collectively EWL and WL carrier cycle integer ambiguities) in a measurement preprocessing module (36, 136) and providing those solutions to orbit, clock and low latency clock modules (138, 144 and 407 in FIG. 1), according to some embodiments. Process 800 concerns extra-wide lane bias and wide-lane bias determination, whereas the operation of measurement preprocessing module (36, 136) is configured to resolve extra-wide-lane ambiguities and wide-lane ambiguities and provide those solutions to the other modules (e.g., orbit, clock and low latency clock modules).

Method 800 includes receiving (802) reference receiver measurement information, including receiving, from a plurality of reference receivers at established locations, measurements of satellite navigation signals received by each of the reference receivers, wherein the satellite navigation signals received by each reference receiver of the plurality of reference receivers include satellite navigation signals at first (L1), second (L2) frequencies, and third frequencies (L3) for the respective carrier frequencies. For the Global Positioning System (GPS) constellation, the first, second and third frequencies are sometimes referred to as L1, L2 and L5, where L5 is now available on a growing number of GPS satellites. Typically, each reference receiver receives signals from at least four or five satellites that are within view or reliable reception of the reference receiver's GNSS antenna.

As shown in FIG. 8, in process 800, the received values, such as carrier phase measurements, code phase measurements, or both of the first frequency, second frequency and third frequency, are used to update, for a next epoch, the measurement preprocessor's zero-difference (ZD) filter, and in particular the ZD wide-lane float ambiguities for each reference receiver 130 and the ZD wide-land satellite biases, such as in step 815. For systems using signals from GLONASS satellites, the extra-wide lane inter-frequency bias and wide-lane inter-frequency bias (IFB) for each receiver is updated for the next epoch using the received measurements of satellite navigation signals.

Method 800 includes, in accordance with the received reference receiver measurement information, and in accordance with the established locations (e.g., two or three dimensional coordinates of stationary reference references) of the plurality of reference receivers 130, determining (804) initial wide-lane navigation solutions (of refraction-corrected wide-lane navigation solutions) and extra-wide-lane navigation solutions (of refraction-corrected wide-lane navigation solutions) for the plurality of reference receivers 130. For example, as discussed above, in some embodiments (and typically) the Melbourne-W\ddot{υ}bbena linear combination

$${L}_{r , WL}^{s}$$

is used for wide-lane ambiguity resolution and the Melbourne-W\ddot{υ}bbena linear combination

$${L}_{r , EWL}^{S}$$

is used for extra-wide-lane ambiguity resolution. As shown in FIG. 8, the Melbourne-Wubbena linear combination is iteratively updated (in 804 and 806) by the ZD filter of preprocessing module (MPP) 36, using the received measurements of satellite navigation signals.

The initial wide-lane navigation solutions and initial extra-wide-lane solutions include double-difference (DD) wide-lane fixed integer ambiguity values, double-difference (DD) wide-lane fixed integer ambiguity values, single-difference (SD) wide-lane floating ambiguities, and single-difference (SD) extra-wide-lane floating ambiguities. Further, in accordance with the initial wide-lane navigation solutions, for a constellation of n satellites in the plurality of satellites, method 800 includes determining (808) clusters (e.g., m clusters) of single-difference (SD) wide-lane floating ambiguities (e.g., where with respect to m clusters, m is an integer greater than one) and SD extra-wide-lain floating ambiguities. Each cluster (e.g., of m clusters or n−1 clusters, where m equals n−1 for n satellites) of SD wide-lane ambiguity values comprises pairs of SD wide-lane floating ambiguities,

$$∇ {\hat{N}}_{{r}_{m}}^{{S}_{i} {S}_{j}} and ∇ {\hat{N}}_{{r}_{n}}^{{S}_{i} {S}_{j}} ,$$

for a respective pair of satellites (e.g., satellites i and j). Further, each cluster (e.g., of m clusters or n−1 clusters, where m equals n−1 for n satellites) of SD extra-wide-lane ambiguity values comprises pairs of SD extra-wide-lane floating ambiguities,

$$∇ {\hat{N}}_{{r}_{m}}^{{S}_{i} {S}_{j}} and ∇ {\hat{N}}_{{r}_{n}}^{{S}_{i} {S}_{j}} ,$$

for a respective pair of satellites (e.g., satellites i and j).

Each pair of SD wide-lane floating ambiguities includes first and second SD wide-lane floating ambiguities for a first reference receiver, rₘ, and a second receiver, rₙ, respectively, that receive satellite navigation signals from both satellites in the respective pair of satellites. Furthermore, the SD wide-lane floating ambiguities in each pair of SD floating ambiguities have equal fractional portions.

$$⌊ ∇ {\hat{N}}_{{r}_{m}}^{{S}_{i} {S}_{j}} ⌋ = ⌊ ∇ {\hat{N}}_{{r}_{n}}^{{S}_{i} {S}_{j}} ⌋ .$$

For example, the fractional ambiguities are consistent with ambiguity clusters and SD ambiguity datum determination.

Similarly, each pair of SD extra-wide-lane floating ambiguities includes first and second SD extra-wide-lane floating ambiguities for a first reference receiver, rₘ, and a second receiver, rₙ, respectively, that receive satellite navigation signals from both satellites in the respective pair of satellites. Furthermore, the SD extra-wide-lane floating ambiguities in each pair of SD extra-wide-lane floating ambiguities have equal fractional portions,

$$⌊ ∇ {\hat{N}}_{{r}_{m}}^{{S}_{i} {S}_{j}} ⌋ = ⌊ ∇ {\hat{N}}_{{r}_{n}}^{{S}_{i} {S}_{j}} ⌋ .$$

For example, the fractional ambiguities are consistent with ambiguity clusters and SD ambiguity datum determination.

Method 800 also includes, determining (812) an initial satellite wide-lane bias value,

$${b}_{WL}^{s} ,$$

and an initial satellite extra-wide bias value

$${b}_{EWL}^{s}$$

for each satellite s or the n satellites, in accordance with fractional portions of the SD wide-lane floating ambiguities in the m clusters. For example, see the above discussion of satellite bias estimation.

Furthermore, method 800 includes, in accordance with the determined initial satellite wide-lane bias value,

$${b}_{WL}^{s} ,$$

and an initial satellite extra-wide bias value

$${b}_{EWL}^{s}$$

for each satellite s of the n satellites, generating (815) updated wide-lane navigation solutions for the plurality of reference receivers, including SD wide-lane fixed integer ambiguity values and SD extra-wide-lane fixed integer ambiguity vales for the plurality of reference receivers 130. For example, in some embodiments, MPP ZD Kalman filter of the measurement preprocessing module (36, 136) generates updated satellite wide-lane bias values and wide-lane navigation solutions at predefined intervals, often called epochs, using the initial satellite wide-lane bias values and initial wide-lane navigation solutions as initial values (e.g., as initial values for state variables corresponding to the DD wide-lane ambiguities and satellite wide-lane bias values). Similarly, the MPP ZD Kalman filter of the measurement preprocessing module (36, 136) generates updated satellite extra-wide-lane bias values and extra-wide-lane navigation solutions at predefined intervals, often called epochs, using the initial satellite extra-wide-lane bias values and initial extra-wide-lane navigation solutions as initial values (e.g., as initial values for state variables corresponding to the DD extra-wide-lane ambiguities and satellite extra-wide-lane bias values).

Further, the method 800 includes generating (816) a set of navigation satellite corrections for each satellite of the n satellites, the set of navigation satellites corrections for each satellite s including a correction corresponding to the satellite wide-lane bias value,

$${b}_{WL}^{s} ,$$

and the satellite extra-wide-lane bias value,

$${b}_{EWL}^{s}$$

determined for satellite s wherein the sets of navigation satellite corrections for the n satellites are for transmission to navigation receivers for use in determining locations of the navigation receivers.

In some embodiments, the sets of navigation satellite corrections for the n satellites are for transmission to navigation receivers for use in determining locations of the navigation receivers using an absolute mode of navigation, such as precise point positioning (PPP). Furthermore, in some embodiments, method 800 includes transmitting (818) the generated set of navigation satellite corrections for each satellite of the n satellites via one or more communication networks to navigation receivers for use in determining current locations of the navigation receivers using an absolute mode of navigation, a relative mode of navigation, or both.

In some embodiments, method 800 can be performed by orbit solution system of FIG. 1. In the method 800, the preprocessing module (36, 136) is configured to combine raw GNSS measurements (e.g., carrier phase measurements at the first, second and third frequencies, L1, L2 and L3, respectively) with information regarding detected phase slips and code outliers (i.e., clean GNSS measurements), resolved WL ambiguities (e.g., SD fixed ambiguities), resolved EWL ambiguities (e.g., SD fixed ambiguities) in the MPP ZD filter 400, and the generated satellite WL biases and EWL biases, and sends the combined information to orbit solution, clock solution and low latency clock solution modules 38, 44 and 42, respectively.

In some embodiments, the number of clusters (see discussion of operations 808, 812, above), m, is equal to n−1, the satellite wide-lane bias value,

$${b}_{WL}^{s} ,$$

for each satellite s is a wide-lane phase bias value, and determining n−1 clusters of single-difference (SD) ambiguity values includes determining a set of fixed wide-lane double-difference (DD) ambiguity values with respect to the reference receivers and the plurality of satellites, each fixed wide-lane DD ambiguity value corresponding to a pair of the reference receivers and a pair of the satellites in the plurality of satellites. Further, each pair of SD wide-lane floating ambiguities,

$$∇ {\hat{N}}_{{r}_{m}}^{{S}_{i} {S}_{j}} and ∇ {\hat{N}}_{{r}_{n}}^{{S}_{i} {S}_{j}}$$

for a pair of satellites Sᵢ and Sⱼ corresponds to a respective DD wide-lane fixed ambiguity value in the determined set of DD wide-lane fixed ambiguity values.

Similarly, in some embodiments, the number of clusters (see discussion of operations 808, 812, above), m, is equal to n−1, the satellite wide-lane bias value,

$${b}_{EWL}^{s} ,$$

for each satellite s is an extra-wide-lane phase bias value, and determining n−1 clusters of single-difference (SD) ambiguity values includes determining a set of fixed extra-wide-lane double-difference (DD) ambiguity values with respect to the reference receivers and the plurality of satellites, each fixed extra-wide-lane DD ambiguity value corresponding to a pair of the reference receivers and a pair of the satellites in the plurality of satellites. Further, each pair of SD extra wide-lane floating ambiguities,

$$∇ {\hat{N}}_{{r}_{m}}^{{S}_{i} {S}_{j}} and ∇ {\hat{N}}_{{r}_{n}}^{{S}_{i} {S}_{j}}$$

for a pair of satellites Sᵢ and Sⱼ corresponds to a respective DD extra wide-lane fixed ambiguity value in the determined set of DD extra wide-lane fixed ambiguity values.

In some embodiments, determining (804) the initial set of fixed wide-lane DD ambiguity values with respect to the reference receivers and the plurality of satellites includes performing (806) an iterative process of removing respective float wide-lane ambiguities from a set of potentially fixable float wide-lane DD ambiguities in accordance with predefined criteria for identifying problematic float wide-lane DD ambiguities, until a remaining set of potentially fixable float wide-lane DD ambiguities satisfies predefined validation criteria. For example, see the above discussions of the LAMBDA search process, the partial LAMBDA search process, and identifying and removing problematic ambiguity elements.

Similarly, in some embodiments, determining (804) the initial set of fixed extra-wide-lane DD ambiguity values with respect to the reference receivers and the plurality of satellites includes performing (806) an iterative process of removing respective float extra-wide-lane ambiguities from a set of potentially fixable float extra-wide-lane DD ambiguities in accordance with predefined criteria for identifying problematic float extra-wide-lane DD ambiguities, until a remaining set of potentially fixable float extra-wide-lane DD ambiguities satisfies predefined validation criteria. For example, see the above discussions of the LAMBDA search process, the partial LAMBDA search process, and identifying and removing problematic ambiguity elements.

In some embodiments, method 800 further includes periodically determining an updated set of fixed wide-lane double-difference (DD) ambiguity values and fixed extra-wide-lane double-difference (DD) ambiguity values with respect to the reference receivers and the plurality of satellites, and determining updates to the determined satellite wide-lane bias values and determined satellite extra-wide-lane bias values for the n satellites in accordance with updated set of fixed wide-lane DD ambiguity values and in accordance with an updated set of fixed extra-wide-lane DD ambiguity values. For example, as described above, computations by preprocessing module 320 are repeated or updated periodically, during successive time intervals sometimes called epochs.

In some embodiments of method 800, determining a satellite wide-lane bias value,

$${b}_{WL}^{s} ,$$

for a respective satellite includes determining an average (e.g., median) satellite wide-lane bias value from a set of satellite wide-lane bias values, determining whether a corresponding variance meets predefined criteria, and in accordance with a determination that the variance meets the predefined criteria, setting the satellite wide-lane bias value,

$${b}_{WL}^{s} ,$$

to the determined median satellite wide-lane bias value. For example, over-range adjustment is handled for satellite WL biases by the measurement preprocessing module 36, the orbit solution module 38, or the clock solution module 44, or any combination of the foregoing modules.

In some embodiments, method 800 includes applying (814) an over-range adjustment to a respective satellite wide-lane bias value if the respective satellite wide-lane bias value meets predefined over-range adjustment criteria. For example, in some such embodiments, determining (812) a satellite wide-lane bias value,

$${b}_{WL}^{s} ,$$

for a respective satellite includes determining whether the satellite wide-lane bias value meets over-range adjustment criteria, and in accordance with a determination that the satellite wide-lane bias value meets the over-range adjustment criteria, adjusting the satellite wide-lane bias value by a predefined number of wide-lane cycles, and adjusting corresponding SD wide-lane ambiguity values by the predefined number of wide-lane cycles. For example, as explained above with respect to preprocessor satellite WL bias over-range handling by the measurement preprocessing module (36, 136), when a respective satellite WL bias value falls outside a predefined range, such as (−2, 2), the satellite WL bias value is decreased by an amount represented by:

$$round ( {b}_{WL \_ MPP \_ SYS}^{s} ) ,$$

which is typically equal to 2 or −2, and a corresponding adjustment is made for each satellite s related ambiguity

$${N}_{r , WL}^{s}$$

by compensating a commensurate amount (e.g., adding the same amount).

In some embodiments, method 800 includes applying (814) an over-range adjustment to a respective satellite extra-wide-lane bias value if the respective satellite extra-wide-lane bias value meets predefined over-range adjustment criteria. For example, in some such embodiments, determining (812) a satellite extra-wide-lane bias value,

$${b}_{EWL}^{s} ,$$

for a representing satellite includes determining whether the satellite extra-wide-lane bias value meets over-range adjustment criteria, and in accordance with a determination that the satellite extra-wide-lane bias value meets the over-range adjustment criteria, adjusting the satellite extra-wide-lane bias value by a predefined number of wide-lane cycles, and adjusting corresponding SD extra-wide-lane ambiguity values by the predefined number of extra-wide-lane cycles. For example, as explained above with respect to preprocessor satellite EWL bias over-range handling by the measurement preprocessing module 36, when a respective satellite EWL bias value falls outside a predefined range, such as (−2, 2), the satellite EWL bias value is decreased by an amount represented by:

$$round ( {b}_{EWL \_ MPP \_ SYS}^{s} ) ,$$

which is typically equal to 2 or −2, and a corresponding adjustment is made for each satellite s related ambiguity

$${N}_{r , EWL}^{s}$$

by compensating a commensurate amount (e.g., adding the same amount).

In some embodiments of method 800, determining (812) the initial satellite wide-lane bias value.

$${b}_{WL}^{s} ,$$

for each satellite s of the n satellites includes comparing the determined satellite wide-lane bias value for each satellite s of the n satellites with a corresponding satellite wide-lane bias value determined when generating orbit and clock corrections for the n satellites, and adjusting the determined satellite wide-lane bias value for a respective satellite by an integer number of wide-lane cycles when an absolute value of a difference between the determined satellite wide-lane bias value and the corresponding satellite wide-lane bias value exceeds a predefined threshold. For example, see the above discussion of over-range handling for satellite WL biases in the orbit solution module 38 and clock solution module 44.

In some embodiments, determining the satellite wide-lane bias value,

$${b}_{WL}^{s} ,$$

for each satellite s of the n satellites includes the setting the satellite wide-lane bias values for the n satellites such that a sum of the satellite wide-lane bias values for the n satellites is equal to zero.

In some embodiments of method 800, determining (812) the initial satellite extra-wide-lane bias value,

$${b}_{EWL}^{s} ,$$

for each satellite s of the n satellites includes comparing the determined satellite wide-lane bias value for each satellite s of the n satellites with a corresponding satellite extra-wide-lane bias value determined when generating orbit and clock corrections for the n satellites, and adjusting the determined satellite extra-wide-lane bias value for a respective satellite by an integer number of wide-lane cycles when an absolute value of a difference between the determined satellite extra-wide-lane bias value and the corresponding satellite extra-wide-lane bias value exceeds a predefined threshold. For example, see the above discussion of over-range handling for satellite EWL biases in the orbit solution module 38 and clock solution module 44.

In some embodiments, determining the satellite extra-wide-lane bias value,

$${b}_{EWL}^{s} ,$$

for each satellite s of the n satellites includes the setting the satellite extra-wide-lane bias values for the n satellites such that a sum of the satellite extra-wide-lane bias values for the n satellites is equal to zero.

In some embodiments, the plurality of satellites are GLONASS satellites, which each transmit satellite navigation signals on first and second frequencies, L1 and L2, wherein different ones of the GLONASS satellites transmit satellite navigation signals in different first and second frequency bands, L1 and L2, wherein each GLONASS satellite s transmits a first satellite navigation signal with a center frequency

$${f}_{{L}_{1}}^{s}$$

in the L1 band of:

$${f}_{{L}_{1}}^{s} = 1602 MHz + {n}^{s} \times 0.5625 MHz$$

and a second satellite navigation signal with a center frequency

$${f}_{{L}_{2}}^{s}$$

in the L2 band of

$${f}_{{L}_{2}}^{s} = 1246 MHz + {n}^{s} \times 0.4375 MHz$$

where n^{s} is a frequency channel number assigned to satellite s, and the frequency channel number assigned to each satellite has an integer value between −7 and +6, inclusive. In such embodiments, method 800 includes determining, for each reference receiver in at least a subset of the plurality of reference receivers, a wide-lane inter-frequency bias (IFB) coefficient kᵣ, and for each satellite for which measurements of satellite navigation signals are received from the reference receiver, an inter-frequency bias value corresponding to a product of the wide-lane inter-frequency bias (IFB) coefficient kᵣ for the reference receiver multiplied by the frequency channel number assigned to satellite s. Furthermore, in such embodiments, the satellite wide-lane bias value,

$${b}_{WL}^{s} ,$$

or satellite extra-wide-lane bias

$${b}_{EWL}^{s} ,$$

for each satellite s of the n satellites is determined in accordance with the inter-frequency bias values determined for at least a subset of the reference receivers 130.

In another aspect, a system, such as satellite corrections generation system, includes a plurality of interconnected computer systems that are configured to, collectively, execute a plurality of navigation satellite correction modules, which causes the plurality of navigation satellite correction modules to perform method 800.

In yet another aspect, a non-transitory computer readable storage medium stores one or more programs for execution by one or more processors of a plurality of interconnected computer systems. The one or more programs include instructions that when executed by the one or more processors of the system cause the system to perform method 800.

Generally, a reference receiver 130 is configured to receive a plurality of satellite signals from each satellite within reception range of the reference receiver: the satellite signals comprise a first carrier frequency (e.g., L1, E1, B1), a second carrier frequency (e.g., L2, E6, B3), and third carrier frequency (e.g., L5, E5A, B2A). A measurement module 56 is configured to measure the carrier phase (which has integer ambiguities in wavelength cycles) and code phase (which is unambiguous and not associated with integer ambiguities) of the corresponding satellite signals from each satellite to estimate a first carrier phase of the respective first carrier frequency, to estimate a second carrier phase of a respective second carrier frequency, and to estimate a third carrier phase of the respective third carrier frequency. A precise point positioning module 16 or an estimator is configured to determine first wide-lane, floating or fixed ambiguities and associated first wide-lane biases for each satellite based on the first carrier phase and second carrier phase associated with the corresponding satellite. The precise point positioning module 16 or the estimator is configured to determine second wide-lane, floating or fixed ambiguities and associated second wide-lane biases for each satellite based on the second carrier phase and third carrier phase associated with the corresponding satellite. The precise point positioning module 16 or the estimator is configured to determine narrow-lane, floating or fixed ambiguities, a satellite slow clock solution and a time-variant narrow-lane bias for a corresponding satellite based within a narrow-lane bias/code-phase bias filter for each satellite. A correction data estimator 34 is configured to provide a correction signal comprising the first wide-lane ambiguities (e.g., WL ambiguities), second wide-lane ambiguities (e.g., EWL ambiguities), first wide-lane bias (e.g., WL bias), second wide-lane bias (e.g., EWL bias) and the narrow-lane ambiguities and the time-variant narrow lane bias.

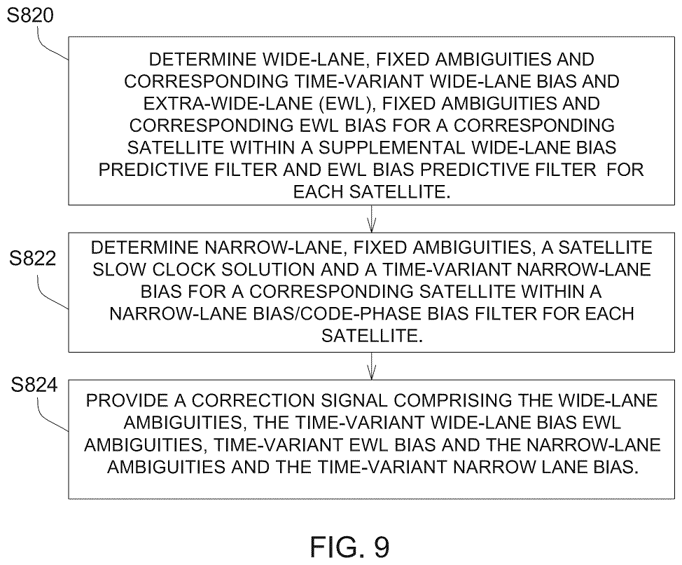

FIG. 9 illustrates flow chart from one embodiment of a method for providing a global satellite differential correction signal. The method starts in step S820 and comprises an improvement to providing a global satellite correction signal.

In step S820, the electronic data processor (e.g., 120), measurement pre-processing module (36, 16) or one or more of its filters (400, 37, 501) determine wide-lane, fixed ambiguities and corresponding a time-variant wide-lane bias and extra-wide-lane, fixed ambiguities and corresponding a time-variant extra-wide-lane bias for a corresponding satellite based on adaptive estimation responsive to tuned dynamic noise within a supplemental wide-lane bias predictive filter 504 for each satellite. For example, the electronic data processor (e.g., 120), measurement pre-processing module 36, or one or more of its filters (400, 37, 501) determine the time-variant wide-lane bias in accordance with the following equation:

$${b}_{WL}^{s} = - ( \frac{{f}_{{L}_{1}}}{{f}_{{L}_{1}} + {f}_{{L}_{2}}} {B}_{{L}_{1}}^{s} + \frac{{f}_{{L}_{2}}}{{f}_{{L}_{1}} + {f}_{{L}_{2}}} {B}_{{L}_{2}}^{s} ) + ( \frac{{f}_{{L}_{1}}}{{f}_{{L}_{1}} - {f}_{{L}_{2}}} {b}_{{L}_{1}}^{s} - \frac{{f}_{{L}_{2}}}{{f}_{{L}_{1}} - {f}_{{L}_{2}}} {b}_{{L}_{2}}^{s} )$$

where

$${b}_{W L}^{s}$$

is satellite wide-lane bias (one per satellite for all receivers),

$${B}_{{L}_{1}}^{s}$$

is L1 satellite code bias,

$${B}_{{L}_{2}}^{s}$$

is L2 satellite code bias,

$${b}_{{L}_{1}}^{s}$$

is L1 satellite phase bias,

$${b}_{{L}_{2}}^{s}$$

is L2 satellite phase bias, f_{L}_{₁} is the L1 frequency, f_{L}_{₂} is the L2 frequency, and where both satellite and receiver wide-lane biases are not constant over time. Further, the time-variant wide lane bias can include an additional wide-lane inter-frequency bias for a corresponding satellite and receiver: particularly for the GLONASS GNSS constellation.

In certain configurations of step S820, the electronic data processor (e.g., 120), measurement pre-processing module (36, 136) or one or more of its filters (400, 37, 501) determines the WL bias by setting or establishing a tuned dynamic noise for satellite WL bias,

$${b}_{W L}^{s} ,$$

of each corresponding satellite, applicable to a first bank of WL ZD filters as follows:
inputting post-fit, wide-lane residuals, of corresponding satellites to a second bank of supplemental WL bias predictive filters that comprise WL Kalman filters;
determining for each satellite in ones of the supplemental WL bias predictive filters, a variance, Q_{\hat{b}t}, of the inputted wide-lane bias residuals at a corresponding measurement time (t); and
estimating a second variance or next variance, Q_{\hat{b}}_{ₜ₊₁} associated with a sampling time (t+1) after the measurement time based on tuned dynamic noise, q_{\hat{b}}, consistent with a dynamic noise constraint (separately and independently determined for the WL Kalman filter for a respective satellite) defined by T (T_{WL}).

For example, the electronic data processor (e.g., 120), measurement pre-processing module 36, or one or more of its filters (400, 37, 501) determine the time-variant wide-lane bias in accordance with the following equation:

$${b}_{E W L}^{s} = - ( \frac{{f}_{{L}_{2}}}{{f}_{{L}_{2}} + {f}_{{L}_{3}}} {B}_{{L}_{2}}^{s} + \frac{{f}_{{L}_{3}}}{{f}_{{L}_{2}} + {f}_{{L}_{3}}} {B}_{{L}_{3}}^{s} ) + ( \frac{{f}_{{L}_{2}}}{{f}_{{L}_{2}} - {f}_{{L}_{3}}} {b}_{{L}_{2}}^{s} - \frac{{f}_{{L}_{3}}}{{f}_{{L}_{2}} - {f}_{{L}_{3}}} {b}_{{L}_{3}}^{s} )$$

where

$${b}_{E W L}^{s}$$

is satellite wide-lane bias (one per satellite for all receivers),

$${B}_{{L}_{2}}^{s}$$

is L2 satellite code bias,

$${B}_{{L}_{3}}^{s}$$

is L3 satellite code bias,

$${b}_{{L}_{2}}^{s}$$

is L2 satellite code bias,

$${b}_{{L}_{3}}^{s}$$

is L3 satellite code bias, f_{L}_{₂} is the L2 frequency, f_{L}_{₃} is the L3 frequency, and where both satellite and receiver wide-lane biases are not constant over time. Further, the time-variant wide lane bias can include an additional wide-lane inter-frequency bias for a corresponding satellite and receiver: particularly for the GLONASS GNSS constellation.

In certain configurations of step S820, the electronic data processor (e.g., 120), measurement pre-processing module (36, 136) or one or more of its filters (400, 37, 501) determines the EWL bias by setting or establishing a tuned dynamic noise for satellite EWL bias,

$${b}_{E W L}^{s} ,$$

of each corresponding satellite, applicable to a first bank of EWL ZD filters as follows:
inputting post-fit, wide-lane residuals, of corresponding satellites to a second bank of supplemental EWL bias predictive filters that comprise EWL Kalman filters;
determining for each satellite in ones of the supplemental EWL bias predictive filters, a variance, Q_{\hat{b}}_{ₜ}, of the inputted wide-lane bias residuals at a corresponding measurement time (t); and
estimating a second variance or next variance, Q_{\hat{b}}_{ₜ₊₁} associated with a sampling time (t+1) after the measurement time based on tuned dynamic noise, q_{\hat{b}}, consistent with a dynamic noise constraint (separately and independently determined for the EWL Kalman filter for a respective satellite) defined by T (T_{EWL}).

In step S822, the electronic data processor (e.g., 120); orbit solution module (38, 138), or its filters (404, 39, 506); or the clock solution module (44, 144), or its filters (408, 43, 506) determine narrow-lane, fixed ambiguities, a satellite slow clock solution and a time-variant narrow-lane bias for a corresponding satellite (e.g., based on adaptive estimation on adaptive estimation responsive to tuned dynamic noise within a narrow-lane bias/code-phase bias filter(s) 512 for each satellite). For example, the electronic data processor (e.g., 120); orbit solution module (38, 138), or its filters (404, 39, 506); or the clock solution module (44, 144), or its filters (408, 43, 506) determine the time-variant narrow-lane code bias,

$${P}_{r , RC}^{s} ,$$

in accordance with the following:

$${P}_{r , R C}^{S} = \frac{{f}_{{L}_{1}}^{2}}{{f}_{{L}_{1}}^{2} - {f}_{{L}_{2}}^{2}} {P}_{r , {L}_{1}}^{S} - \frac{{f}_{{L}_{2}}^{2}}{{f}_{{L}_{1}}^{2} - {f}_{{L}_{2}}^{2}} {P}_{r , {L}_{2}}^{S} = {D}_{r}^{s} + {B}_{r , N L} - {B}_{N L}^{s} + {ε}_{{P}_{r , RC}^{s}}$$

where,

$${P}_{r , {L}_{1}}^{s}$$

is the narrow-lane L1 code bias for receiver r and satellite s,

$${P}_{r , {L}_{2}}^{s}$$

is the narrow-lane L2 code bias for receiver r and satellite s, f_{L}_{₁}, is the L1 frequency, f_{L}_{₂} is the L2 frequency,

$${D}_{r}^{s} ( e . g . , {D}_{r , {L}_{i = 1 , 2}}^{s} )$$

represents the common terms for any given frequency, B_{r,NL} is receiver r narrow-lane lane code bias (one per receiver and constellation for all visible satellites), is

$${B}_{NL}^{s}$$

satellite s narrow-lane lane code bias, and

$${ε}_{{P}_{r , RC}^{s}}$$

are errors in the refraction-corrected, narrow-lane code bias, such as unmodeled errors.
   In certain configurations of step S822, the electronic data processor (e.g., 120); orbit solution module 38, or its filters (404, 39, 506); or the clock solution module 44, or its filters (408, 43, 506) determine the NL bias by setting or establishing a tuned dynamic noise for satellite NL bias,

$${b}_{NL}^{s} ,$$

or satellite RC code-phase bias \hat{B}ₜ of each corresponding satellite, applicable to a first bank of NL ZD filters as follows:
inputting refraction corrected code (NL) residuals, of corresponding satellites to a second bank of NL bias filters/code-phase filters that comprise NL Kalman filters;
determining for each satellite in ones of the NL bias filters/code-phase filters, a variance, Q_{\hat{B}}_{ₜ}, of the inputted narrow-lane bias residuals at a corresponding measurement time (t); and
estimating a second variance or next variance, Q_{\hat{B}}_{ₜ₊₁} associated with a sampling time (t+1) after the measurement time based on tuned NL dynamic noise,

$${q}_{\hat{b}} , or {q}_{{b}_{NL}^{s}} ,$$

consistent with a dynamic noise constraint (separately and independently determined for the NL Kalman filter for a respective satellite) defined by T (T_{NL}).

In step S824, the low latency clock module 752, a correction manager 740, or an electronic data processor 120 of the data processing center 118 provide a correction signal comprising the wide-lane ambiguities, the time-variant wide-lane bias, the extra-wide-lane-ambiguities, the time-variant extra-wide-lane-bias, and the narrow-lane ambiguities and the time-variant narrow lane bias.

Step S824 may be conducted in accordance with various procedures that may be applied separately or cumulatively. Under a first procedure, the low latency clock module 752, a correction manager 740, or an electronic data processor 120 of the data processing center 118 determines one or more quality indicators indicating the quality of GNSS satellite orbit solution, satellite clock, satellite wide-lane bias, and narrow-lane bias in accordance to the following equation:

$$Q = \frac{{N}_{sat} + {N}_{ref} + {\sum }_{i = 1}^{{N}_{sat}} {Q}_{i}}{4}$$

where:
   Nₛₐₜ is the number of satellites used;
   N_{ref} is the number of reference sites used; and
   Qᵢ (Narrow Lane bias quality value) can be one of the following:
      =0 (UNSURE_SAT_BIAS) if satellite bias is not ready to use:
      =1 (POOR_SAT_BIAS) if satellite bias is poor and to be removed in partial fix:
      =2 (GOOD_SAT_BIAS) if satellite bias is good to use for SD fix; or
      =3 (GREAT_SAT_BIAS) if satellite bias is excellent and can be used for reference satellite.

Under a second procedure, the data processor 120, the low-latency clock module 752, or the correction manager 740 incorporates the quality indicators into the correction signal for one or more epochs or sampling intervals.

Under a third procedure, the data processor 120, the low-latency clock module 752, or the correction manager 740 incorporates the correction signal, alone or together with code-phase bias data or code bias data to compensate for one or more of the following conditions or states: (1) a first state where the time-variant wide-lane bias results from observed changes in in received signal-to-noise ratio or carrier-to-noise density ratio of an encoded L1 C/A or L2C (or L2C or L5) satellite signal of the satellite transmitter; (2) a second state where the time-variant narrow-lane bias results from observed changes in received signal-to-noise ratio or carrier-to-noise density ratio of an encoded L1 C/A or L2C (or L2C or L5) satellite signal of the satellite transmitter; and (3) a third state where the time variant wide-lane bias and the narrow-lane bias results from thermally dependent inter-frequency clock biases (e.g., different hardware signal paths in the satellite or different thermal environments of different transmitter signal paths within the satellite).

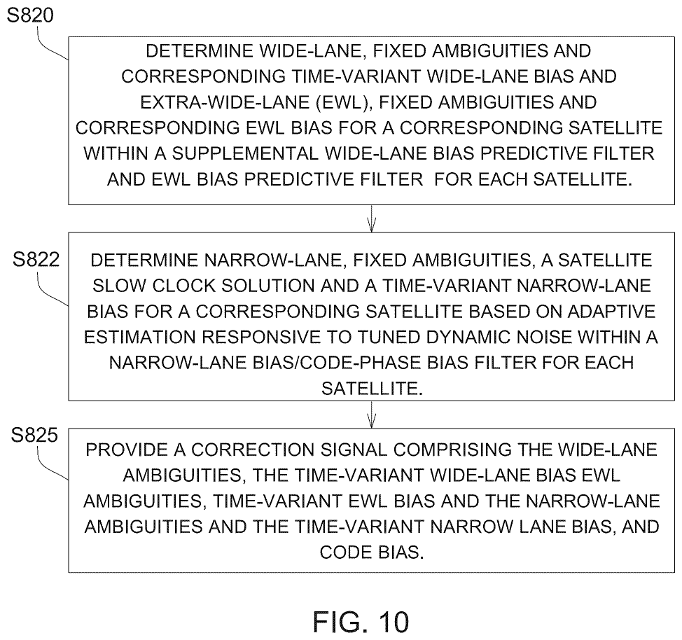

The embodiment of the method of FIG. 10 is similar to the embodiment of the method of FIG. 9, except step S824 is replaced with step S825 in FIG. 10. Like reference numbers in FIG. 9 and FIG. 10, or in any set of drawings, for that matter, indicate like elements or features.

In step S825, the low latency clock module (42, 407) a correction manager 740, or an electronic data processor 120 of the data processing center 118 provide a correction signal comprising the wide-lane ambiguities, extra-wide-lane ambiguities, the time-variant wide-lane bias, the time-variant extra-wide-lane bias, and the narrow-lane ambiguities and the time-variant narrow lane bias, and code bias (or code-phase bias). In general, as a practical matter, the code bias (of the pseudo-random noise code the encodes any carrier of a GNSS signal component) is or can be correlated to the phase bias (e.g., satellite clock bias components) of the corresponding carrier phase of the GNSS signal component, such as phase bias owing to or related to the flex power or changes in transmit power of the corresponding carrier phase of the GNSS signal component; hence, the term code-phase bias can be used to indicate such correlation throughout this disclosure.

Further, in alternate embodiments step S825 can be substituted for step S824 in any methods or flow charts in this disclosure.

Navigation Satellite Orbit and Clock Correction Determination with Low Latency Clock Corrections

A StarFire™ navigation receiver is a real-time global navigation satellite system (GNSS) receiver navigation that supports achieving cm-level accuracy positioning, by using the real-time global differential corrections. The StarFire™ navigation receiver works in conjunction with the StarFire™ correction signal or correction data, which is available globally through either over Internet Protocol (IP) or L-Band geostationary communication satellite. In comparison to local reference station correction, global differential correction is more desirable as it eliminates the need for local reference stations and radio communication.

The correction latency is one of critical factors to impact overall StarFire™ system performance. The correction latency is defined as the time difference between the epoch of processed measurements from network and the reference epoch of applied correction in rover receivers.

The foregoing description, for the purposes of explanation, has been described with reference to specific embodiments. However, the illustrative discussions above are not intended to be exhaustive or to limit the disclosure to precise forms disclosed. Many modifications and variations are possible in view of the above teachings. The embodiments were chosen and described in order to best explain the principles of the disclosure and its inventive and its practical applications, to thereby enable others skilled in the art to best utilize the disclosure and various embodiments with various modifications as are suited to the particular use contemplated.

What is claimed is:

1. A method for providing a global satellite correction signal comprises:
receiving, by a reference receiver, a plurality of satellite signals from each satellite, the satellite signals comprising a first carrier frequency, a second carrier frequency, and third carrier frequency;
measuring a carrier phase of the corresponding satellite signals from each satellite to estimate a first carrier phase of the respective first carrier frequency, to estimate a second carrier phase of a respective second carrier frequency, and to estimate a third carrier phase of the respective third carrier frequency;
determining first wide-lane, floating or fixed ambiguities and associated first wide-lane biases for each satellite based on the first carrier phase and second carrier phase associated with the corresponding satellite;
determining second wide-lane, floating or fixed ambiguities and associated second wide-lane biases for each satellite based on the second carrier phase and third carrier phase associated with the corresponding satellite;
determining narrow-lane, floating or fixed ambiguities, a satellite slow clock solution and a time-variant narrow-lane bias for a corresponding satellite based within a narrow-lane bias/code-phase bias filter for each satellite; and
providing a correction signal comprising the first wide-lane bias, second wide-lane bias and the narrow-lane ambiguities and the time-variant narrow lane bias.

2. The method according to claim 1 wherein the first wide-lane (WL) bias comprises a WL bias and where the second wide-lane bias comprises an extra-wide-lane (EWL) bias.

3. The method according to claim 1 further comprising:
determining an ambiguity-fixed-ionosphere-free (AFIF) bias for each satellite based on a first combination of first carrier phase measurements and second carrier phase measurements for wide-lane measurements for a respective epoch, a second combination of second carrier phase measurements and third carrier phase measurements for extra-wide-lane measurements for a respective epoch, resolved extra-wide lane ambiguities and resolved wide-lane ambiguities, wherein single-differencing and double-differencing wide-lane ambiguities are resolved for the respective epoch, and series of epochs thereafter, by using zero-differencing of the wide-lane carrier phase measurements and wherein single-differencing and double-differencing extra-wide-lane ambiguities are resolved for the respective epoch, and a series of epochs, thereafter by using zero-differencing of the extra wide-lane carrier phase measurements.

4. The method according to claim 3 wherein:
the first combination is a wide-lane combination of the first carrier phase measurements and the second carrier phase measurements; and
the second combination is an extra-wide-lane combination of the second carrier phase measurements and the third carrier phase measurements for extra-wide-lane measurements.

5. The method according to claim 1 wherein the correction signal further comprises one or more of the following components for each respective satellite within reception range or view of the reference:
the first wide lane bias that comprises a wide-lane (WL) bias;
the second wide-lane bias that comprises an extra-wide-lane bias (EWL);
a narrow-lane (NL) bias that comprises the time-variant narrow lane bias; or
an Ambiguity-Fixed-Ionosphere-Free (AFIF) bias, orbit and clock correction for correction for a plurality of global navigation satellite systems.

6. The method according to claim 1 further comprising:
determining clusters of single-difference (SD) extra-wide lane (EWL) floating ambiguities based on carrier phase measurements of the second carrier frequency and the third carrier frequency for a respective satellite in a set of satellites, each cluster of single-difference (SD) EWL floating ambiguities comprising pairs of SD EWL floating ambiguities for respective pairs of satellites within the set.

7. The method according to claim 6 wherein the determining of the clusters of single-difference (SD) EWL floating ambiguities comprises:
determining a respective satellite EWL bias value for each satellite of a plurality of satellites that is initially determined in accordance with fractional portions of the SD EWL floating ambiguities in the clusters, and then periodically updated by a predictive filter or Kalman filter.

8. The method according to claim 1 wherein the providing of the correction signal further comprises:
determining Ambiguity-Fixed-Ionosphere-Free (AFIF) carrier phase measurements with both resolved EWL integer ambiguities and resolved WL integer ambiguities,
processing the AFIF carrier phase measurements to determine the satellite AFIF bias for each respective satellite.

9. The method according to claim 8 wherein the providing of the correction signal further comprises processing the AFIF carrier phase measurements to determine receiver AFIF phase bias for each reference station.

10. The method according to claim 1 wherein the correction signal comprises one or more of the following data for each satellite: an EWL bias, a WL bias, a NL bias, an AFIF bias, orbit correction data, and clock correction data.

11. The method according to claim 1 further comprising transmitting the correction signal, with augmented EWL bias and AFIF bias, to mobile receivers for use in determining locations of one or more of the mobile receivers with faster convergence and better accuracy in a precise point positioning (PPP) mode.

12. The method according to claim 1 further comprising:
removing a first order ionospheric refraction error from the first frequency (L1) carrier phase measurement, the second frequency (L2) carrier phase measurements, and the third frequency (L3) carrier phase measurements to yield resultant refraction corrected wide-lane measurements and extra-wide-lane measurements in accordance with the following equations:
$${Φ}_{r , AFIF}^{s} = \frac{{f}_{{L}_{1}}}{{f}_{{L}_{1}} - {f}_{{L}_{3}}} ( \frac{{f}_{{L}_{1}}}{{f}_{{L}_{1}} - {f}_{{L}_{2}}} {Φ}_{r , {L}_{1}}^{s} - \frac{{f}_{{L}_{2}}}{{f}_{{L}_{1}} - {f}_{{L}_{2}}} {Φ}_{r , {L}_{2}}^{s} ) - \frac{{f}_{{L}_{3}}}{{f}_{{L}_{1}} - {f}_{{L}_{3}}} ( \frac{{f}_{{L}_{2}}}{{f}_{{L}_{2}} - {f}_{{L}_{3}}} {Φ}_{r , {L}_{2}}^{s} - \frac{{f}_{{L}_{3}}}{{f}_{{L}_{2}} - {f}_{{L}_{3}}} {Φ}_{r , {L}_{3}}^{s} ) = {D}_{r}^{s} + {b}_{r , AFIF} + {b}_{r , AFIF}^{s} + \frac{{f}_{{L}_{1}}}{{f}_{{L}_{1}} - {f}_{{L}_{3}}} {λ}_{WL} {N}_{WL} - \frac{{f}_{{L}_{3}}}{{f}_{{L}_{1}} - {f}_{{L}_{3}}} {λ}_{EWL} {N}_{EWL} + {ε}_{{Φ}_{r , AFIF}^{s}}$$
where:
b_{r,AFIF} is receiver ambiguity-free, ionosphere-free (AFIF) bias that is a combination of L1, L2 and L3 receiver carrier phase bias, as follows:
$${b}_{r , AFIF} = \frac{{Cf}_{{L}_{1}}}{( {f}_{{L}_{1}} - {f}_{{L}_{2}} ) ( {f}_{{L}_{1}} - {f}_{{L}_{3}} )} {b}_{r , {L}_{1}} + \frac{{Cf}_{{L}_{2}}}{( {f}_{{L}_{2}} - {f}_{{L}_{1}} ) ( {f}_{{L}_{2}} - {f}_{{L}_{3}} )} {b}_{r , {L}_{2}} + \frac{{Cf}_{{L}_{3}}}{( {f}_{{L}_{3}} - {f}_{{L}_{1}} ) ( {f}_{{L}_{3}} - {f}_{{L}_{2}} )} {b}_{r , {L}_{3}} {b}_{r , AFIF}^{s}$$
is satellite ambiguity-free, ionosphere-free (AFIF) bias that is a combination of L1, L2 and L3 satellite phase bias as follows, both satellite and receiver wide-lane biases are not constant over time:
$${b}_{r , AFIF}^{s} = \frac{{Cf}_{{L}_{1}}}{( {f}_{{L}_{1}} - {f}_{{L}_{2}} ) ( {f}_{{L}_{1}} - {f}_{{L}_{3}} )} {b}_{{L}_{1}}^{s} + \frac{{Cf}_{{L}_{2}}}{( {f}_{{L}_{2}} - {f}_{{L}_{1}} ) ( {f}_{{L}_{2}} - {f}_{{L}_{3}} )} {b}_{{L}_{2}}^{s} + \frac{{Cf}_{{L}_{3}}}{( {f}_{{L}_{3}} - {f}_{{L}_{1}} ) ( {f}_{{L}_{3}} - {f}_{{L}_{2}} )} {b}_{{L}_{3}}^{s} ,$$
where
b_{r,AFIF} represents a receiver phase bias T, for each receiver and each GNSS constellation that is modelled after extra-wide-lane ambiguities and wide-lane ambiguities are resolved.

13. A method for providing a global satellite correction signal comprising:
receiving, by a reference receiver, a plurality of satellite signals from each satellite, the satellite signals comprising a first carrier frequency, a second carrier frequency, and third carrier frequency;
measuring the carrier phase and code phase of the corresponding satellite signals from each satellite to estimate a first carrier phase of the respective first carrier frequency, to estimate a second carrier phase of a respective second carrier frequency, and to estimate a third carrier phase of the respective third carrier frequency;
determining first wide-lane, floating or fixed ambiguities and associated first wide-lane biases for each satellite based on the first carrier phase and second carrier phase associated with the corresponding satellite;
determining second wide-lane, floating or fixed ambiguities and associated second wide-lane biases for each satellite based on the second carrier phase and third carrier phase associated with the corresponding satellite;
determining narrow-lane, floating or fixed ambiguities, a satellite slow clock solution and a time-variant narrow-lane bias for a corresponding satellite based within a narrow-lane bias/code-phase bias filter for each satellite; and
providing a correction signal comprising the first wide-lane bias, second wide-lane bias, the time-variant narrow lane bias.

14. The method according to claim 13 wherein the correction signal further comprises code bias or code-phase bias for one or more epochs, orbit correction, and clock correction.

15. The method according to claim 14 wherein the providing of the correction signal further comprises:
determining Ambiguity-Fixed-Ionosphere-Free (AFIF) carrier phase measurements with both fixed EWL integer ambiguities and fixed WL integer ambiguities, and
processing the AFIF carrier phase measurements to determine the satellite AFIF bias for each respective satellite.

16. The method corroding to claim 15 wherein the providing of the correction signal further comprises processing the AFIF carrier phase measurements to determine receiver AFIF phase bias for each reference station.
